(19) United States
(12) Patent Application Publication
(10) Pub. No.: US 2026/0112030 A1
(43) Pub. Date: Apr. 23, 2026

(54) ULTRASOUND IMAGING AND DEEP LEARNING FOR BODY COMPOSITION AND NUTRITIONAL ASSESSMENT

(71) Applicants: The Trustees of Boston College, Chestnut Hill, MA (US); The Brigham and Women’s Hospital, Inc., Boston, MA (US)

(72) Inventors: Bryan RANGER, Brookline, MA (US); Jinhee PARK, Norwood, MA (US); Donglai WEI, Arlington, MA (US); Katherine BELL, Newton, MA (US); Keshi HE, Newton, MA (US)

(21) Appl. No.: 19/364,188

(22) Filed: Oct. 21, 2025

Related U.S. Application Data
(60) Provisional application No. 63/709,832, filed on Oct. 21, 2024.

(51) Int. Cl. G06T 7/00; G06T 7/11

(52) U.S. Cl. CPC G06T 7/0012; G06T 7/11; G06T 2207/10132; G06T 2207/20084

(57) ABSTRACT

Embodiments provide computer-implemented methods, systems, and media for estimating a subject's body composition from ultrasound. Images acquired at standardized sites (e.g., biceps, abdominal wall, quadriceps) are quality-gated and preprocessed (scale, denoise, normalization). A neural network segments tissue layers; features from the image and masks feed a predictor that outputs fat mass (FM), fat-free mass (FFM), and, in some embodiments, adiposity indices (e.g., preperitoneal fat thickness, visceral-to-subcutaneous ratio). Multi-site predictions may be fused. The system can compute uncertainty, produce explanation overlays, and generate a report with values and visit-to-visit trends. An acquisition-planning module selects a minimal site subset to meet an error target. Implementations support edge/cloud inference and optional fusion with clinical covariates or laboratory data. The approach applies to neonatal, pediatric, adult, pregnant, and diabetic subjects for prenatal nutrition care, metabolic screening, and longitudinal monitoring.

### CROSS REFERENCE TO RELATED APPLICATIONS

This application claims the benefit of priority to U.S. provisional application Ser. No. 63/709,832, filed 21 Oct. 2024, the entire disclosure of which is incorporated by reference as if fully set forth herein in its entirety.

### FIELD OF THE INVENTION

The embodiments of the present invention relate to the intersections of medical ultrasound, machine learning, and subjects'/neonatal nutrition assessments, among other assessments.

### BACKGROUND OF THE INVENTION

Clinical assessment of human subjects—including fetuses, newborns, children, adults, pregnant persons, and older adults—has evolved from impressionistic bedside observation to structured examinations that guide stabilization, triage, and longitudinal care. A landmark in perinatal assessment remains the Apgar score, introduced in the 1950s, which standardized immediate post-birth evaluation with five signs and fixed time points; its common language enabled comparison of delivery practices across institutions and populations (resuscitationjournal.com/article/S0300-9572(00)00340-3/abstract?).

As neonatal survival improved and preterm birth drew increasing attention, clinicians emphasized early estimation of gestational maturity. Bedside physical and neuromuscular markers—skin transparency, ear cartilage recoil, posture, joint flexion—were consolidated into maturity scores culminating in the New Ballard Score, which extended applicability to extremely premature infants and improved inter-rater reliability. These exams provided practical corroboration of gestational age when obstetric dating was uncertain and informed thermoregulation, feeding readiness, and respiratory support (e.g., see: sciencedirect.com/science/article/abs/pii/S0022347605820566?).

Beyond immediate stabilization and maturity estimation, growth and nutrition surveillance became central across the life course. In infancy and childhood, weight, length/height, and head circumference are tracked serially; in adolescents and adults, anthropometrics such as BMI and waist circumference are used to estimate adiposity and cardiometabolic risk. Recognizing limitations of region-specific charts, the World Health Organization established international standards derived from healthy, optimally nourished subjects, infants, and children, enabling detection of under- or over-nutrition, comparison of trajectories across settings, and harmonized public-health reporting (e.g., see: who.int/publications/i/item/924154693X?).

Taken together, this historical arc reflects progressive systematization: first, codifying immediate physiologic status; second, formalizing developmental and maturity markers; and third, standardizing growth and nutrition surveillance. Yet across populations—including pregnant subjects and subjects with diabetes—clinicians still lack practical tools that capture body-composition nuances (e.g., shifts between fat mass and fat-free mass) linked to neurodevelopmental outcomes, obstetric and neonatal health, and long-term cardiometabolic risk. What are urgently needed are accessible ultrasound imaging methods, paired with modern deep learning, for body-composition and nutritional assessment in real-world clinical and community settings.

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Various strategies have been explored for estimating neonatal body composition using noninvasive measurements. Early work relied on anthropometric techniques, including skinfold caliper measurements at the triceps, subscapular, and abdominal sites, combined with population-specific regression equations to infer fat mass (FM) and fat-free mass (FFM). Although simple to implement at the bedside, these approaches are subject to intra- and interoperator variability, limited to surface adiposity measures, and often calibrated on small or demographically restricted cohorts.

To improve specificity for internal adipose and muscle layers, two-dimensional (2D) B-mode ultrasound imaging has been applied to neonatal tissues. In these methods, sonographers manually select regions of interest (ROIs) at the biceps, quadriceps, or abdominal sites and measure subcutaneous fat thickness or muscle depth using on-screen calipers. Some implementations introduce rule-based image enhancement and edge detection algorithms to assist with boundary identification, but still require substantial user intervention and yield limited reproducibility across different ultrasound systems or imaging operators.

Advancements in image processing lead to semi-automated segmentation techniques, such as active contour models, graph-cut algorithms, and histogram-based thresholding, to delineate tissue structures in neonatal ultrasound frames. Extracted morphological and texture features—including mean gray-level intensity, gradient statistics, and contour curvature—are combined in multivariate linear or non-linear regression models to predict FM and FFM, often using reference standards such as air displacement plethysmography or magnetic resonance imaging for calibration. While these workflows reduce manual annotation time, they can remain constrained by handcrafted feature sets and region-specific parameter tuning.

Herein, supervised machine-learning approaches have been evaluated for automated tissue classification in neonatal ultrasound. Shallow neural networks and support vector machines trained on small annotated datasets have demonstrated proof-of-concept for distinguishing adipose from muscle tissue, and three-dimensional (3D) matrix-array ultrasound systems have been used to capture volumetric data for post-hoc analysis. These systems can involve complex hardware, high data rates, and often require offline processing pipelines that are not optimized for rapid or region-specific composition reporting at the point of care. Herein is developed a comprehensive solution that combines the features described in this disclosure.

In some embodiments, this disclosure relates to neonatal body composition estimations from ultrasound imagery using neural networks. In some embodiments, this disclosure provides methods, systems, and computer-readable media for objective, bedside estimation of neonatal body composition from ultrasound images acquired at standardized anatomical sites. Conventional growth surveillance relies on weight, length, and head circumference, which are insensitive to early shifts between fat mass and fat-free mass—the compartments most closely tied to energy balance, feeding effectiveness, and neurodevelopmental risk. Reference techniques that can quantify body composition directly are costly, immobile, or impractical for routine use in nurseries and neonatal intensive care units. The invention overcomes these limitations by coupling rapid image acquisition with automated interpretation that yields fat mass (FM) and fat-free mass (FFM) estimates suitable for clinical decision support and longitudinal monitoring.

In one aspect, a computer-implemented method receives one or more ultrasound images of a subject and/or a newborn acquired at defined regions (for example, biceps, abdomen, and quadriceps). The method performs standardized preprocessing—including scale normalization, denoising, and brightness/contrast harmonization—to reduce device and operator variability. A trained segmentation network delineates tissue boundaries (e.g., subcutaneous fat and underlying muscle fascia). From the normalized images and pixel-wise delineations, the system derives learned features and applies a trained regression head to predict FM and/or FFM. Where multiple regions are imaged, region-level predictions may be fused to improve accuracy. The method outputs a report containing the predicted values and, in some embodiments, complementary quality and safety signals such as an image-quality score, an uncertainty measure, and an explanation overlay that highlights image regions driving the prediction.

In another aspect, a system integrates an acquisition interface (e.g., an ultrasound probe and display) with one or more processors and non-transitory memory storing trained models. The system can execute preprocessing and segmentation on an edge device, forward normalized inputs or intermediate features to a remote service for inference, and present the returned results at the point of care. The interface can guide probe placement, screen frames for motion blur or insufficient anatomical coverage, and request reacquisition when needed. Secure storage associates acquired images, intermediate masks, and outputs with a subject identifier; audit trails link predictions to model version and configuration to support clinical governance. The system may operate offline and synchronize when connectivity is restored.

A further aspect addresses model development. A training pipeline ingests labeled datasets of neonatal ultrasound images paired with reference body-composition measurements. The pipeline performs data quality checks and standardization, trains a segmentation network to produce anatomically faithful delineations, and trains a regression model (which may share a backbone with the segmentation network) to estimate FM and FFM. Validation employs cross-validation procedures and agreement analyses against reference methods. In ablations, the approach surpasses classical feature-based baselines and demonstrates that combining images across anatomical regions yields improved accuracy compared with any single site alone.

The invention also introduces acquisition planning that selects a minimal set of regions expected to meet a predefined error threshold. Using validation statistics learned during training, the planner estimates the marginal information gain of each region and proposes an ordered subset that balances accuracy with acquisition time. During scanning, real-time feedback can adapt the plan based on observed image quality and partial predictions, enabling efficient acquisition in busy clinical workflows and in settings with limited resources.

The disclosed techniques are designed to be practical and reproducible. Standardized site definitions and automated quality control reduce operator dependence. Learned features, rather than hand-engineered measurements, capture complex patterns in speckle and tissue interfaces while remaining explainable via attention or saliency overlays. Confidence measures enable clinicians to weigh predictions appropriately and to trigger confirmatory steps when needed. Outputs can be trended over time, providing a sensitive barometer of nutritional adequacy and response to interventions, including feeding protocol changes and discharge or clinic visit planning.

According to some aspects, the invention is technology-agnostic with respect to model families and compute placement. Segmentation may be performed by encoder-decoder networks with skip connections or comparable architectures; regression may be single- or multi-task; and inference can be executed on-device, in the cloud, or in a hybrid topology. Interfaces support programmatic integration with electronic records and analytics pipelines. The approach generalizes across probes and care settings by harmonizing scale and intensity and by learning robust representations from diverse data, while audit and governance features support safe deployment in clinical environments.

Collectively, these elements provide an end-to-end solution that transforms common ultrasound images into actionable estimates of neonatal body composition. By uniting standardized image acquisition, automated segmentation, multi-region fusion, calibrated prediction, and operator guidance, the invention equips clinicians with a practical tool to detect early nutritional imbalance, stratify risk, and personalize care in the critical early window of life.

The details of one or more implementations of the subject matter of this specification are set forth in the accompanying drawings and the description below. Other features, aspects, and advantages of the subject matter will become apparent from the description, the drawings, and the claims.

As such, keeping in mind possible combination embodiments and the above discussion (and the details below), as an additional brief summary or to provide discussion points for a brief summary, some example features of the technology disclosed herein can be briefly summarized by the following list of features, any of which can be inter-combined or discussed optionally with any other feature, Figure, Drawing, detail, embodiment, aspect, or example disclosed herein:

Feature 1: A computer-implemented method for estimating body-composition metrics of a subject from ultrasound imagery, the method comprising: receiving one or more ultrasound images of the subject acquired at at least one of a biceps region, an abdominal wall region lateral to the umbilicus, and a quadriceps region; preprocessing the one or more ultrasound images to generate normalized inputs comprising at least scale normalization, cropping, resizing, denoising, and intensity normalization with quality-control gating; segmenting tissue structures in the normalized inputs with a trained neural network to produce pixel-wise anatomical delineations; generating, from the normalized inputs and the pixel-wise delineations, a learned feature representation; predicting, using a trained model, a body-composition output comprising at least one of fat mass (FM), fat-free mass (FFM), preperitoneal fat thickness, a visceral-to-subcutaneous fat ratio, or an adiposity score; and producing a report comprising the body-composition output.

Feature 2: The method of feature 1, wherein the subject is a pregnant subject, and the report further comprises at least one of: FM, FFM, a gestational-weight-gain percentile for current gestational age, or a trend of the body-composition output across prenatal visits to inform nutritional assessment in prenatal care; and/or wherein the method of claim 1 is used to monitor a physiological readiness in military populations.

Feature 3: The method of feature 2, further comprising calibrating the body-composition output against a reference comprising air-displacement plethysmography (ADP) using a BodPod device when available, and otherwise recording the body-composition output with an associated uncertainty score.

Feature 4: The method of feature 2, wherein acquiring the one or more ultrasound images comprises providing probe-placement cues and motion guidance using inertial measurement unit (IMU) signals from a handheld ultrasound probe, and rejecting frames that fail a quality criterion comprising compression or motion artifacts.

Feature 5: The method of feature 1, wherein the subject has diabetes or pre-diabetes, and the predicting further comprises computing at least one of: preperitoneal fat thickness, the visceral-to-subcutaneous fat ratio, or a composite adiposity score that fuses ultrasound-derived features with waist circumference and body-mass index obtained from clinical records; and/or wherein the method is configured to monitor response to therapy in a subject receiving a dietary intervention or pharmacologic therapy including a GLP-1 receptor agonist.

Feature 6: The method of feature 5, further comprising associating the body-composition output for the subject with diabetes with laboratory data comprising at least one of hemoglobin A1c (HbA1c), fasting glucose, fasting insulin, lipid panel, or liver enzymes, and including an uncertainty or confidence interval in the report.

Feature 7: The method of feature 5, further comprising selecting, by an acquisition-planning module, a minimal subset of anatomical regions to satisfy an error threshold for the adiposity score, favoring abdominal wall views and optionally adding biceps or quadriceps views when predicted error remains above the threshold.

Feature 8: The method of feature 1, wherein the one or more ultrasound images comprise images from two or more of the biceps, abdominal wall, and quadriceps regions, and the predicting comprises combining region-level predictions by fusion to produce the body-composition output.

Feature 9: The method of feature 1, wherein the preprocessing further comprises normalizing pixel spacing using image metadata or a scale bar to standardize physical scale prior to segmentation and prediction.

Feature 10: The method of feature 1, further comprising computing an uncertainty or confidence score for the body-composition output, generating an explanation visualization comprising a saliency or attention heatmap overlaid on at least one of the ultrasound images, and producing a longitudinal trend of the body-composition output across visits in the report.

Feature 11: A system for estimating body-composition metrics of a subject from ultrasound imagery, comprising: an ultrasound acquisition interface configured to receive ultrasound images of a subject acquired at at least one of a biceps region, an abdominal wall region lateral to the umbilicus, and a quadriceps region; one or more processors; and non-transitory memory storing instructions that, when executed by the one or more processors, cause the system to perform operations comprising: preprocessing the ultrasound images to generate normalized inputs with quality-control gating; segmenting tissue structures using a trained neural network to produce pixel-wise delineations; generating a learned feature representation from the normalized inputs and the pixel-wise delineations; predicting, using a trained model, a body-composition output comprising at least one of FM, FFM, preperitoneal fat thickness, a visceral-to-subcutaneous fat ratio, or an adiposity score; and producing a report comprising the body-composition output.

Feature 12: The system of feature 11, wherein at least a portion of the segmenting executes on an edge device coupled to a handheld ultrasound probe and at least a portion of the predicting executes on a remote server, and wherein the system is further configured to export the report and associated metadata to an electronic health record via an application programming interface.

Feature 13: The system of feature 11, wherein the system is configured, in pregnant subjects, to compute FM and FFM and to present a gestational-weight-gain percentile and a trend across prenatal visits, together with an explanation visualization highlighting an abdominal subcutaneous fat boundary used in the prediction; and/or wherein the system of claim 11 is used to monitor a physiological readiness in military populations.

Feature 14: The system of feature 11, wherein the system is configured, in subjects with diabetes or pre-diabetes, to compute at least one of preperitoneal fat thickness, the visceral-to-subcutaneous fat ratio, or an adiposity score that fuses ultrasound-derived features with anthropometric inputs including waist circumference and body-mass index, and to flag results that exceed a configurable clinical threshold; and/or wherein the system is configured to monitor response to therapy in a subject receiving a dietary intervention or pharmacologic therapy including a GLP-1 receptor agonist.

Feature 15: The system of feature 11, further comprising an IMU-assisted guidance module configured to provide probe-placement cues and motion guidance and to reject frames that fail a quality criterion comprising compression or motion artifacts.

Feature 16: A non-transitory computer-readable medium storing instructions that, when executed by one or more processors, cause the one or more processors to perform a method comprising: receiving one or more ultrasound images of a subject acquired at at least one of a biceps region, an abdominal wall region lateral to the umbilicus, and a quadriceps region; preprocessing the one or more ultrasound images to generate normalized inputs with scale harmonization and denoising; segmenting tissue structures in the normalized inputs by executing a trained neural network to produce pixel-wise delineations; generating a learned feature representation from the normalized inputs and the pixel-wise delineations; predicting, using a trained model, a body-composition output comprising at least one of FM, FFM, preperitoneal fat thickness, a visceral-to-subcutaneous fat ratio, or an adiposity score; and producing a report comprising the body-composition output.

Feature 17: The non-transitory computer-readable medium of feature 16, wherein the instructions comprise code to normalize pixel spacing using image metadata or a scale bar prior to segmentation and to reject an image that fails a quality criterion comprising motion blur or insufficient anatomical coverage.

Feature 18: The non-transitory computer-readable medium of feature 16, wherein the instructions comprise code to aggregate predictions across two or more of the biceps region, abdominal wall region, and quadriceps region to produce the body-composition output by late-fusion of region-level predictions.

Feature 19: The non-transitory computer-readable medium of feature 16, wherein the instructions comprise code to format the report to include at least one of: FM, FFM, preperitoneal fat thickness, the visceral-to-subcutaneous fat ratio, or an adiposity score; an uncertainty or confidence interval; an explanation visualization; and, when available, associated laboratory values comprising HbA1c or fasting glucose.

Feature 20: The non-transitory computer-readable medium of feature 16, wherein the instructions comprise code to select, by an acquisition-planning module, a minimal subset of anatomical regions to satisfy an error threshold for an adiposity score or FM/FFM, favoring an abdominal wall view and optionally adding biceps or quadriceps views when predicted error remains above the threshold.

Feature 21: A computer-implemented method for estimating neonatal body composition from ultrasound imagery, the method comprising: receiving one or more ultrasound images of a newborn acquired at at least one of a biceps region, an abdomen region, and a quadriceps region; preprocessing the one or more ultrasound images to generate normalized inputs, the preprocessing comprising one or more of cropping, resizing, denoising, or intensity normalization; segmenting tissue structures in the normalized inputs by executing a trained neural network to produce pixel-wise delineations of anatomical boundaries; generating, from the normalized inputs and the pixel-wise delineations, a learned feature representation; and predicting, using a trained regression model, a body-composition output comprising at least one of fat mass (FM) and fat-free mass (FFM), and producing a report comprising the body-composition output.

Feature 22: The method of feature 21, wherein the trained neural network comprises an encoder-decoder architecture with skip connections.

Feature 23: The method of feature 21, wherein the ultrasound images comprise images from two or more of the biceps region, abdomen region, and quadriceps region, and the predicting comprises combining region-specific predictions to produce the body-composition output.

Feature 24: The method of feature 21, wherein the preprocessing further comprises normalizing pixel spacing using image metadata or a scale bar to standardize physical scale prior to segmentation.

Feature 25: The method of feature 21, further comprising computing an image-quality score for each received ultrasound image and rejecting an image that fails a quality criterion comprising motion blur or insufficient anatomical coverage.

Feature 26: The method of feature 21, further comprising computing an uncertainty or confidence score for the body-composition output and including the uncertainty or confidence score in the report.

Feature 27: The method of feature 21, further comprising generating an explanation visualization comprising a saliency or attention heatmap overlaid on at least one of the ultrasound images and including the explanation visualization in the report.

Feature 28: The method of feature 21, wherein the predicting further comprises adjusting the body-composition output based on one or more newborn covariates selected from the group consisting of age, sex, and birthweight.

Feature 29: The method of feature 21, further comprising aggregating a plurality of frames of a given anatomical region into a region-level representation prior to the predicting.

Feature 30: The method of feature 21, wherein at least a portion of the segmenting executes on an edge device coupled to an ultrasound probe and at least a portion of the predicting executes on a remote server, and the report is returned to a display of the edge device.

Feature 31: A system for estimating neonatal body composition from ultrasound imagery, comprising: an ultrasound acquisition interface configured to receive ultrasound images of a newborn acquired at at least one of a biceps region, an abdomen region, and a quadriceps region; one or more processors; and non-transitory memory storing instructions that, when executed by the one or more processors, cause the system to perform operations comprising: preprocessing the ultrasound images to generate normalized inputs; segmenting tissue structures in the normalized inputs using a trained neural network to produce pixel-wise delineations; generating a learned feature representation from the normalized inputs and the pixel-wise delineations; predicting, using a trained regression model, a body-composition output comprising at least one of FM and FFM; and producing a report comprising the body-composition output.

Feature 32: The system of feature 31, wherein the non-transitory memory stores the trained neural network comprising an encoder-decoder with skip connections for pixel-wise segmentation.

Feature 33: The system of feature 31, wherein the system is configured to accept multiple images per anatomical region and to combine the multiple images to produce a region-level prediction.

Feature 34: The system of feature 31, further comprising a network interface to communicate normalized inputs or intermediate features to a remote server for inference and to receive the body-composition output in response.

Feature 35: The system of feature 31, wherein the system is configured to compute and store at least one of: (i) an uncertainty or confidence score for the body-composition output, and (ii) an explanation visualization comprising a saliency heatmap.

Feature 36: A non-transitory computer-readable medium storing instructions that, when executed by one or more processors, cause the one or more processors to perform a method comprising: receiving one or more ultrasound images of a subject from at least one of a biceps region, an abdomen region, and a quadriceps region; preprocessing the one or more ultrasound images to generate normalized inputs; segmenting tissue structures in the normalized inputs by executing a trained neural network to produce pixel-wise delineations; generating a learned feature representation from the normalized inputs and the pixel-wise delineations; and predicting, using a trained regression model, a body-composition output comprising at least one of FM and FFM, and producing a report comprising the body-composition output.

Feature 37: The non-transitory computer-readable medium of feature 36, wherein the instructions comprise code to normalize pixel spacing using image metadata or a scale bar prior to segmentation.

Feature 38: The non-transitory computer-readable medium of feature 36, wherein the instructions comprise code to reject an image that fails a quality criterion comprising motion blur or insufficient anatomical coverage.

Feature 39: The non-transitory computer-readable medium of feature 36, wherein the instructions comprise code to aggregate predictions across two or more of the biceps region, abdomen region, and quadriceps region to produce the body-composition output.

Feature 40: The non-transitory computer-readable medium of feature 36, wherein the instructions comprise code to format the report with textual values for FM and FFM and to include an uncertainty or confidence score associated with at least one of FM and FFM.

Other implementations are also described and recited herein. These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Solely for the purpose of illustration, certain embodiments of the present invention are explained using examples in the drawings described below. It should be understood, however, that the invention is not limited to the precise arrangements, dimensions, and configurations shown. In the drawings:

FIG. 1 shows an overview of the neonatal ultrasound assessment workflow.

FIG. 2 shows a summary Table of study variables and outcome measures.

FIG. 3A shows a representative ultrasound image technique of the biceps region.

FIG. 3B shows a representative ultrasound image technique of the abdomen region.

FIG. 3C shows a representative ultrasound image technique of the quadriceps region.

FIG. 4A shows example measurement landmarks and regions of interest for the biceps.

FIG. 4B shows measurement landmarks and regions of interest for the abdomen.

FIG. 4C shows measurement landmarks and regions of interest for the quadriceps.

FIG. 5 shows an example study design and data flow diagram from enrollment to analysis.

FIG. 6A shows an example image preprocessing and normalization pipeline. FIG. 6B shows a different example image preprocessing and normalization pipeline.

FIG. 7 shows a neural network architecture for image analysis and prediction.

FIG. 8 shows a training and evaluation pipeline for the predictive models.

FIGS. 9A-9D show a comparison of prediction and real values of fat mass (UNet FM BAQ). FIG. 9A shows a Bland-Altman plot. FIG. 9B shows model error. FIG. 9C shows model prediction; and FIG. 9D shows ground truth vs prediction.

FIGS. 10A-10D show a comparison of prediction and real values of fat-free mass (UNet FFM BAQ). FIG. 10A shows a Bland-Altman plot. FIG. 10B shows model error. FIG. 10C shows model prediction; and FIG. 10D shows ground truth vs prediction.

FIG. 11 shows the contributory regions in the ultrasound images of abdomen, biceps and quadriceps identified by Grad-CAM. Warmer colors (reds) indicate higher importance in the model's prediction, while cooler colors (blue) indicate lower importance in the model's prediction.

FIG. 12 shows cohort demographics and summary statistics.

FIG. 13 shows Table 3 (e.g., Results of image combinations for prediction of FM).

FIG. 14 shows model configuration and key hyperparameters.

FIG. 15 shows an aggregate evaluation metrics across prediction tasks.

FIG. 16 shows an additional dataset overview and distribution characteristics.

FIG. 17 shows a comparative results table for principal model variants.

FIG. 18 shows an ablation study results for preprocessing and architecture choices.

FIG. 19 shows an end-to-end prediction workflow schematic.

FIG. 20 shows a consolidated performance summary across datasets.

FIG. 21A shows comparative results under training regime A.

FIG. 21B shows comparative results under training regime B.

FIG. 21C shows comparative results under training regime C.

FIG. 22 shows a table of MAPE results for combinations of anatomical image (e.g., error rates by combinations of anatomical image locations).

FIG. 23 shows an extended results table with secondary metrics.

FIGS. 24A-24H each show a bar chart of a representative example.

FIG. 25 displays Grad-CAM visualizations.

FIG. 26 shows an example report or visualization of predicted outcomes.

FIG. 27 shows an example table of “Concept/Source” and “Measure”.

FIG. 28 shows a Clarius® C3 HD3 probe with iPad® to control image acquisition; (image source: clarius.com).

Like reference numbers and designations in the various drawings indicate like elements. Reference numbers can be interchanged for various embodiments. It is also to be understood that the various exemplary implementations shown in the figures are merely illustrative representations and are not necessarily drawn to scale. All trademarks, images, likenesses, words, and depictions in the drawings and the disclosure are plainly in fair use and are provided solely for the purposes of illustration of the invention in view of an urgent need to treat subjects as further discussed in detail below.

### DETAILED DESCRIPTION OF THE INVENTION

The subject innovation is now described in some instances, when necessary, with reference to the drawings. In the following description, for purposes of explanation, numerous specific details are set forth in order to provide a thorough understanding of the present invention. It may be evident, however, that the present invention may be practiced without these specific details. In other instances, well-known structures, methods, and devices are shown in block diagram form or with illustrations in order to facilitate describing the present invention. It is to be appreciated that certain aspects, modes, embodiments, variations and features of the invention are described below in various levels of detail in order to provide a substantial understanding of the present invention.

### Definitions

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed invention, because the scope of the invention is limited only by the claims. The technology can be used under any circumstances or in a surgery (MedlinePlus, medlineplus.gov/). Unless otherwise defined, all technical and scientific terms used herein have the same meaning as commonly understood by one of ordinary skill in the art to which this invention belongs. If there is an apparent discrepancy between the usage of a term in the art and its definition provided herein, the definition provided within the specification shall prevail. In general, typical chemical terminology is found in the International Union of Pure and Applied Chemistry GoldBook(IUPAC Gold Book, goldbook.iupac.org). This disclosure is purposefully presented in commonly understood words, known to a person of skill in the art, but Merriam-Webster's Online Dictionary is used, when appropriate, for terms not specifically demonstrated herein or not known in the art (e.g., Merriam-Webster Online Dictionary, merriam-webster.com/).

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 1% (e.g., Encyclopedia of Molecular Cell Biology and Molecular Medicine), or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”. Where a range is preceded by ‘about’, each endpoint is deemed modified by ‘about’ unless context clearly indicates otherwise, and all intervening sub-ranges are individually disclosed.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation. The term “including” can be interchanged with “comprising”.

The term “consisting of” refers to compositions, methods, and respective components thereof as described herein, which are exclusive of any element not recited in that description of the embodiment.

The term “statistically significant” or “significantly” refers to statistical significance and generally means a two-standard deviation (2SD) or greater difference. Unless otherwise specified, p<0.05 or a difference≥2 standard deviations from a control mean constitutes statistical significance.

As used herein, the term “subject” refers to a neonatal infant and/or an embryo, a human subject, a mammal, including but not limited to a dog, cat, horse, cow, pig, sheep, goat, rodent, or primate. Subjects can be house pets (e.g., dogs, cats), agricultural stock animals (e.g., cows, horses, pigs, chickens, etc.), laboratory animals (e.g., mice, rats, rabbits, etc.), but are not so limited. Subjects particularly include human subjects in urgent treatment as described herein. The human subject may be a pediatric, adult, or a geriatric subject. The human subject may be of any sex.

The term “treating” includes prophylactic and/or therapeutic treatments. The term “prophylactic or therapeutic” treatment is art-recognized and includes administration to the host of one or more of the subject compositions and/or application of one or more therapies or surgeries.

As used herein, the terms “treat,” “treatment,” “treating,” or “amelioration” when used in reference to a disease, disorder, or medical condition, refer to therapeutic treatments for a condition, wherein the object is to reverse, alleviate, ameliorate, inhibit, slow down or stop the progression or severity of a symptom or condition.

The terms: “decrease”, “reduced”, “reduction”, or “inhibit” are all used herein to mean a decrease by a statistically significant amount.

The terms “increased”, “increase”, “enhance”, or “activate” are all used herein to mean an increase by a statistically significant amount.

As used herein, an agent or a therapeutic agent provided to a subject and suspected to be or involved in a treatment can be a small molecule less than 1000 MW or a large molecule not less than 1000 MW including biologics, oligonucleotides, peptides, oligosaccharides, and larger molecules. When referring to MSE values herein the kg can be a kg\hat{ }2 for squared error.

A subject can be one who has been previously diagnosed with or identified as suffering from or having a condition in need of treatment.

Example list of abbreviations: AI: Artificial intelligence; BMI: Body mass index; CNN: Convolutional neural network; FM: Fat mass; FFM: Fat-free mass; IRB: Institutional review board; OPD: pediatric outpatient department; MAE: Mean Absolute Error; MAPE: Mean Absolute Percentage Error; ML: machine learning; MSE: Mean Squared Error; NICU: Neonatal intensive care unit; RMSE: Root Mean Squared Error. As discussed above, unless otherwise defined herein, scientific and technical terms used in connection with the present application shall have the meanings that are commonly understood.

Means-plus-function disclaimer: No claim element is intended to invoke 35 U.S.C. 112(f) absent express recitation of ‘means for’ or ‘step for’ followed by a functional statement. Regarding e.g.: As used herein (including throughout the claims), this Latin abbreviation for *exempli gratia* introduces non-limiting examples presented solely to illustrate representative embodiments, optional features, materials, parameters, ranges, process steps, functional relationships, or use scenarios. Each instance of e.g. shall be construed as expressly non-restrictive and shall not be interpreted as narrowing, disclaiming, or excluding unrecited alternatives, equivalents, sub-ranges, or additional species that a person of ordinary skill in the art would recognize as reasonably pertinent to the stated genus or concept. The inclusion of illustrative matter following e.g. does not invoke prosecution disclaimer, estoppel, or an election of species, and does not limit any open or transitional claim terminology (such as “comprising,” “including,” or “consisting essentially of”). The absence of an example after e.g. shall likewise not imply the essentiality of any recited example elsewhere. Where a list of examples follows e.g., the list is exemplary and not exhaustive; additional unlisted variants remain within the contemplated scope unless expressly excluded. No inference should be drawn that examples linked by e.g. are mutually exclusive or that any particular sequence, proportion, or sub-combination is required unless affirmatively stated.

Other terms are defined herein within the description of the various aspects of the invention.

### Ultrasound Imaging and Deep Learning for Body Composition and Nutritional Assessment

In an introduction to details of some embodiments, the technology provides end-to-end systems, methods, and computer-readable media for estimating neonatal body composition from routine ultrasound acquired at standardized anatomical sites. According to some aspects, the invention is configured to transform B-mode images from the biceps, abdomen, and/or quadriceps into calibrated estimates of fat mass (FM) and fat-free mass (FFM), thereby furnishing a practical, non-invasive readout of early nutritional status suitable for serial bedside monitoring.

In some embodiments, acquisition proceeds under a protocol that defines subject positioning, probe orientation, and region-of-interest placement to capture dermis, subcutaneous adipose, the superficial fascial plane, and adjacent muscle. Example sites include mid-biceps, a lateral peri-umbilical abdominal window, and a mid-thigh quadriceps view. The probe is applied with minimal compression and perpendicular insonation to maximize boundary contrast. The system may accept single frames, short cine sweeps, or triplicate captures per site and can automatically screen for motion, reverberation, inadequate field of view, or insufficient coverage of target layers.

According to some aspects, the invention is device-agnostic and harmonizes inputs prior to learning. In certain implementations, preprocessing normalizes pixel spacing from metadata or scale bars, standardizes brightness and contrast across vendors, and applies speckle-aware denoising (e.g., median or anisotropic filters) that preserve fascia while reducing granular noise. Frames failing quality thresholds are rejected or routed for reacquisition with operator prompts. Accepted frames are cropped and resampled to a canonical tensor size suitable for downstream inference. In some embodiments, the technology provides a segmentation backbone—such as an encoder-decoder network with skip connections—that produces pixel-wise delineations of subcutaneous fat and the muscle fascia. The masks and normalized gray-scale imagery are embedded into a learned feature space from which a regression head predicts FM and/or FFM. Multi-task variants jointly predict both compartments with shared encoders. Training losses can include overlap terms (e.g., Dice) for segmentation and L1/L2 components for regression, optionally augmented with boundary-aware or calibration losses to improve agreement with reference methods.

In certain aspects, per-region predictions are fused to improve accuracy and resilience. For example, biceps, abdomen, and quadriceps streams can be aggregated by late fusion of region-level embeddings or by ensembling independent regressors. Where acquisition time is constrained, an acquisition planner recommends a minimal subset of regions expected to satisfy an error target, updating recommendations in real time based on observed image quality. The system, in some embodiments, provides interpretable outputs and governance signals. Outputs may include numerical FM/FFM values with units, confidence or uncertainty estimates derived from model dispersion or Monte-Carlo sampling, and explanation overlays (e.g., saliency/Grad-CAM) highlighting image zones most influential to the prediction. A quality score per frame and per study can be surfaced to guide reacquisition. Audit trails link inputs and outputs to model versions, acquisition parameters, and operator identifiers to support clinical review.

According to some aspects, the invention is deployable in multiple compute topologies. An edge component on an ultrasound tablet or probe may run preprocessing and segmentation, while a secure service performs regression and fusion; alternatively, a fully local pipeline executes when connectivity is limited. The system can export structured results to electronic records and store de-identified images, masks, and predictions in secure storage associated with a subject and/or a newborn identifier, enabling longitudinal trend analysis across encounters.

In some embodiments, the technology provides a training pipeline that ingests labeled datasets of neonatal ultrasound paired with reference body-composition measures. The pipeline applies standardized curation and augmentation (e.g., small rotations, flips, modest gain jitter) to improve generalization, partitions data into training/validation/test cohorts, and performs cross-validation with early stopping. Ablation studies may compare preprocessing options, architectures (e.g., UNet, EfficientNet/ResNet backbones), and fusion strategies, while agreement is quantified by MAPE, MAE, MSE/RMSE, scatter-plot calibration, and Bland-Altman analysis. In use, the system assists clinicians and allied health staff at the point of care. A guided interface teaches probe placement with anatomical cues, verifies that the ROI includes skin, fat, and fascia, and signals when coverage is adequate. Within seconds, a report appears with FM and FFM, optional percentile contextualization, confidence bounds, and a compact audit panel. Serial measurements enable clinicians to assess response to feeding interventions, optimize discharge planning, and flag infants at elevated risk for under- or over-nutrition for closer follow-up.

According to some aspects, the invention is robust to vendor and setting variability via intensity and scale harmonization and by learning features that emphasize stable sonographic landmarks (e.g., echogenic fascia and muscle texture) over device-specific noise. Optional cohort-level calibration can reduce systematic bias relative to reference techniques. The same framework extends naturally to additional anatomical sites or modalities, and supports model updates with traceable versioning and shadow evaluation before promotion.

In some embodiments, safety and privacy are addressed throughout. The pipeline can operate on de-identified frames; role-based access controls limit data visibility; and encryption protects data in transit and at rest. Quality gates and uncertainty thresholds can trigger human review or reacquisition prompts, ensuring that automated outputs augment, rather than replace, clinical judgment.

Collectively, these embodiments provide a practical, reproducible pathway to translate widely available ultrasound signals into actionable nutritional metrics in subjects. By uniting standardized acquisition, automated segmentation, region-fusion regression, interpretable reporting, and deployment flexibility, the invention equips clinicians with an objective, bedside tool to quantify FM and FFM and to personalize early nutrition in diverse care environments.

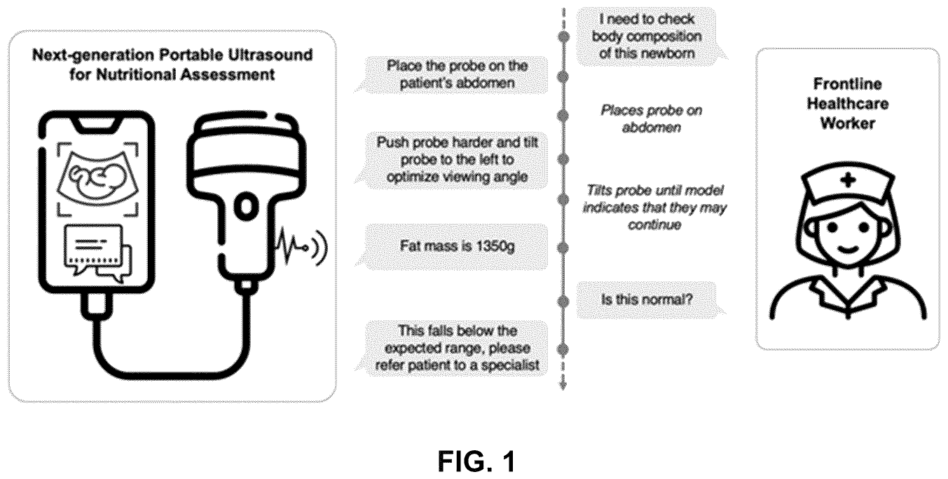

According to some more detailed aspects, a study protocol is presented. Malnutrition represents a significant “double burden,” characterized by the coexistence of undernutrition and overnutrition as critical healthcare challenges affecting populations globally. The consequences of this burden impact all countries, regardless of economic status. A promising solution lies in ultrasound imaging, which, due to its low cost and capacity to evaluate adipose tissue and skeletal muscle, could serve as an effective tool for assessing nutritional status and guiding appropriate interventions. In a non-limiting example, FIG. 1 depicts an end-to-end neonatal ultrasound assessment workflow. At left, a probe acquires frames at defined sites (biceps, abdomen, quadriceps). Images pass an initial quality gate (motion/coverage) before standardized preprocessing (scale, denoise, brightness/contrast). A segmentation stage (e.g., encoder-decoder) delineates tissue layers; features from the normalized image and masks feed a regression stage to estimate body-composition outputs—fat mass (FM) and fat-free mass (FFM). When multiple sites are imaged, a fusion block combines region-level predictions. Outputs include numerical FM/FFM, an uncertainty score, and an explainability overlay highlighting informative regions. The rightmost panel shows a report on a clinician display. An edge/cloud note indicates optional on-device preprocessing with remote inference and secure data storage.

This study will recruit 10 preterm and 15 term infants from two locations: Brigham & Women's Hospital in Boston, MA and Jimma Medical Center in Jimma, Ethiopia. Eligible participants will have stable cardiovascular and respiratory status at the time of observation and will be excluded if they experience any health-related issues affecting growth or nutrient accretion, any factors hindering ultrasound performance, or if they require respiratory support or intravenous therapy beyond discharge. During data collection, the following measurements will be taken for each infant: (a) ultrasound image and video “sweep” data using a portable ultrasound system focused on the abdomen, biceps, and quadriceps; (b) anthropometric measures, including height, weight, head circumference, and mid-upper arm circumference, along with basic demographic information; and (c) fat and fat-free mass measured using a PEAPOD air-displacement plethysmography device, a recognized standard for body composition analysis.

This study has the potential to generate crucial data that could lead to a more efficient method for measuring body composition, and allow for the effective assessment of growth and development using portable ultrasound systems. The ultimate aim is to develop a tool that enables frontline healthcare workers to measure body composition at a lower cost and without the necessity for specialized personnel to operate the device. This approach could significantly enhance the accessibility and practicality of body composition and nutritional assessments across a diverse range of healthcare settings.

Ultrasound and machine learning for body composition and nutritional status assessment in subjects and/or in newborns: a pilot study discussion: Background; malnutrition represents a significant “double burden,” characterized by the coexistence of undernutrition and overnutrition as critical healthcare challenges affecting populations globally. The consequences of this burden impact all countries, regardless of economic status. A promising solution lies in ultrasound imaging, which, due to its low cost and capacity to evaluate adipose tissue and skeletal muscle, could serve as an effective tool for assessing nutritional status and guiding appropriate interventions.

Methods: This study will recruit 10 preterm and 15 term infants from two locations: Brigham & Women's Hospital in Boston, MA and Jimma Medical Center in Jimma, Ethiopia. Eligible participants will have stable cardiovascular and respiratory status at the time of observation and will be excluded if they experience any health-related issues affecting growth or nutrient accretion, any factors hindering ultrasound performance, or if they require respiratory support or intravenous therapy beyond discharge. During data collection, the following measurements will be taken for each infant: (a) ultrasound image and video “sweep” data using a portable ultrasound system focused on the abdomen, biceps, and quadriceps; (b) anthropometric measures, including height, weight, head circumference, and mid-upper arm circumference, along with basic demographic information; and (c) fat and fat-free mass measured using a PEAPOD air-displacement plethysmography device, a recognized standard for body composition analysis.

Discussion: This study has the potential to generate crucial data that could lead to a more efficient method for measuring body composition, and allow for the effective assessment of growth and development using portable ultrasound systems. The ultimate aim is to develop a tool that enables frontline healthcare workers to measure body composition at a lower cost and without the necessity for specialized personnel to operate the device. This approach could significantly enhance the accessibility and practicality of body composition and nutritional assessments across a diverse range of healthcare settings.

Additional background: Global malnutrition is considered a “double burden,” with both undernutrition and overnutrition coexisting as healthcare challenges within the same populations (Wells, et al., 2020). The consequences of this burden are significant, affecting all countries regardless of economic status. For instance, early-life undernutrition leads to stunting and wasting, contributing to nearly 50 percent of deaths among children under five globally. Survivors often face increased risks of reduced capacity to resist disease, impaired physical performance, and challenges in educational advancement (UNICEF, 2021). Later in life, obesity serves as a primary contributor to numerous non-communicable diseases, including diabetes, heart disease, and hypertension (Shrimpton & Rokx, 2012).

To monitor a patient's nutritional health, healthcare workers typically rely on anthropometric indicators such as weight, height, and body mass index (BMI). While these measures are straightforward to obtain, they do not provide a comprehensive assessment of healthy growth and development. Specifically, these traditional metrics may overlook critical factors such as the distribution of body fat and lean mass, which are essential for understanding overall health. For example, a subject may regain weight after treatment for malnourishment, yet it remains unclear whether this weight gain is due to unhealthy fat accumulation or healthy muscle development. As a result, relying solely on anthropometric indicators can lead to misinterpretations of an individual's nutritional status, potentially hindering the implementation of targeted and effective interventions.

Recently, measures of body composition such as fat mass (FM) and fat-free mass (FFM) have been explored to study the quality of growth, the partitioning of nutrients to fat-free or fat mass, and how to define more appropriate nutritional interventions (Demerath & Fields, 2014). Despite promising studies and recommendations from international agencies to utilize these metrics, body composition measurements remain difficult to obtain, requiring expensive equipment, specialized facilities, and trained staff. This challenge limits their widespread use, particularly for use at the point of care and in low-resource settings.

A promising alternative is ultrasound imaging, which, due to its low cost and ability to assess measures of adipose tissue and skeletal muscle, could serve as a practical assessment tool for nutritional status assessment and informing appropriate interventions (McLeod, et al., 2013; Ponti, et al., 2020). This study aims to utilize a low cost and portable ultrasound device in diverse populations to explore its feasibility, compare its data with other body composition measures, and analyze ultrasound images to predict body composition and nutritional status.

Study Rationale: The overarching objective of this research is to develop, through a human-centered and iterative design process, a novel artificial intelligence (AI)-enabled ultrasound tool that determines critical body composition measures for nutritional assessment. As this is a pilot study, it will focus on infants with diverse nutritional statuses, including both preterm and full-term infants. The eventual realization of the tool will involve machine learning (ML) models that predict body composition metrics, integrated as part of an ultrasound system for use by frontline healthcare workers. The ultimate goal is to improve clinical diagnosis and the experiences and outcomes of patients burdened by malnutrition.

Aims; Example specific aims of this study are now detailed. Aim 1: Feasibility, acceptability, inter-rater reliability, and refinement of ultrasound protocol. This pilot study will evaluate the overall feasibility of integrating an ultrasound scanning protocol, taking into account acceptability, implementation logistics, and practicality in both study settings. We will monitor the acceptability of ultrasound imaging among families and staff in the newborn care units and evaluate the feasibility of incorporating research measurements into the workflow, including scheduling around infant care times in the NICU and tracking recruitment and retention rates. Implementation logistics will be measured through protocol adherence, using metrics such as time to consent, duration of data collection, success in using a portable ultrasound device to capture images, and management of missing data. This process will also allow us to refine the ultrasound protocol based on real-time feedback from staff using the tools. Additionally, inter-rater reliability analysis at one facility will be incorporated into the validation of this technique. Overall, we will focus on practicality by evaluating factors such as the recruitment timeline and the costs (e.g., equipment, software, person-hours) necessary to complete the study. In other embodiments, acquisition occurs in obstetric clinics, diabetes/endocrinology clinics, primary-care, or community screening settings.

Aim 2: Data collection of ultrasound images, gold standard body composition, and associated clinical data. Currently, there is no established standard protocol for collecting ultrasound images or videos to assess body composition in subjects. Therefore, we developed a clinical protocol for data collection based on published literature and consultations with pediatric radiologists. We will create a database comprising ultrasound scans, gold standard body composition measures, and associated clinical data according to a consented clinical protocol.

Aim 3: Ultrasound image analysis and training ML models to predict body composition and nutritional status. Ultrasound image and video data will be stripped of patient identifiers, tagged with “ground truth” measures of anthropometry and body composition from air displacement plethysmography, and pre-processed. Our team will develop a convolutional neural network (CNN) architecture and train the CNN to identify optimal image markers that predict body composition measurements and overall nutritional status. In addition to 2D measurements of ultrasound-derived tissue thickness—which some studies have found inadequate as surrogates for body composition—we will examine echogenicity, elastography, and other image features as part of model training. We will also develop a pre-processing pipeline to prepare the raw images and videos from the database, augmenting them to create a training dataset aimed at improving model accuracy. Images and videos will be divided and tagged based on the anatomical location of data collection: abdomen, biceps, and quadriceps. The CNN will be trained to estimate body composition from each combination of these sets. A validation/tuning set will determine the optimal network structure and classifier variations based on training runs, while an independent test set will evaluate performance until the classifier is finalized. To assess the model, we will calculate and report the mean absolute error (MAE), mean square error (MSE), and the 95% confidence interval.

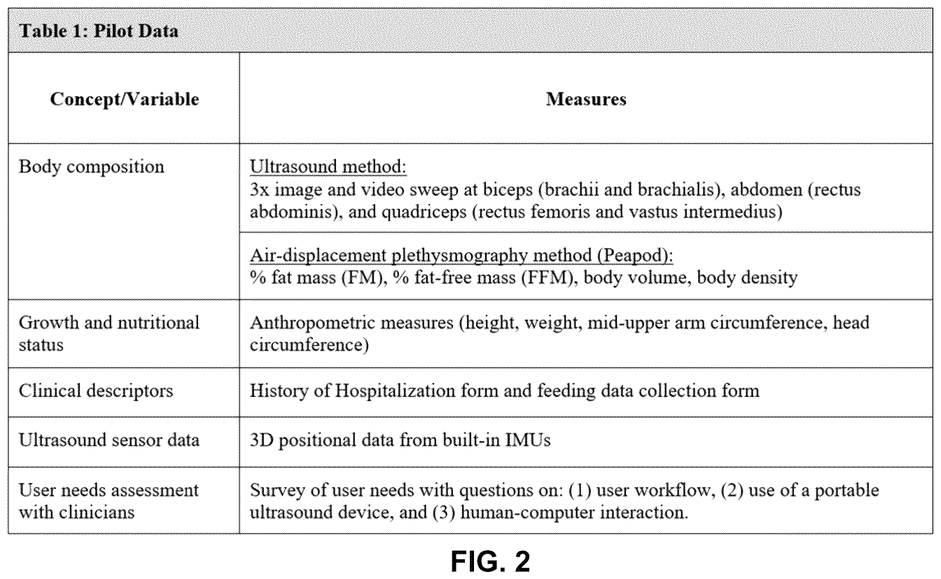

Methods; Study Design; This pilot study is prospective, cross-sectional, and multi-center. A summary of the data that will be collected is provided in Table 1 (FIG. 2). In some embodiments, FIG. 2 presents a structured overview of the study design and variables used in neonatal body-composition assessment of subjects (including neonates, children, adolescents, adults, pregnant subjects, and subjects with diabetes). Rows group information into demographics (sex, gestational age, birthweight), anthropometrics (weight, length, head circumference, postnatal age at scan), ultrasound acquisition (anatomical site—biceps, abdomen, quadriceps; probe settings; depth; frame count; image-quality flag), and derived image features (segmentation outputs, regional measures). Outcome definitions specify reference fat mass (FM) and fat-free mass (FFM) with units, alongside evaluation metrics and dataset partitions (training/validation/test counts). Additional columns indicate data source (scan vs. clinical record), collection timing, and handling of missing or excluded entries. Abbreviations are listed at the foot of the table to standardize terminology across figures and text.

Approvals: This study has received ethical approval from the Institutional Review Boards (IRBs) of Boston College, Mass General Brigham, and Jimma University.

Study Population: Clinically stable full-term and pre-term infants will be recruited for the study. Full-term infants will undergo measurement once during the first 72 hours after birth, prior to discharge. Preterm infants (born at less than 37 weeks gestation) will begin participation during hospitalization, once they are deemed clinically stable for participation by the primary medical team.

Inclusion criteria: Inclusion criteria for the study require that participants have stable cardiovascular and respiratory status at the time of observation.

Exclusion criteria: Participants will be excluded from the study if they have congenital anomalies of the limbs, injuries, or medical conditions that would interfere with the ability to perform the ultrasound. Additionally, those with genetic anomalies that impact growth or nutrient accretion will also be excluded. Lastly, subjects requiring respiratory support or intravenous therapy beyond the time of discharge or clinic visit will not be eligible for participation.

Sample size rationale: In this pilot study, data will be collected from 25 infants (10 preterm and 15 full-term) at each site who meet the study eligibility criteria, resulting in a total of 50 infants scanned. This sample size is intended to refine the data collection protocol, conduct preliminary image analysis, and determine the sample size for the next phase of the project.

Clinical Data Collection: At the time of discharge or clinic visit, clinical data will be extracted from the participant's medical record, including the subject's basic demographics, birth and health history during hospitalization, and maternal pregnancy history. All data entered by site clinicians will be de-identified, and this de-identified data will then be entered into a secure web-based database (REDCap). Additionally, all collected images will be stored on the secure Clarius cloud online platform (cloud.clarius.com) associated with the device. For pregnant subjects, pertinent obstetric records may be reviewed; for subjects with diabetes, endocrinology or primary-care records may be consulted.

Outcome Measures:
1. Database of annotated ultrasound images and body composition metrics: The primary outcome will be the creation of a database of ultrasound images and videos of muscle and adipose tissue in newborns, annotated with gold standard measurements of body composition (FM and FFM from PEAPOD) and anthropometric measures of nutritional status.
2. Influence of clinical descriptors on body composition: Secondary variables from the clinical data, such as the participants' age, health condition, sex, race, dietary nutrition, will be included to evaluate their potential influence on body composition.
3. Validation of ML algorithms for body composition estimation: The expected outcomes include validated ML algorithms utilizing CNNs to estimate body composition measures and nutritional status in subjects from ultrasound image and video data, which may be applicable to larger population sizes. The goal is to identify anatomical regions that are most indicative of body composition through ultrasound sensor data.
4. Refinement of ultrasound protocol based on user needs assessment: The outcome of assessing workflow, ultrasound device usability, and human-computer interaction will be to refine the ultrasound protocol and improve the experience for staff using the tool in real time, as well as in future larger cohort studies based on feedback.

Study Setting: Data will be collected at two primary sites: one in the United States and one in Ethiopia. In the United States, the study will take place at the Brigham and Women's Hospital in the largest Level 3 neonatal intensive care unit (NICU) in the New England region, along with the associated Well Baby/Postpartum Unit. In Ethiopia, the data collection will occur in the NICU and Outpatient Pediatric Department (OPD) of Jimma Medical Center, a tertiary referral hospital located in the southwest region of the country. These two diverse settings will facilitate an evaluation of the project's feasibility across diverse environments.

Study Procedures: A cohort of preterm infants (gestational age <37 weeks at birth) will be recruited during their hospitalization with written consent from their parents. These infants, who may remain in the hospital for several weeks, will be measured at three time points, if possible: (1) at the earliest opportunity when the infant is free from any breathing support, (2) again at 36 weeks postmenstrual age, and (3) just before discharge. If the infant has been scheduled for additional testing with the gold standard body composition measurement (i.e., PEAPOD) for clinical or research purposes at other time points, additional ultrasound measurements may be taken to coincide with the PEAPOD assessments. However, ultrasound will not be performed more frequently than once per week.

Full-term infants will be recruited and measured once during the first 72 hours after birth. At the time of each study observation, the following measurements will be taken: (a) anthropometric measures (e.g., height, weight, head circumference, mid-upper arm circumference) along with basic demographic and clinical information, (b) fat and fat-free mass using a PEAPOD air-displacement plethysmography device, a recognized standard for acquiring infant body composition, and (c) ultrasound image and video “sweep” data using an FDA-approved portable mobile phone-based ultrasound system to assess the infant's abdomen, biceps, and quadriceps. Previous studies have demonstrated that muscle and adipose tissue thickness in adults and adolescents can predict whole-body composition (Leahy, et al., 2012; Takai, et al., 2014). The selected measurement locations were based on Nagel, et al.'s protocol for predicting body composition in premature infants through ultrasound measurements of muscle and adipose tissue thickness, as well as the feasibility of measuring these areas in infants in a supine position (Nagel, et al., 2021).

The video “sweep” data will be essential for generating a robust dataset rich in anatomical information for analysis. This innovative approach, which has not been previously employed in ultrasound protocols for body composition measurements, offers several advantages that enhance our data collection process. First, it generates a larger volume of data, allowing for more comprehensive analyses. Second, the use of video sweep data simplifies scanning procedures by requiring less expertise. Instead of needing to identify and capture a specific image frame, operators can simply “sweep” across an area, thereby reducing reliance on trained experts for precise image freeze framing. This feature sets our study apart from existing protocols, such as those outlined in Nagel, et al., and contributes to the overall feasibility and efficiency of our data collection efforts (Nagel, et al., 2021).

Standard Operating Procedures for Ultrasound Data Collection: A standard operating procedure (SOP) for collecting ultrasound images and videos to assess body composition in subjects and/or in infants will be developed based on published literature and consultations with pediatric radiologists (Nagel, et al., 2021). For the imaging procedures, the Clarius L20 and Clarius L15 high-frequency linear array scanners will be utilized, accompanied by a standard tablet device (Clarius, 2024).

Measurements will be taken in triplicate on the right side of the participant's body, unless otherwise specified, once the participant is deemed clinically stable by the primary medical care team. The ultrasound probe must be placed perpendicular to the muscle of interest. To ensure that images can be effectively used for both AI training and clinical data evaluation, it is crucial that the visualization of skin, fat, muscle, and tissue regions is clear and distinguishable.

Zero or minimal compression will be applied during all measurements to optimize the visualization of the body's natural curvature. This technique is crucial for accurately capturing anatomical features, as excessive pressure can distort soft tissues and compromise the appearance of muscle and adipose tissue. By minimizing compression, we ensure that key regions—such as skin, fat, and muscle—remain clearly distinguishable in the ultrasound images. This practice not only enhances data quality but also prioritizes the comfort and safety of the subject and/or the infant, leading to more reliable assessments of body composition and ultimately improving the effectiveness of subsequent analyses and interventions.

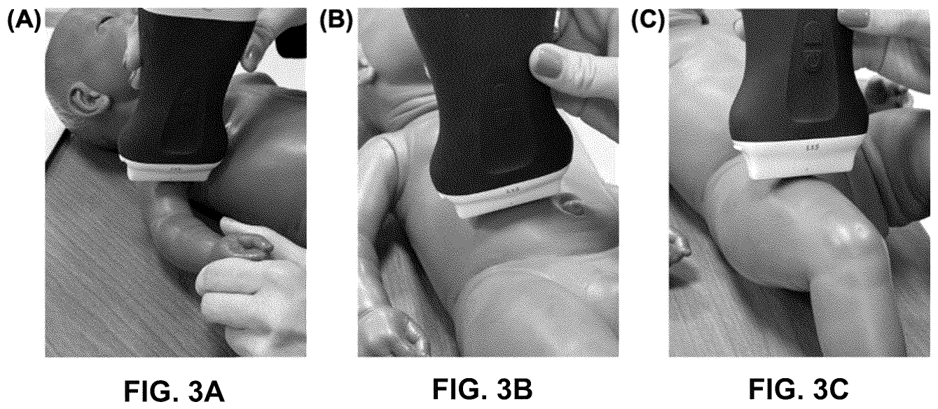

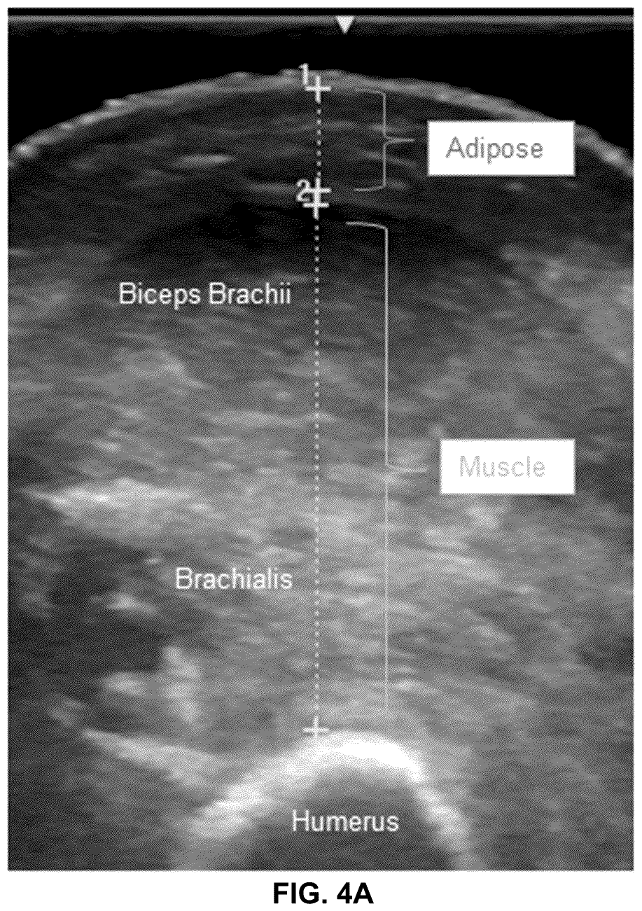

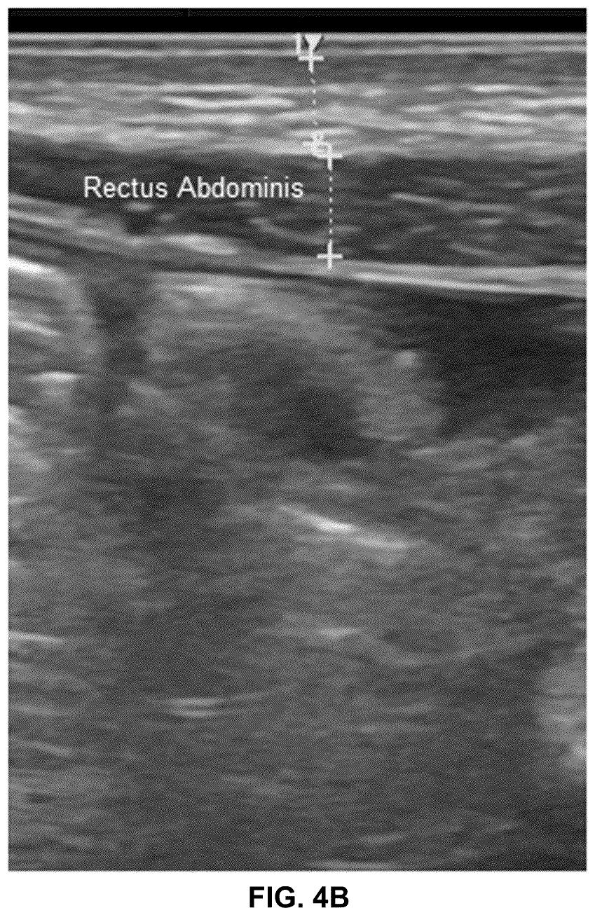

The anatomical placement of the ultrasound probe is outlined in FIGS. 3A-3C, which depict examples of the three distinct muscle regions of interest, along with the appropriate body positioning and anatomical references for measurement points. Once prepared for image collection, three still images will be captured, followed by three video sweeps of the designated region. A radiologist associated with the study will review the collected images and videos to rule out any notable clinical significance that may affect the participant's medical plan of care.

FIG. 3A, FIG. 3B, and FIG. 3C: (FIG. 3A) Biceps (biceps brachii and brachialis). Body position: supine with arm extended (palm up). Measurement point: ½ distance between acromion (shoulder) to antecubital crease of the arm on anterior centerline of the arm (shoulder and elbow). (FIG. 3B) Abdomen (rectus abdominis). Body position: supine

Measurement point: between costal margin and anterior superior iliac crest (bottom of rib cage to top of hip bone), to the appropriate side of the umbilicus (depending on side of subject and/or infant used). (FIG. 3C) Quadriceps (vastus intermedius and rectus femoris). Body position: supine with knee extended and quadriceps relaxed. Measurement point: ½ distance from anterior superior iliac spine to the superior patellar border (hip to knee).

FIG. 3A (Biceps): In some embodiments, this panel shows a representative transverse ultrasound frame of the mid-biceps region. The superficial skin line and subcutaneous fat layer are visible just below the probe face, with fine echogenic septa traversing hypoechoic adipose tissue. A bright fascial plane marks the boundary with the biceps brachii, whose internal fiber pattern is discernible. Depth and scale bars appear along the margins. A region-of-interest bracket and example calipers illustrate standardized subcutaneous-thickness measurement. In some embodiments, an overlay traces the dermis-fat and fat-muscle interfaces used by the model. The image demonstrates adequate coverage, focus, and alignment orthogonal to the muscle fibers.

FIG. 3B (Abdomen): In some embodiments, this panel depicts a transverse abdominal wall scan obtained lateral to the umbilicus, avoiding obvious bowel gas. The superficial skin and subcutaneous fat layer are followed by the bright anterior abdominal fascia, with underlying muscle fibers of the abdominal wall visible as a striated band. Depth annotation and a scale indicator are shown. A rectangular region-of-interest highlights the standardized sampling window used for analysis, and example calipers indicate how subcutaneous thickness is captured. The frame exemplifies correct probe pressure (no excessive compression) and even gain, yielding clear tissue boundaries suitable for segmentation and subsequent feature extraction.

FIG. 3C (Quadriceps): According to some aspects, this panel presents a transverse view at mid-thigh over the quadriceps. The skin and subcutaneous fat layer appear superficially, separated from the rectus femoris and vastus intermedius by a distinct hyperechoic fascial line. Deeper, the anterior femoral cortex forms a bright linear reflector with shadowing beneath. Margin scales provide depth and lateral distance. A region-of-interest marks the analysis window, with example calipers positioned for standardized subcutaneous-thickness capture. The frame demonstrates appropriate orientation relative to muscle fibers and sufficient field-of-view to include superficial fat and the principal fascial boundary, producing a high-quality input for segmentation and prediction.

ML-based Image Analysis: For the analysis of collected images, we will employ deep learning models, including UNet, AttentionUNet, EfficientNet, and ResNet, to predict FM and FFM from ultrasound images. These models are well-suited for image segmentation and classification tasks. UNet and AttentionUNet utilize symmetric downsampling (encoding) and upsampling (decoding) layers, systematically reducing the size of the ultrasound image to capture essential features during encoding and then restoring it to its original resolution during decoding. The AttentionUNet enhances this process with attention mechanisms, allowing the model to selectively focus on the most important features within the image. Meanwhile, ResNet employs residual connections to facilitate the training of deeper models, and EfficientNet optimizes performance through scaling, achieving high accuracy with fewer parameters.

These models will be fine-tuned using the pilot data to optimize their performance and adapt to the specific characteristics of our clinical dataset. During training, the models will learn to extract relevant features from various scales within the images to provide precise predictions. The dataset will be divided into training, validation, and testing subsets. To ensure that the models generate clinically relevant predictions, we will use Gradient-weighted Class Activation Mapping (Grad-CAM), which will produce heatmaps overlaying the ultrasound images. This visualization will highlight the specific areas of focus for the models during their predictions.

We will select the deep learning model based on a clinical analysis of their Grad-CAM heatmaps and their accuracy in predicting FM and FFM. The accuracy of these predictions compared to the ground truth will be assessed using the following metrics: (1) Root Mean Squared Error (RMSE), (2) Mean Absolute Percentage Error (MAPE), (3) Mean Absolute Error (MAE), and (4) Mean Squared Error (MSE).

Safety & Adverse Event Reporting: Any adverse events will be reported to the Principal Investigator (PI), who will review and document them appropriately. The PI will hold regular meetings with the study team to discuss any minor adverse events that arise. While serious adverse events are not expected due to the low-risk nature of the study procedures, any such event will be reported to the PI immediately. The PI will then inform the Institutional Review Board (IRB) in accordance with reporting guidelines for unanticipated problems and adverse events.

Quality Assurance: Data will be entered into a REDCap database, which includes built-in data quality checking functions. The PI will primarily oversee the implementation of the project, ensuring the accuracy and completeness of data collection.

Discussion: Measuring human body composition, including FM and FFM, is essential for assessing health and nutritional status, understanding the impact of disease, and evaluating changes resulting from nutritional, therapeutic, or behavioral interventions. However, obtaining these measurements can be challenging, and often require expensive equipment, specialized facilities, and trained personnel. With the advent of low-cost mobile ultrasound systems, and ultrasound's demonstrated effectiveness in assessing adipose tissue and skeletal muscle, this protocol aims to develop a novel ultrasound tool that guides users in collecting high-quality data and automatically determining body composition metrics for nutritional evaluation.

This project has significant potential benefits for both society and the medical field, as it seeks to generate pivotal data that can create a more efficient means of measuring body composition, thereby adequately assessing growth and development. The ultimate goal is to develop a tool that enables frontline healthcare workers to measure body composition cost-effectively and without the need for specialized training to operate the device. Increasing access to body composition measurement tools can help mitigate challenges related to diagnosing and treating undernutrition and overnutrition, particularly in low-resource settings.

By implementing this pilot study in two distinct environments, we aim to evaluate the device's applicability across various contexts and demographics. This will enhance the generalizability and effectiveness in assessing body composition. This could ultimately contribute to a reduction in mortality rates associated with nutritional health issues and foster a deeper understanding of the relationship between nutritional health, certain diseases, and overall quality of life.

Limitations: A primary limitation of this pilot study is the relatively small recruitment size, which may affect the generalizability of the findings. Preliminary analysis will help identify an optimal sample size for future studies, with the ultimate aim of conducting a larger longitudinal study. Additionally, there is currently no standardized ultrasound protocol for measuring body composition, and to the author's knowledge, no prior studies have utilized portable ultrasound systems for this purpose. Although comprehensive training was provided to staff for image and video collection, potential operational variability must be considered, as it may impact the quality of the collected data.

Ethics approval and consent to participate: This study has received ethical approval from the Boston College IRB, Mass General Brigham IRB, and Jimma University IRB. Written informed consent will be obtained from the parents or legal guardians of all participants prior to enrollment in the study. The consent process will ensure that caregivers are fully informed about the study's purpose, procedures, potential risks, and benefits, and their rights to withdraw from the study at any time without any impact on their child's medical care. All data will be collected and handled in accordance with ethical guidelines to ensure participant confidentiality throughout the study.

### Enhancing Subject Health Assessment: Ultrasound-Based Body Composition Prediction Using Deep Learning Techniques

According to some aspects, this study investigates the feasibility of deep learning to predict body composition with ultrasound, specifically fat mass (FM) and fat free mass (FFM), to improve newborn health assessments.

Methods: We analyzed 721 ultrasound images of the biceps, quadriceps, and abdomen from 65 preterm infants. A deep learning model incorporating a modified U-Net architecture was developed to predict FM and FFM, using air displacement plethysmography (ADP) as ground-truth labels for training. Model performance was assessed using mean absolute error (MAE), mean squared error (MSE), root mean square error (RMSE), and mean absolute percentage error (MAPE), along with Bland-Altman plots to evaluate mean bias and limits of agreement. We tested different image combinations to determine the contribution of anatomical regions. Grad-CAM was applied to identify image regions with the strongest influence on predictions.

Results: Combining biceps, quadriceps, and abdomen ultrasound images to predict whole-body composition showed strong agreement with ground truth values, with low MAE (FM: 0.0145 kg, FFM: 0.0794 kg), MSE (FM: 0.0003 kg, FFM: 0.0073 kg), RMSE (FM: 0.0183 kg, FFM: 0.0854 kg), and MAPE (FM: 2.65%, FFM: 8.40%). Using only abdomen images for prediction improved FFM performance (MAPE=4.62%, MSE=0.0041 kg, RMSE=0.0486 kg, MAE=0.0378 kg). Grad-CAM revealed muscle regions as key contributors to FM and FFM predictions.

Example Conclusion: Deep learning provides a promising approach for predicting body composition with ultrasound and a valuable tool for assessing nutritional status in neonatal care.

Introduction: Malnutrition represents a significant public health challenge, affecting over 45 million children under five years of age globally. Approximately one in eight children does not receive adequate nutrition to support healthy growth and development. At the same time, the rising prevalence of obesity is also influenced by early-life growth patterns, with rapid weight gain in infancy increasing the risk of obesity later in childhood and adulthood. Accurate monitoring of children's growth patterns is essential for identifying nutritional risk and timely intervention. However, current methods primarily rely on simple anthropometric measurements such as height, weight, and body mass index (BMI), which do not provide detailed insights into whether weight gain is due to fat accumulation or healthy muscle development.

Assessing body composition, including fat mass (FM) and fat-free mass (FFM), is valuable for evaluating nutritional status, health outcomes, and responses to interventions. However, accurate measurement typically requires specialized equipment, such as dual-energy X-ray absorptiometry (DXA), computed tomography (CT), or air displacement plethysmography (ADP). These methods are costly, require trained personnel, and are often inaccessible in many clinical and resource-limited settings.

Ultrasound offers a portable, affordable, noninvasive, and radiation-free approach to body composition assessment. It has been applied in various populations, including older adults, children with nephrotic syndrome, and individuals with disease-related malnutrition, to assess fat and muscle. Compared to DXA and CT, ultrasound is safer and more suitable for repeated use. However, its use in automated body composition analysis remains limited. Most existing methods rely on manual measurement of single-plane fat or muscle thickness, which limits reproducibility and does not utilize the full potential of image data. Automated methods leveraging multidimensional features may enable more robust and scalable assessments.

The advantages of ultrasound are particularly relevant for vulnerable populations, such as preterm infants, yet its application in this population remains limited. Prior work has shown ultrasound can reliably measure muscle and fat thickness in premature infants, but efforts to utilize these measurements to predict whole-body composition have shown poor accuracy and low predictive ability. Importantly, prior models relied on human operators to extract single-plane fat or muscle thickness from ultrasound images, limiting reproducibility and data utility. Integrating ultrasound with deep learning-based automated prediction methods may better leverage multidimensional imaging data and improve predictive accuracy.

Deep learning has emerged as a powerful tool for medical image analysis, including ultrasound image segmentation and classification. It has also been applied to body composition prediction using CT for image acquisition and segmentation. However, its use with ultrasound for this purpose remains unexplored. Given ultrasound's ability to distinguish adipose from muscle tissue and the growing availability of low-cost portable systems, deep learning integrated with ultrasound presents a promising method to assess nutritional and growth metrics.

The objective of this study is to develop a deep learning-based end-to-end method for automated prediction of body composition with ultrasound. Specifically, we aim to validate the feasibility of a deep learning model trained with ultrasound images obtained from preterm infants and ADP-measured ground-truth body composition data, and to evaluate specific model components that contribute to whole-body composition prediction. This approach has the potential to enhance body composition assessment, providing a practical, accurate, and scalable solution for clinical implementation.

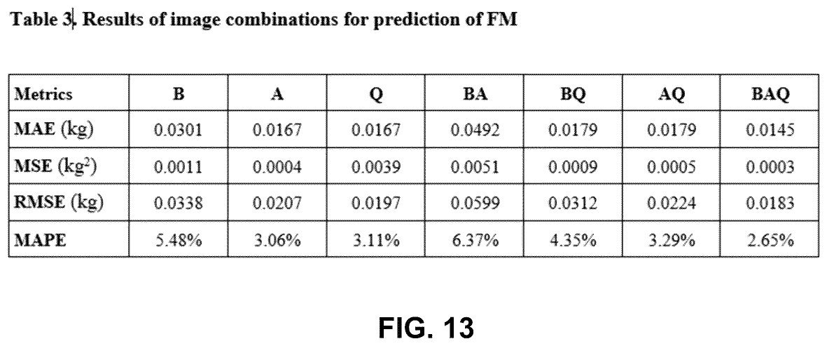

Materials and Methods: Subjects; we conducted a secondary analysis of ultrasound images and clinical data from an observational cohort study at the University of Minnesota Medical Center. The original study enrolled 68 preterm infants born between 25- and 34-weeks' gestation who were clinically stable (i.e., not requiring respiratory support or intravenous fluids). Ultrasound imaging of the arm, leg, and abdomen was performed alongside body composition measurement using ADP. Postmenstrual age (PMA) at the time of measurement ranged from 32.60 to 38.70 weeks. For this secondary analysis, we included 65 infants with available ultrasound data. For clinical data, descriptive characteristics of the cohort are summarized in Table 2 (FIG. 12). Only FM and FFM from ADP were used as ground truth for model training.

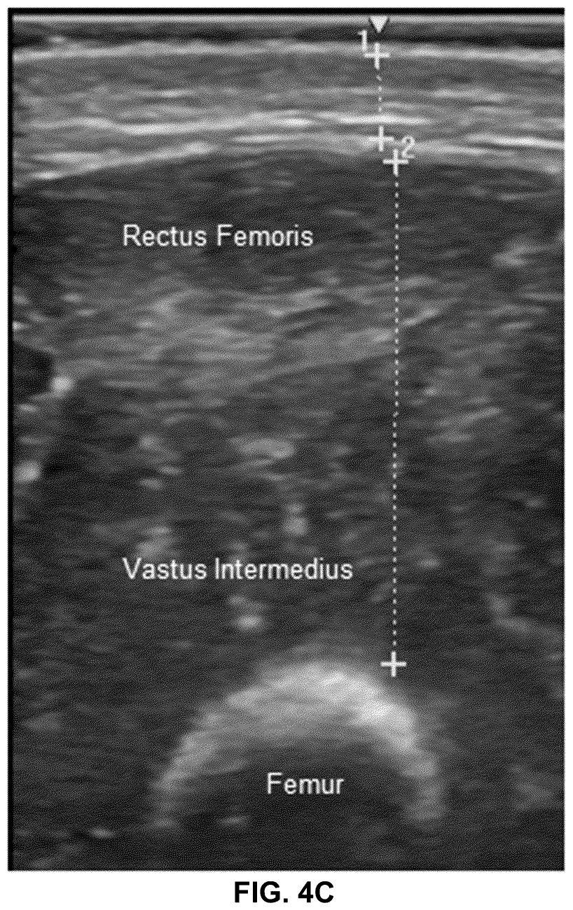

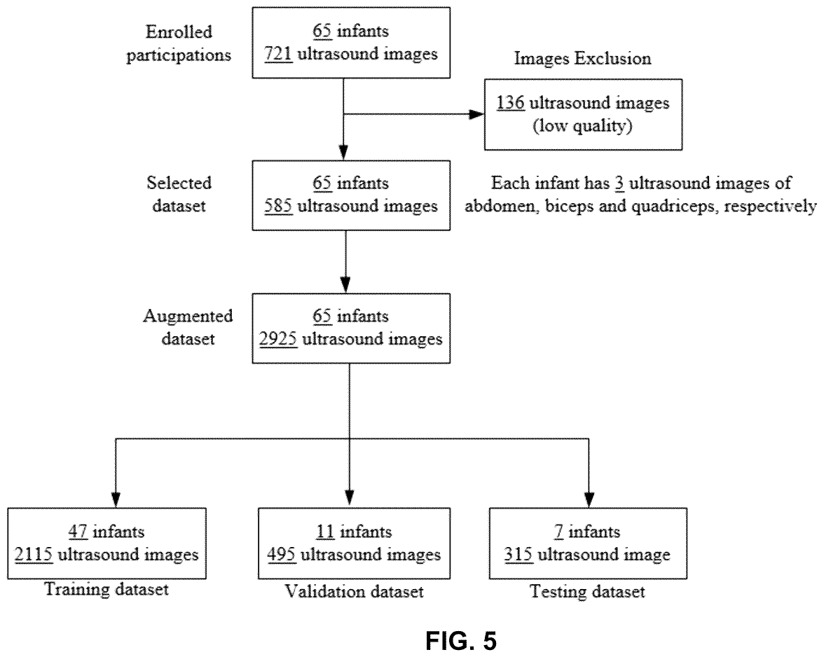

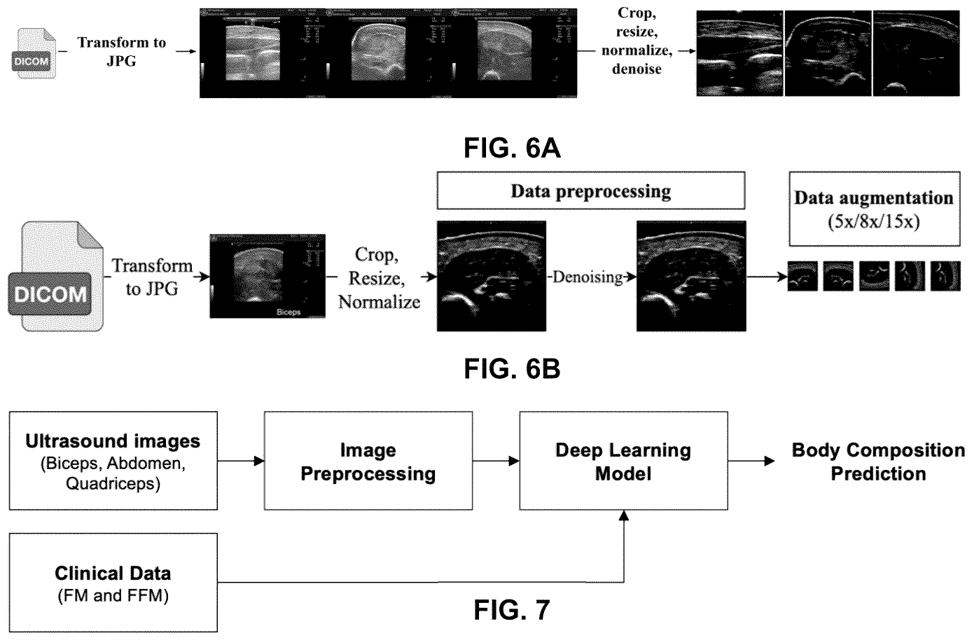

Data curation: A dataset of 721 ultrasound images from the 65 infants was curated. Images were collected at three anatomic sites—the biceps (brachii and brachialis), abdomen (rectus abdominis), and quadriceps (rectus femoris and vastus intermedius)—using a B-mode ultrasound imaging system (NextGen LOGIQ e R7, GE Medical Systems, Chicago, IL). At least three images were acquired per region (FIG. 4A, FIG. 4B, and FIG. 4C).

FIG. 4A (Biceps landmarks and ROI): In an example, this schematic standardizes acquisition at the mid-biceps. It shows external probe placement and an on-screen frame with labeled tissue interfaces: epidermis/dermis, subcutaneous fat, superficial fascia over biceps, and muscle belly. Tick marks indicate depth calibration. A rectangular region of interest (ROI) is centered between lateral artifacts and excludes near-field reverberation. Calipers span from the dermis-fat junction to the fat-muscle fascia to illustrate subcutaneous-thickness capture. Arrows denote the desired beam angle (perpendicular to the fascia) and gentle probe pressure to minimize compression. The panel provides visual cues for consistent framing, focus, and gain across infants and operators.

FIG. 4B (Abdomen landmarks and ROI): According to some aspects, this panel defines a lateral-to-umbilicus abdominal site. The diagram shows the probe footprint relative to surface anatomy and an example frame with annotated layers: skin, subcutaneous fat, anterior abdominal fascia, and superficial abdominal wall muscle. The ROI box avoids umbilical ring and bowel gas, with calipers placed orthogonal to the fascia to measure subcutaneous fat thickness. Guidance arrows illustrate avoiding obliquity and excessive compression; margin scales indicate depth and lateral distance. Notes emphasize maintaining even time-gain compensation and capturing sufficient lateral span so that the ROI lies away from edge artifacts, enabling reproducible segmentation and measurement.

FIG. 4C (Quadriceps landmarks and ROI): In some embodiments, this figure locates a mid-thigh site over rectus femoris. Surface placement of the probe is shown alongside a representative frame labeled with skin, subcutaneous fat, hyperechoic anterior fascia, quadriceps muscle fibers, and the bright femoral cortex deeper in the field. The ROI is centered to include the fat layer and the principal fascial boundary while excluding posterior shadowing from cortex. Calipers demonstrate perpendicular measurement of subcutaneous thickness. Orientation arrows indicate aligning the beam orthogonal to muscle fibers; depth markers and a suggested focal zone are depicted to optimize boundary contrast and minimize partial-volume effects.

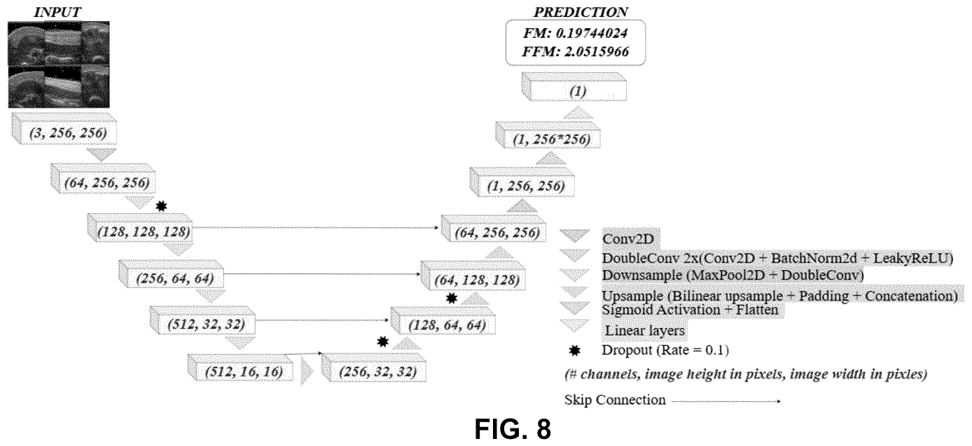

In the ultrasound images, subcutaneous fat appears as bright layers just beneath the skin surface, while muscle layers are visible beneath the fat and distinguished by darker coloration. In biceps and quadriceps images, deeper layers reveal the underlying humerus or femur. Gold standard body composition values (FM, FFM) were obtained using ADP (PeaPod, Cosmed, Ltd, Concord, CA). FIG. 5 presents a flowchart detailing subject selection and the data processing workflow. In some embodiments, FIG. 5 is a flow diagram from enrollment to analysis. Boxes summarize eligibility and consent, followed by imaging at predefined sites (biceps, abdomen, quadriceps). A quality-control gate flags frames with motion or insufficient coverage. Preprocessing nodes apply scale normalization and denoise/contrast harmonization, after which a segmentation stage delineates tissue boundaries. Downstream, feature extraction and region-level fusion feed a prediction block that outputs fat mass (FM) and fat-free mass (FFM). Parallel lanes show dataset partitions (training/validation/test) and evaluation metrics. The final boxes depict reporting (values, uncertainty, and optional overlays) and secure storage tied to a newborn identifier.

Data pre-processing: Ultrasound images in DICOM format were converted to JPEG to reduce file size and ensure compatibility with image processing workflows. The dataset was cleaned through a systematic quality control process. Exclusion criteria included: (i) presence of strong acoustic shadowing or reverberation artifacts, (ii) insufficient contrast between tissue layers, (iii) truncated or inappropriate fields of view, including imaging depth set too shallow to capture the full neonatal region of interest or too deep such that superficial structures were inadequately resolved, and (iv) visible tissue compression or distortion of anatomical boundaries caused by excessive probe pressure. These criteria were applied systematically to ensure consistency across the dataset, and each excluded image was carefully reviewed by at least two researchers to ensure that only valid scans were retained.

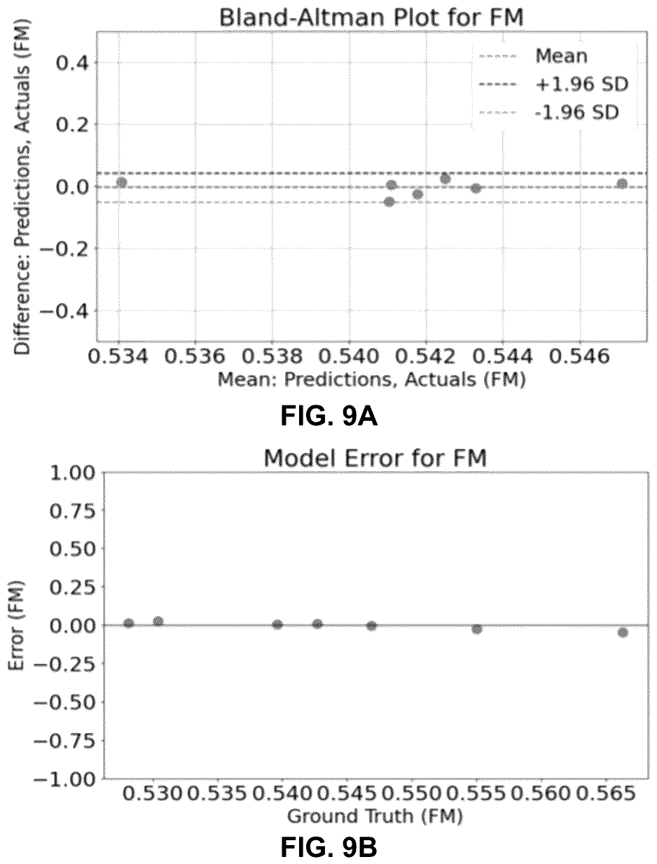

A series of preprocessing steps, illustrated in FIG. 6A, was subsequently applied to the remaining images. Denoising was performed using a median filter, with a pixel size of 5, which we determined through empirical testing to provide the most effective balance between noise reduction and preservation of anatomical detail. The images were then resized to 256×256 pixels to meet model input requirements. Finally, standard normalization with a mean of 0.5 and a standard deviation of 0.5 was applied and standardization was performed to ensure that all images were on the same scale.

Data augmentation was used to enhance generalizability and reduce overfitting. Augmentations included horizontal and vertical flipping, small-angle rotations (±10°), and minor adjustments to brightness and contrast to simulate variability while preserving anatomical integrity. Five augmentations per image provided optimal balance between computational efficiency and predictive performance. This approach is commonly used in deep learning applications to expand limited datasets without requiring additional labeled data. Augmented images were qualitatively reviewed to ensure anatomical fidelity, and stable model performance across augmentation levels demonstrated that the approach increased data diversity without causing lossy reduction of critical anatomical details.

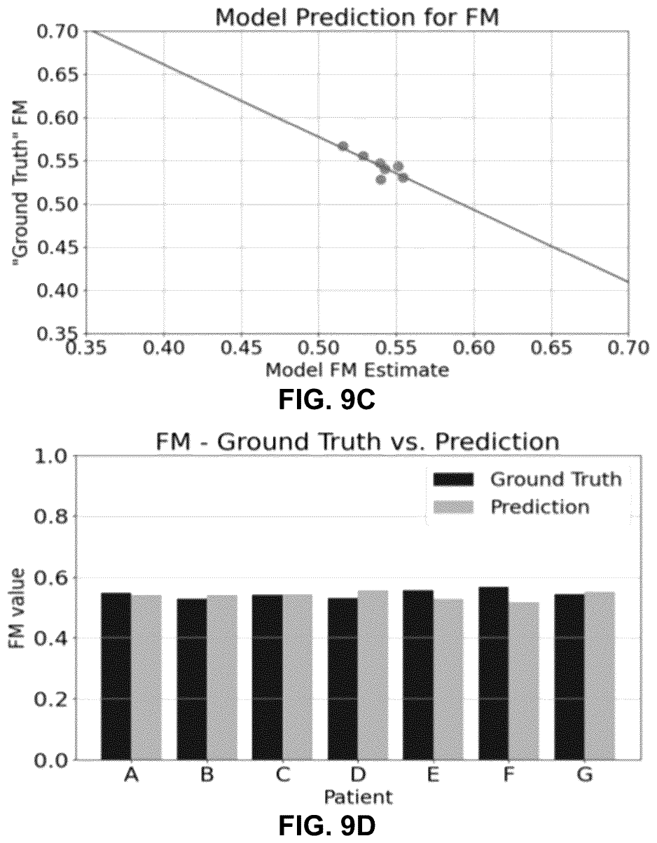

Workflow for deep learning-based body composition prediction: FIG. 7 illustrates the workflow for deep learning-based automated body composition prediction. Preprocessed ultrasound images, along with ground truth (i.e., ADP-measured FM and FFM), were used to train the model. The trained model, upon deployment, can process ultrasound images and automatically generate end-to-end predictions of FM and FFM. In some embodiments, FIG. 7 illustrates an encoder-decoder segmentation network with skip connections. The encoder stacks convolution-normalization-activation blocks with downsampling to capture contextual features, while the decoder upsamples and fuses corresponding encoder features to restore spatial detail. Kernel sizes, channel counts, and optional dropout are annotated per stage. A final 1×1 convolution yields pixel-wise masks delineating subcutaneous fat and muscle fascia. An auxiliary branch extracts features from the normalized image and mask embeddings for downstream regression. Training losses include Dice (for overlap) and cross-entropy, with optional boundary-aware terms to sharpen interfaces.

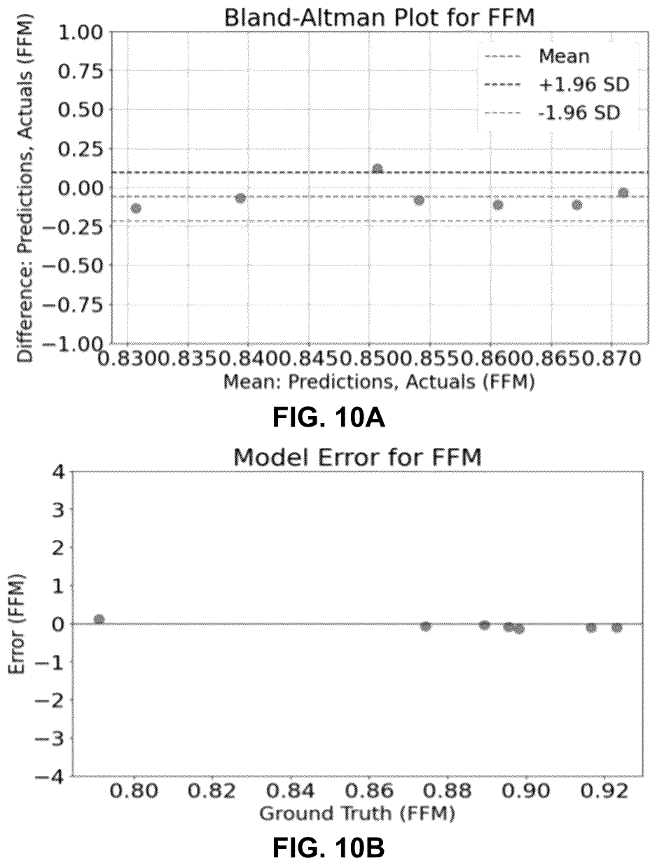

Deep learning model description: As part of model development, we explored several commonly used architectures, including U-Net, EfficientNet, ResNet, and Attention U-Net. U-Net was selected based on its balance of computational efficiency, architectural simplicity, and predictive performance. The architecture of the deep learning model, based on the U-Net framework, is illustrated in FIG. 8. U-Net employs an encoder-decoder structure that captures local and global image features to predict FM and FFM from ultrasound images. For this study, we employed a modified U-Net architecture tailored for the ultrasound regression prediction task. U-Net is frequently used in image segmentation due to its ability to capture spatial hierarchies and contextual relationships within images. This characteristic makes it well-suited for predicting body composition, as structural features play a key role. The encoder-decoder structure facilitates effective feature extraction, while skip connections preserve spatial details essential for accurate prediction. In some embodiments, FIG. 8 details/summarizes dataset curation and model development. After de-identification and site labeling, data are partitioned into training/validation/test cohorts. Preprocessing and augmentation operate on the training stream; validation remains untouched to monitor overfitting. The segmentation network is trained first, producing tissue masks; a regression head is then trained on learned features to predict fat mass (FM) and fat-free mass (FFM). Cross-validation loops and early stopping criteria are shown. Evaluation outputs include scatter plots, Bland-Altman analyses, calibration curves, and mean absolute percentage error, with model selection based on validation agreement.

Each training batch consisted of a PyTorch tensor containing six ultrasound images per infant—two images each from the abdomen, biceps, and quadriceps. This configuration balanced complexity and computational efficiency. The encoder pathway progressively downsampled the input, reducing the spatial dimensions (from 256×256 to 16×16), while increasing the number of channels (from 64 to 512) to enhance feature capture. The decoder pathway then upsampled the feature maps, restoring the spatial dimensions to 256×256, while decreasing the number of channels back to 64. To mitigate overfitting, dropout layers with a rate of 0.1 were incorporated throughout the network. The final feature map was flattened to (1, 256×256) and passed through linear layers to aggregate information across anatomical regions to generate predictions of FM and FFM. A sigmoid activation function was applied to the final output to normalize predictions and improve training stability.

Model training: A 5-fold cross-validation approach was used to improve training robustness and reduce overfitting, particularly given the limited dataset. Ten percent of the dataset was held out as an independent test set (FIG. 5), while the remaining data were used to train and validate the model. In each fold, 72% of the dataset was used for training and 18% used for validation. Model training, hyperparameter tuning using the validation set, and performance evaluation on the test set were performed iteratively to optimize model performance. The model was trained using stochastic gradient descent with a momentum of 0.9, a mini-batch batch size of 32, and a fixed learning rate schedule of 0.001. The Adam optimization algorithm was employed to fine-tune the model. A regression sequence duration of 1.0 seconds was selected to balance temporal information and computational efficiency. The loss function integrated mean square error (MSE) and L1 loss to improve accuracy and robustness, while penalizing negative predictions. The number of U-Net layers was optimized based on runtime and performance, and further tuning was not pursued, as deeper architectures yielded minimal gains and longer training times.

Model evaluation: The model's performance was evaluated using a validation dataset and quantified with standard regression metrics, including root mean square error (RMSE), mean absolute percentage error (MAPE), mean absolute error (MAE), and MSE.

Model implementation: The deep learning models were implemented using Python 3.9 and the PyTorch framework. The computational environment consisted of a Dell G15 Gaming Laptop with a NVIDIA® GeForce RTX™ 3060 GPU and a 11th Generation Intel® Core™ i7-11800H processor. Additionally, a T4 GPU hosted on Google Colab was utilized to accelerate the training process.

Model computation: During model computation, the training and testing loss curves exhibited an expected decline in the initial stages, followed by a gradual decrease and stabilization with minimal variation after 90 epochs. The total duration of the model computation was approximately 20 minutes, depending on the specific computational configuration.

Model validation: Model performance was evaluated using: (a) Bland-Altman plots to assess agreement between predicted and actual values, highlighting any systematic bias or outliers; (b) model errors to quantify the difference between predicted and actual values, providing a gauge for prediction accuracy; and (c) scatterplots for visual inspection of model predictions.

Comparison to classical feature-based regression methods: To compare performance with traditional approaches, classical feature extraction methods including Histogram of Oriented Gradients (HOG) and Scale-Invariant Feature Transform (SIFT) were applied to ultrasound images. Features were encoded using a Bag of Visual Words (BoVW) model and subsequently used as input to a Random Forest regression model for predicting FM and FFM.

Evaluation of anatomical region contributions to prediction: To assess the contribution of each anatomical region to body composition prediction, we tested image combinations derived from the biceps (B), abdomen (A), and quadriceps (Q). Initially, we trained the model with ultrasound images from all three anatomical regions (BAQ) to establish baseline performance. Subsequently, we iteratively excluded one region at a time to quantitatively evaluate how its omission affected the model's predictive accuracy for FM and FFM, using MAPE as the evaluation metric. This analysis helped identify which regions contributed most to body composition prediction, providing insights into which regions should be prioritized for scanning in future imaging protocols.

Visual identification of image region contributions to prediction: Model interpretability and transparency are essential in healthcare applications. To elucidate how the model makes predictions, we employed feature importance analysis and visualization techniques, including Grad-CAM, to identify regions within the images that contributed to the model's prediction. Grad-CAM computes the gradient of the trained model with respect to the input data and processes it into heatmaps that highlight the areas most significant to the final prediction. When applied to the three anatomic sites (abdomen, biceps, and quadriceps) at the final layer of the U-Net architecture, Grad-CAM identifies key regions in the ultrasound images that influence FM and FFM prediction, with warmer colored (red) regions indicating greater importance.

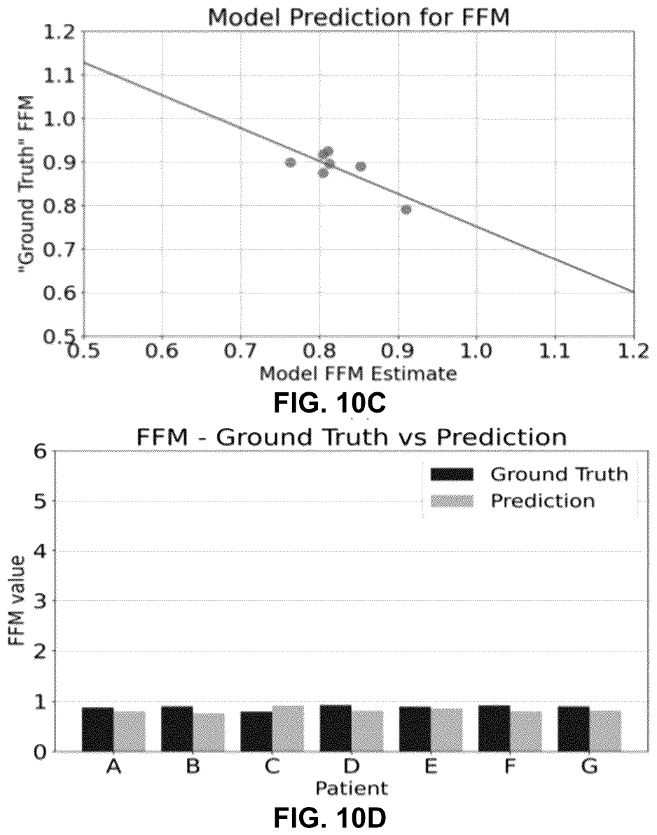

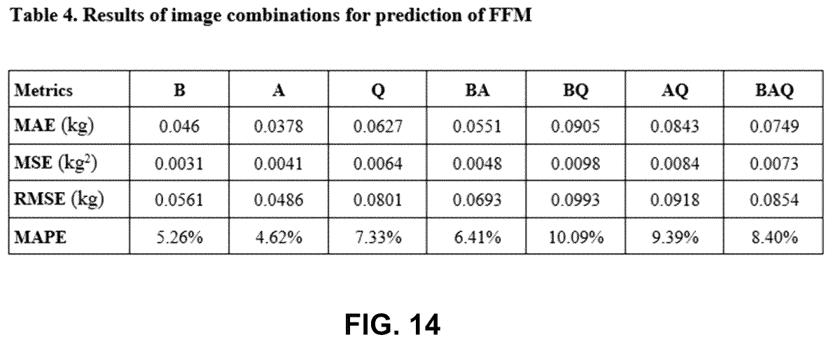

Results: Body composition prediction; FIGS. 9A-9D present comparisons between the predicted and actual values of FM. The Bland-Altman plot in FIG. 9A illustrates strong consistency between the measured values and the model predictions for FM, with minimal mean bias of −0.0052 kg and limits of agreement ranging from −0.0516 to 0.0412 kg. The deep learning model yielded the following prediction results: MAE=0.0145 kg, MSE=0.0003 kg², RMSE=0.0183 kg, and MAPE=2.65%, as shown in Table 3 (FIG. 13) and FIG. 9B and FIG. 9C. Overall, there is good agreement between ground truth and predictions.

FIG. 9A (Bland-Altman for FM): In an example, this panel plots the difference between predicted and reference fat mass (FM) against their mean for each newborn. A solid horizontal line shows mean bias; dashed lines denote the 95% limits of agreement. Shaded bands indicate clinically acceptable error. A fitted trend (e.g., LOWESS) screens for proportional bias. Points may be colored by anatomical-site combination or image-quality tier, highlighting contexts where error widens and suggesting acquisition or model refinements.

FIG. 9B (Model error for FM): In some embodiments, this figure summarizes FM prediction error distributions. Panels (e.g., box/violin plots or histograms) display absolute or percentage error across folds, site combinations, and quality strata. Medians, interquartile ranges, and whiskers reveal dispersion; tail counts flag rare large errors. Horizontal reference lines mark target error thresholds. An inset table reports cohort-level metrics (MAPE, MAE) to complement the graphical view and guide operational thresholds for QC or reacquisition.

FIG. 9C (Model prediction for FM): According to some aspects, this panel visualizes predicted FM outputs across representative cases or experimental settings. For example, grouped bars (or lines) show mean predicted FM with confidence intervals for different anatomical-region subsets, while overlay markers indicate corresponding reference values. Alternatively, a heat map can summarize cross-validation means by site combination. The goal is to expose how predicted FM varies with input configuration and to illustrate stability of predictions across folds and device/setting variations.

FIG. 9D (FM ground truth vs. prediction): According to some aspects, a scatter plot here compares predicted FM against ground-truth FM. The 45° identity line and a fitted regression line (with confidence band) display calibration. Reported statistics include R², slope, intercept, and mean absolute (percentage) error. Color encodes region subset or quality tier; labeled outliers support audit and targeted improvements.

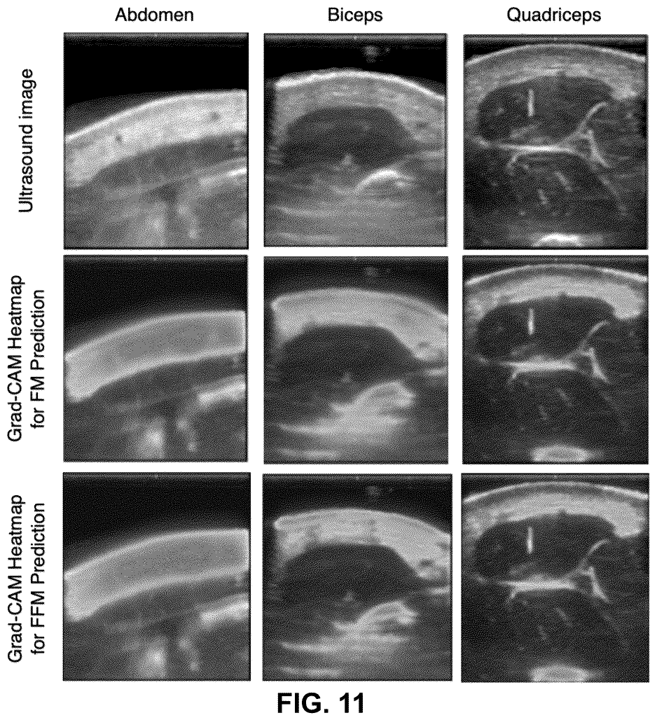

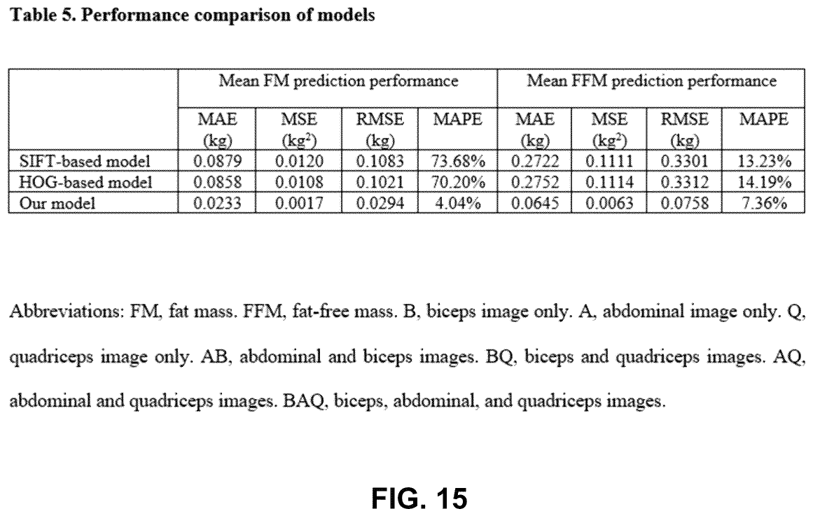

FIGS. 10A-10D present a systematic comparison between predicted and actual values for FFM. The Bland-Altman plot in FIG. 10A shows strong consistency between the measured values and model predictions, with a low mean bias of −0.0613 kg. However, the limits of agreement were wider than those for FM, ranging from −0.2172 to 0.0947 kg. The FFM prediction showed MAPE of 8.40%, while the MAE (0.0749 kg), MSE (0.0073 kg²), and RMSE (0.0854 kg) were larger compared to the FM prediction, as shown in Table 4 (FIG. 14) and FIG. 10B and FIG. 10C. Despite this, the ground truth and predictions demonstrate acceptable differences.

FIG. 10A (Bland-Altman for FFM): In an example, this panel plots the difference between predicted and reference fat-free mass (FFM) against their mean for each newborn. The central horizontal line indicates mean bias; dashed lines mark the 95% limits of agreement. Shaded bands denote clinically acceptable error. A trend line (e.g., LOWESS) checks for proportional bias across the measurement range. Points may be color-coded by anatomical-site combination or image-quality tier, revealing conditions that widen variance and guiding acquisition or model refinements.

FIG. 10B (Model error for FFM): In some embodiments, this figure summarizes FFM error distributions across cross-validation folds, region subsets (single-site vs. multi-site), and quality strata. Box/violin plots display absolute or percentage error, with medians, interquartile ranges, and whiskers highlighting dispersion; tail counts flag rare large errors. Horizontal reference lines show operational targets (e.g., MAPE thresholds). An inset table reports cohort-level metrics (MAE, MAPE, RMSE), enabling quick comparison across configurations and informing thresholds for automated QC or reacquisition prompts.

FIG. 10C (Model prediction for FFM): According to some aspects, this panel visualizes predicted FFM across representative configurations. Grouped bars (or lines) display mean predicted FFM with confidence intervals for different anatomical-region inputs, with overlay markers for corresponding reference values. Alternatively, a heat map aggregates cross-validation means by site combination. The visualization emphasizes stability of predictions across folds and devices, and illustrates the gain from multi-region fusion relative to single-site inputs, supporting selection of acquisition protocols that balance accuracy and scan time.

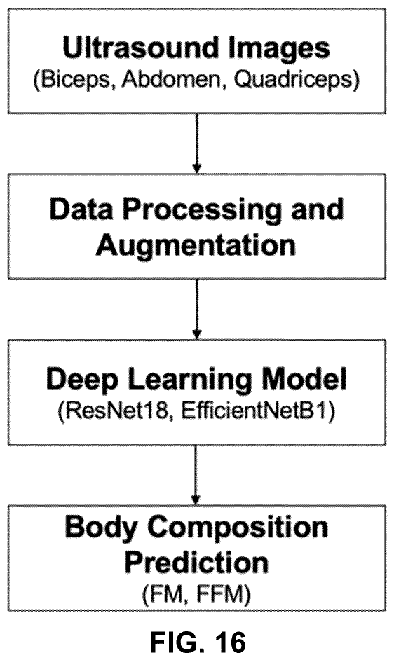

FIG. 10D (FFM ground truth vs. prediction): In some aspects, a scatter plot compares predicted FFM to ground-truth FFM. The 45° identity line and a fitted regression line (with confidence band) display calibration. Reported statistics include R², slope, intercept, and mean absolute (percentage) error. Color encodes region subset or image-quality tier, and annotated outliers highlight edge cases for audit (e.g., atypical habitus or motion artifacts). The plot provides an intuitive readout of model accuracy and any systematic deviation across the FFM range. As shown in Table 5 (FIG. 15), our model outperformed traditional feature-based regression approaches, which used HOG and SIFT features with Random Forest regression.

Anatomical region contributions to prediction: FIG. 13 (Table 3) and Table 4 (FIG. 14) provide the performance of predicted FM and FFM for each body region. For FM prediction, the combination of images from all three anatomical regions (BAQ) resulted in the lowest MAPE (2.65%), MSE (0.0003 kg²), RMSE (0.0183 kg) and MAE (0.0145 kg). For FFM prediction, we found the lowest MAPE (4.62%), MSE (0.0041 kg²), RMSE (0.0486 kg) and MAE (0.0378 kg) when using only abdomen images as input (A) to the model. These findings suggest that abdomen images alone provide a strong contribution to accurate body composition prediction, particularly for FFM.

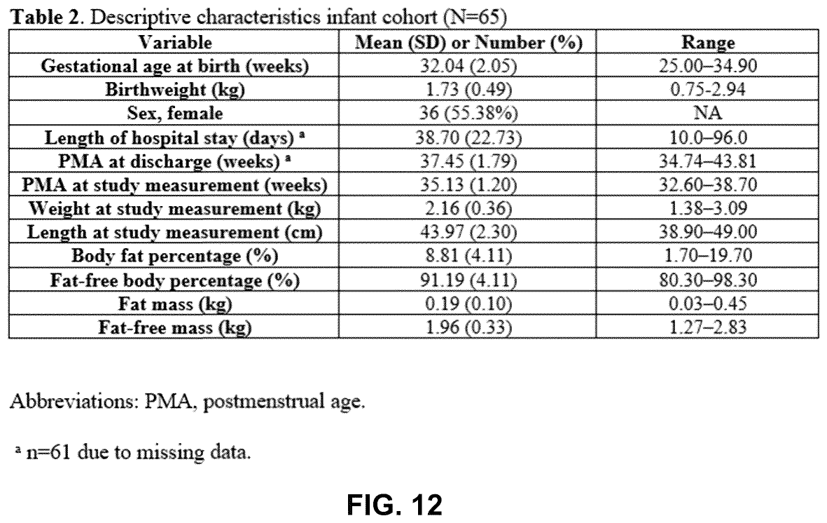

Image regions that contribute to predictions: FIG. 11 presents visualization results from a representative infant, identifying key regions within the ultrasound images of the abdomen, biceps, and quadriceps that contribute to model predictions, as identified by Grad-CAM. Warmer colors (reds) indicate regions of higher importance in the model's prediction, while cooler colors (blues) indicate lower importance. Separate heatmaps were generated for FM and FFM predictions at each anatomic site (FIG. 11). Both FM and FFM predictions emphasized similar areas, highlighting fat regions in blue and nonfat regions in red. This suggests that the model primarily utilizes areas with more muscle tissue for prediction, while subcutaneous fat and bone regions (femur and humerus) contribute less. Notably, the abdomen shows the greatest distinction between fat and muscle in its heatmap, indicating that subcutaneous abdominal fat plays a minimal role in predictions. In contrast, fat overlying the biceps and quadriceps contributed more significantly, although muscle tissue still took precedence in the overall predictions.

Discussion: Accurately predicting body composition from ultrasound images is a complex task influenced by several factors, including the quality and quantity of imaging data, image preprocessing, and the selection of modeling techniques. Clinically, bedside estimation of body composition could improve neonatal care by enabling more frequent, non-invasive monitoring of growth and nutrition in premature infants. Ultrasound is portable and repeatable, making it a useful complement to existing methods such as ADP and extending assessments to community clinics and resource-limited settings. This complexity makes it well suited to a deep learning approach, which can quickly perform sophisticated analyses and fully leverage rich imaging data. In practice, manual analysis by human operators often requires a priori selection of regions in the image, along with simplified measures, such as single plane tissue thickness. In contrast, deep learning can independently identify important imaging regions for prediction and effectively utilize all available data within a region.

In this study, we validated the feasibility of applying deep learning techniques to B-mode ultrasound images for predicting body composition in premature infants. Our preliminary results demonstrate that combining ultrasound imaging with deep learning shows promise as a non-invasive method for predicting body composition. The model demonstrated a low mean bias of −0.0052 kg for FM and −0.0613 for FFM, indicating good agreement with ground truth measures. The primary innovation lies in the first demonstration of ultrasound-based automatic prediction of FM and FFM in preterm infants by using deep learning. We also incorporated multiple anatomical regions, evaluated their individual and combined predictive value, and used Grad-CAM to support interpretability—distinguishing this work from previous approaches.

While gold standard methods achieve a low error of 3-5%, our model demonstrated MAPE results ranging from 2.65-10.09%, as shown in Table 3 (FIG. 13) and Table 4 (FIG. 14). Deep learning-based models are heavily dependent on the dataset used for training. This initial analysis was based on a limited sample size, suggesting that larger and more diverse datasets may improve performance. Many body composition prediction methods, such as ADP, incorporate clinical data such as infant sex, weight, length, and age. Our model, however, demonstrated reasonable agreement using imaging data alone, which is advantageous since certain clinical data such as infant length can be challenging to measure accurately. Compared with traditional models, our model offers stronger overall predictive value and promising applicability.

Analysis of the contributions of different anatomical regions to body composition prediction revealed that abdomen images were particularly useful for accurate prediction. Using only abdomen images for FFM prediction resulted in the lowest error values. For FM, the abdomen image alone had only marginally higher error than using images from all three anatomical regions. Though preliminary, this finding is important for optimizing ultrasound scanning protocols for body composition assessments. Given that abdomen-only images performed well for FFM prediction, it may be worth exploring in future studies whether scanning just the abdomen is sufficient for accurate body composition prediction as compared to scanning all three anatomical regions. Streamlining the scanning protocol to focus on fewer regions could reduce scanning time, lower costs, and simplify the process for clinicians, enhancing the feasibility of this approach in diverse clinical settings. These results provide valuable insights to guide the development of future studies and clinical applications.

The Grad-CAM visualization results indicate that muscle regions play a significant role in predicting body composition in preterm infants. FFM heatmaps aligned with clinical expectations, demonstrating that non-fat, predominantly muscle tissue, is most important for predicting FFM. In contrast, FM heatmaps were more complex; the model does not focus primarily on subcutaneous fat for its prediction, but emphasizes surrounding tissue regions. This suggests that the prediction of FM may involve other fat deposits, such as visceral fat near the organs, which might not be easily detected by surface ultrasound images. This is consistent with existing literature, which shows that preterm infants have greater visceral fat depots at term-corrected age compared to full-term infants. Furthermore, the limited subcutaneous fat in preterm infants could explain why subcutaneous fat did not emerge as the primary determinant for FM prediction. Additionally, we found that subcutaneous fat over the biceps and quadriceps is a stronger predictor of total body composition than abdominal subcutaneous fat, as indicated by the warmer colors in these regions. This suggests that the model's emphasis on these areas reflects their greater predictive value, rather than a limitation in ultrasound's ability to differentiate between tissue layers. These results highlight the importance of considering anatomical context when interpreting ultrasound images for body composition analysis.

This study provides a foundation for future multi-center, longitudinal studies to improve generalizability with more diverse datasets. To address the limited diversity of infants in the present cohort, we have initiated data collection at additional sites, including high- and low-resource settings. Nevertheless, the proposed deep learning pipeline shows strong potential for assessing infant nutrition with portable imaging systems outside traditional settings. Compared to manual methods, it offers a more objective, efficient, and less operator-dependent approach. Ultrasound can also be applied in critically ill infants or those on respiratory support who cannot undergo ADP. With mobile integration, this tool could be deployed in underserved settings for immediate feedback and point-of-care monitoring. A next step toward clinical translation will be incorporating poor-quality images into training, enabling the model to automatically identify and exclude them and reduce the need for manual quality control.

Examplery conclusion: This study introduces an ultrasound-based deep learning approach for automated body composition prediction, showing good agreement with reference measures. With further refinement, this approach may provide a cost-effective tool for assessing infant growth and nutrition across diverse care settings.

### Developing a Deep Learning Approach for Automated Body Composition Prediction in Newborns Using Ultrasound Images

In some embodiments, the combined objective disclosed in this section is: Measurements of human body composition such as fat mass (FM) and fat-free mass (FFM) are critical for studying malnutrition and the effects of nutritional interventions. This study introduces research toward a novel ultrasound scanning protocol combined with a deep learning analysis pipeline for predicting body composition. Methods: We analyzed a clinical dataset of 65 premature infants, consisting of ultrasound images from three anatomical locations (biceps, abdomen, and quadriceps), and ground truth FM and FFM from air displacement plethysmography (ADP). Our investigation focused on determining: (1) the optimal data processing methods for this application; (2) suitable baseline deep learning models for prediction to guide our learning strategy; and (3) the anatomical locations and image regions most predictive of FM and FFM. Results: We demonstrate that: (1) pre-processing techniques such as denoising, median filtering, and data augmentation enhance performance; (2) by employing a modified EfficientNet-B1 architecture, we achieve fully automatic body composition predictions from ultrasound images; (3) images obtained from combinations of biceps and quadriceps, as well as biceps, quadriceps, and abdomen scanning locations, resulted in mean absolute percent error (MAPE) values of 26.1% and 25.32%, respectively. Finally, sensitivity analysis shows that FM and FFM prediction are influenced by different body parts, as well as adipose and muscle tissue thickness. Conclusion: This study represents the first demonstration of deep learning for automated human body composition prediction from ultrasound images and lays a critical foundation for a novel ultrasound scanning and interpretation protocol to assess malnutrition.

Human body composition measures, such as fat mass (FM) and fat-free mass (FFM) play a critical role in studying malnutrition and assessing changes due to nutritional, therapeutic or behavioral interventions. Nutritional assessment in infancy is crucial, as this is a critical period for growth and development during which disruptions can lead to lifelong consequences. However, body composition measurement techniques such as dual-energy X-ray absorptiometry (DXA), computed tomography (CT), and air displacement plethysmography (ADP) require specialized staff and equipment, which are costly and not widely available.

Ultrasound imaging presents a promising alternative capable of distinguishing between adipose tissue and skeletal muscle. Its accessibility has recently increased due to the rise in availability of low-cost portable ultrasound systems. However, fully automated body composition prediction from ultrasound images has yet to be developed.

Deep learning is a promising tool for automating clinical diagnosis for various disorders and has been widely used for segmentation, classification, and detection in medical image analysis. Currently, most research on deep learning-based human body composition prediction is based on CT data in adult subjects. For instance, Weston, et al. proposed a fully automated convolutional neural network (CNN) model based on U-Net for segmenting the abdomen from CT images to quantify body composition, achieving dice scores exceeding 0.9. Koitka, et al., developed a 3D semantic segmentation CNN, with an average dice score of 0.9553 and the intra-class correlation coefficients for subclassified tissues above 0.99. Xu, et al., developed a fully automatic pipeline to derive body composition measurements from routine lung screening chest low-dose CT. Despite these advances, CT is not an ideal option for routine body composition measurement, particularly in subjects, due to its relatively high cost and exposure to ionizing radiation. In contrast, ultrasound presents a promising alternative for this application, given its inherent low-cost, portability and lack of ionization radiation. Recently, Nagel, et al., demonstrated encouraging results when studying body composition of premature infants and/or of subjects using manual tissue thickness measurements obtained from ultrasound.

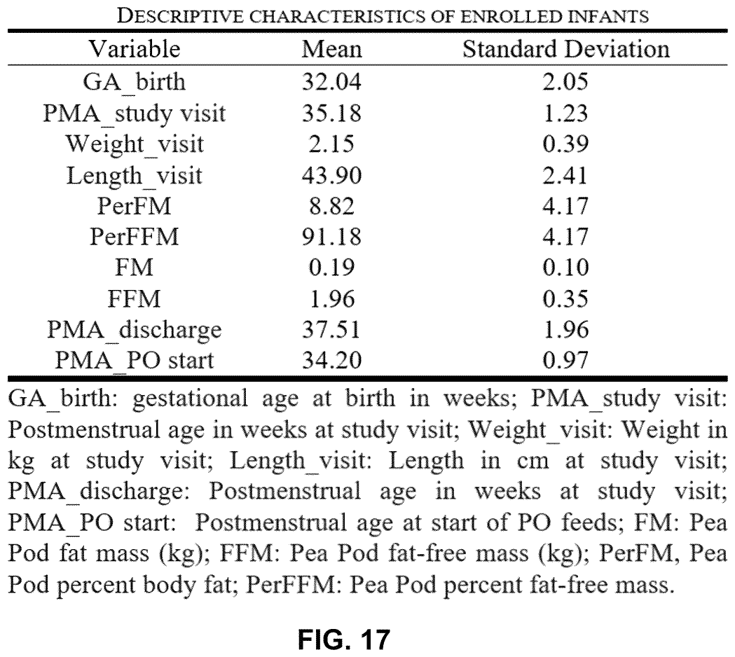

FIG. 16 shows a flowchart of deep learning approach to predicting body composition from ultrasound images. Our ultimate vision is to apply deep learning interpretation techniques to ultrasound images and develop predictive algorithms for important nutritional and growth metrics (FIG. 16). Toward this goal, we present research related to the development of a novel ultrasound scanning protocol and analysis pipeline, which will ultimately be deployed for computer-assisted intervention (CAI), in which nutritional interventions may be informed by computer-based tools and methods. Our work is driven by the following research questions: (1) Data pre-processing: what data processing is most suitable for this application? (2) Data analysis: which baseline deep learning models provide predictions to inform our learning strategy? (3) Data acquisition: which anatomical locations and image regions are most predictive of FM and FFM? Following this, we conducted sensitivity analysis to quantitatively evaluate how the prediction performance of FM and FFM can be influenced by different human body parts as well as muscle and adipose thickness. To address these questions, we analyzed data collected as part of a previous study on premature infants conducted at the University of Minnesota Medical Center. The dataset comprises of ultrasound images collected from three anatomical locations (leg, arm, and abdomen), ground truth FM and FFM from air displacement plethysmography (ADP), and clinical data extracted from patient records.

In some embodiments, FIG. 16 summarizes the study cohort and data characteristics. Panel A shows cohort demographics (sex, gestational age, birthweight) as histograms or violin/box plots with medians and interquartile ranges. Panel B depicts scan timing relative to birth and the distribution of anatomical sites per newborn (biceps, abdomen, quadriceps), including frame counts per site. Panel C presents reference body-composition values (fat mass and fat-free mass) with density overlays to illustrate range and central tendency. Panel D outlines data partitions (training/validation/test) and per-subset counts. An inset “missingness” grid flags excluded or incomplete entries (e.g., absent site, low image quality), ensuring transparency around sample size, coverage, and balance across inputs.

The contributions of this paper are summarized as follows: (1) We identified the most suitable data preprocessing techniques, including median filtering, denoising, and image augmentation, which can enhance prediction performance; (2) We demonstrate, for the first time, end-to-end automatic estimation of human body composition, finding that EfficientNet-B1, when fine-tuned and trained with the mean absolute error (MAE) loss function, provided the best baseline among the models evaluated; (3) We found that combinations of biceps and quadriceps images, as well as combinations of biceps, abdomen, and quadriceps, yielded the lowest mean absolute percentage error (MAPE) in predictions. Finally, sensitivity analysis revealed that different body parts affect the prediction performance of FM and FFM which is also influenced by different muscle and adipose thicknesses. To the author's knowledge, this study represents the first demonstration of utilizing deep learning techniques for automated human body composition prediction from ultrasound images. Therefore, our results provide important guidelines for optimizing a novel ultrasound scanning and analysis pipeline to assess malnutrition.

Materials and methods; experimental data description; all data were collected as part of a previous study conducted at the University of Minnesota Medical Center. A total of 65 premature infants were recruited following an IRB-approved protocol, with informed consent obtained from their parents. The infants were born between 25 and 34 (+6) weeks' gestational age, were medically stable at time of measurement, and had not undergone major pre-processing steps of ultrasound images. FIG. 6B shows an example flowchart showing pre-processing steps of ultrasound images, surgeries or received significant medical diagnoses. Following clinical data collection, all data were de-identified, thus eliminating the need for additional IRB approval for analysis.

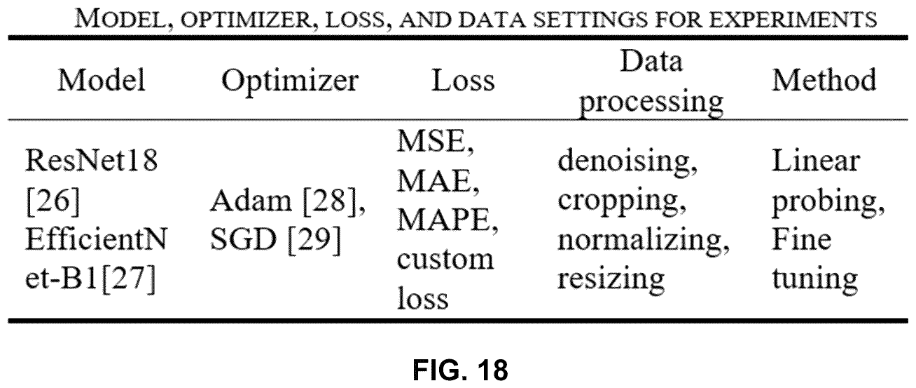

The dataset comprises ultrasound images, gold standard body composition, and clinical measures. Ultrasound images of infant biceps (brachii and brachialis), abdomen (rectus abdominis), and quadriceps (rectus femoris and vastus intermedius) were collected using a B-mode ultrasound imaging system (NextGen LOGIQ e R7, GE Medical Systems, Chicago, IL). These anatomical locations were chosen since they are representative of muscle and adipose tissue distribution at different regions of the body and are easily accessible for scanning. Ultrasound measurements of adipose and muscle thickness were conducted by a clinician using the system's built-in measurement tools. Gold standard body composition values, including FM and FFM, were generated via ADP using a PeaPod system (Cosmed, Ltd, Concord, CA). Ultimately, we curated a representative dataset including 414 ultrasound images of arm, leg, and abdomen with triplicate measurements from 46 infants. This secondary analysis excluded 19 subjects that lacked complete ultrasound image or clinical data. The clinical data included measurements such as body composition, body weight, height, age, and gender, as detailed in the table in FIG. 17, wherein it shows descriptive characteristics of enrolled infants

GA_birth: gestational age at birth in weeks; PMA_study visit: Postmenstrual age in weeks at study visit; Weight_visit: Weight in kg at study visit; Length_visit: Length in cm at study visit; PMA_discharge: Postmenstrual age in weeks at study visit; PMA_PO start: Postmenstrual age at start of PO feeds; FM: PeaPod fat mass (kg); FFM: PeaPod fat-free mass (kg); PerFM, PeaPod percent body fat; PerFFM: PeaPod percent fat-free mass.

Data Pre-Processing: The ultrasound image data underwent a series of pre-processing steps to prepare it for analysis. First, the data was converted from DICOM to .jpg format. The original images were then cropped to remove the background. Subsequently, a series of image preprocessing approaches were applied as follows: (1) raw cropped ultrasound images were resized to 256×256; (2) resized ultrasound images were denoised using a median filter of size 5 to enhance ultrasound image quality; (3) ultrasound images were normalized with a mean and standard deviation of 0.5; and (4) the dataset was augmented from 414 images (9 images for each of the 46 infants) by a factor of five using vertical flipping, horizontal flipping, and random rotation to improve the scale and diversity of the ultrasound image dataset in order to mitigate the risk of model overfitting. FIG. 6B depicts all steps associated with the overall ultrasound images preprocessing. In some embodiments, FIG. 6B details the intensity and geometry harmonization applied before learning. Incoming frames pass scale normalization using DICOM metadata or on-image scale bars to standardize pixel spacing. Brightness/contrast are adjusted to a reference histogram; speckle reduction (e.g., median or anisotropic filtering) improves boundary conspicuity without blurring fascia. Frames failing a quality gate (motion, shadowing, inadequate coverage) are rejected or flagged for reacquisition. Optional augmentation (small rotations, shifts, gain jitter) is shown for training only. The output is a standardized tensor with consistent dynamic range and resolution, ready for segmentation and feature extraction.

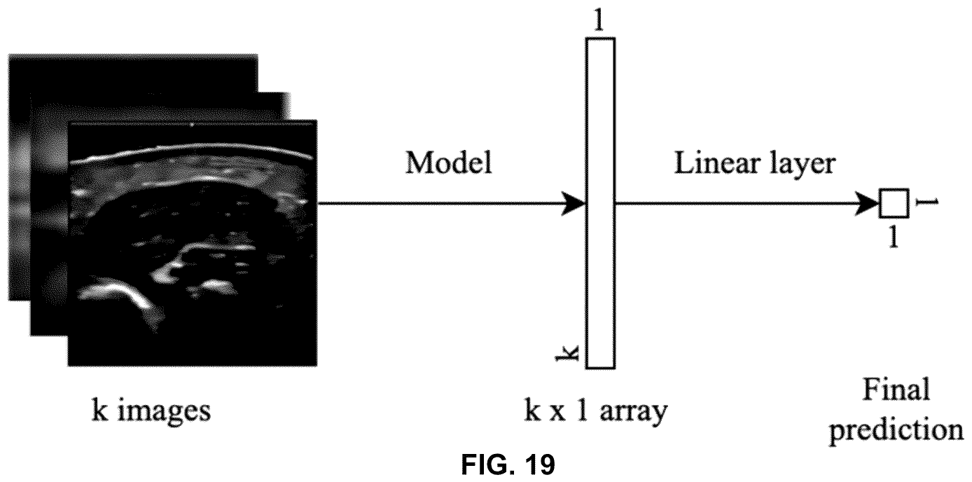

Data Analysis: Model Design Choices For Deep Learning Pipelines: Preprocessed ultrasound images, along with FM and FFM derived from gold standard ADP, were utilized for model training and evaluation. The trained model was designed to automatically generate end-to-end predictions of FM and FFM. The experimentation involved two models, two optimizers, four loss functions, four data processing, and two methods, as summarized in the Table of FIG. 18. FIG. 18 shows an example model, optimizer, loss, and data settings for experiments.

For the initial analysis, ResNet18 and EfficientNet-B1 models were selected due to their well-established balance of computational efficiency, prediction accuracy, and training stability, which are key considerations for regression tasks, such a body composition prediction. While other architectures, such as U-Net, excel in image segmentation and spatial feature localization, our study focuses on direct regression from images, making EfficientNet-B1 and ResNet18 are more suitable for our task (i.e., B-mode ultrasound image-to-FM/FFM value regression). To evaluate model performance across varying data conditions, we constructed 21 subsets from our data sets using 7 different combinations of data, and 3 different numbers of images from each muscle. For instance, one subset consisted of both biceps and quadriceps with 2 images withdrawn from each muscle.

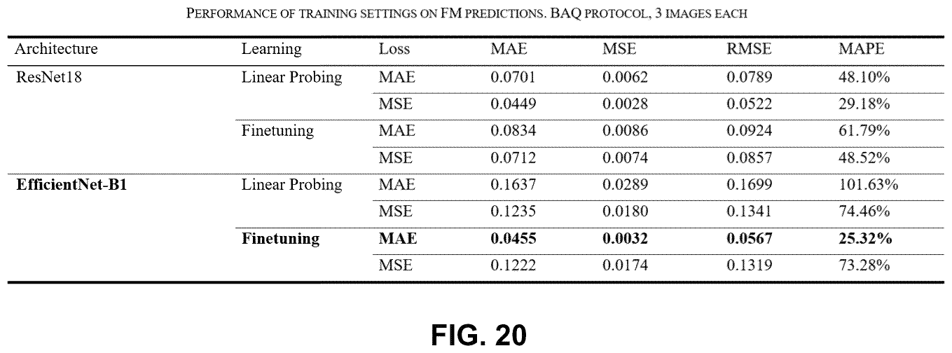

For the ResNet18 and EfficientNet-B1 regression models, each ultrasound image was processed to extract model features, which were then aggregated through averaging. These aggregated features were subsequently passed to a linear layer for regression. The overall deep learning model design is shown in FIG. 19. FIG. 19 shows an example deep learning model design for human body composition prediction.

It is shown that the first linear layer was applied on an individual image basis, concatenating the 256×256 matrix of features to a single float. After obtaining a value for n image, we performed a late fusion technique in which we concatenated n numbers in each batch into a single float, which predicted either FM or FFM.

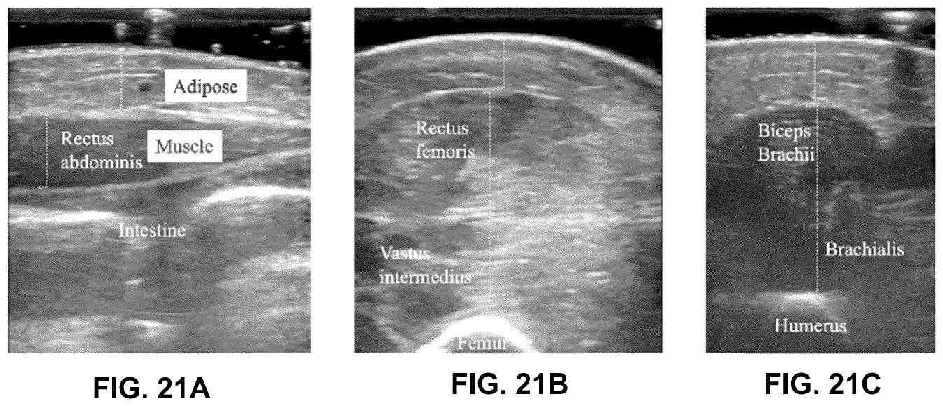

FIG. 20 (Table): Performance of training settings on FM predictions. BAQ protocol, 3 images each. 1) Model Training: Our dataset was split into training, validation, and testing sets in a 70-20-10 ratio, resulting in 32 infants for training, 9 for validation, and 5 for testing. Each patient had 3 abdomen images, 3 biceps images, and 3 quadriceps images, along with 36 augmented images, leading to a batch size of 45 images. Various combinations and numbers of images from each muscle were tested, and hyperparameters were adjusted to optimize model performance. Training and hyperparameter tuning were iterated to enhance performance. The study focused on human body composition labels, including fat mass (FM) and fat-free mass (FFM). Different loss functions were employed, such as MAPE, mean square error (MSE), mean absolute error (MAE), and custom loss function composed of 60% MSE and 40% MAE. Both the Adam optimizer algorithm and the Stochastic Gradient Descent (SGD)were used for model training. In this example, a mini-batch size of 1 and a fixed learning rate schedule of 0.001 were employed, with 40 epochs identified to be the most effective. Minimal performance improvement was observed beyond 40 epochs of training. To prevent the overfitting of the deep learning model, the following techniques were employed: 1) multiple dropout layers with a rate of 0.1; 2) leaky ReLU with a 0.1 negative slope applied twice in each convolution block; and 3) L2 regularization.

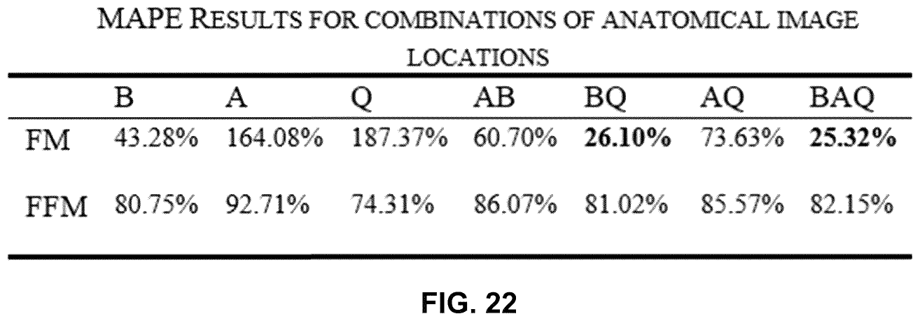

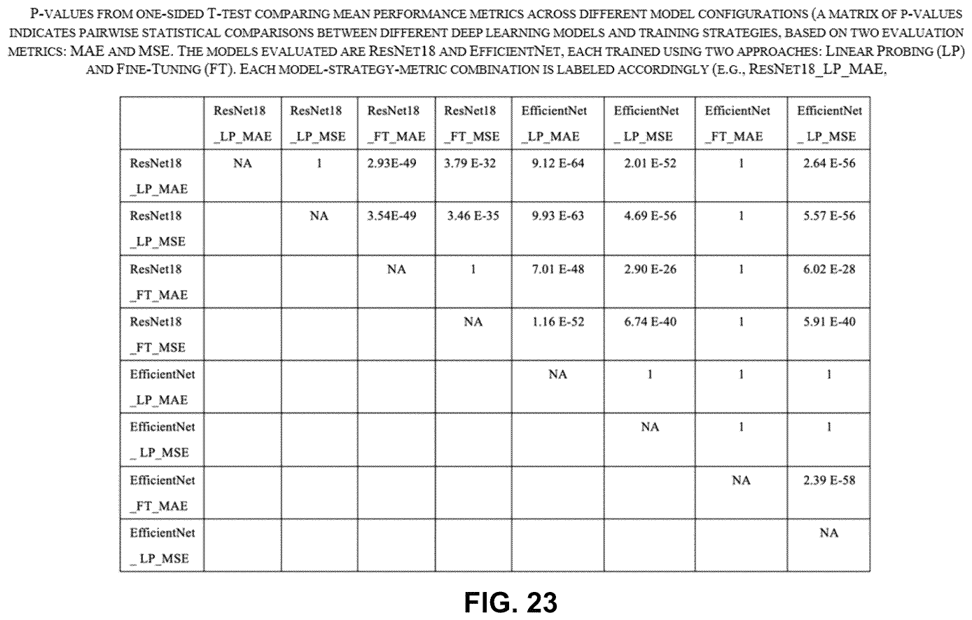

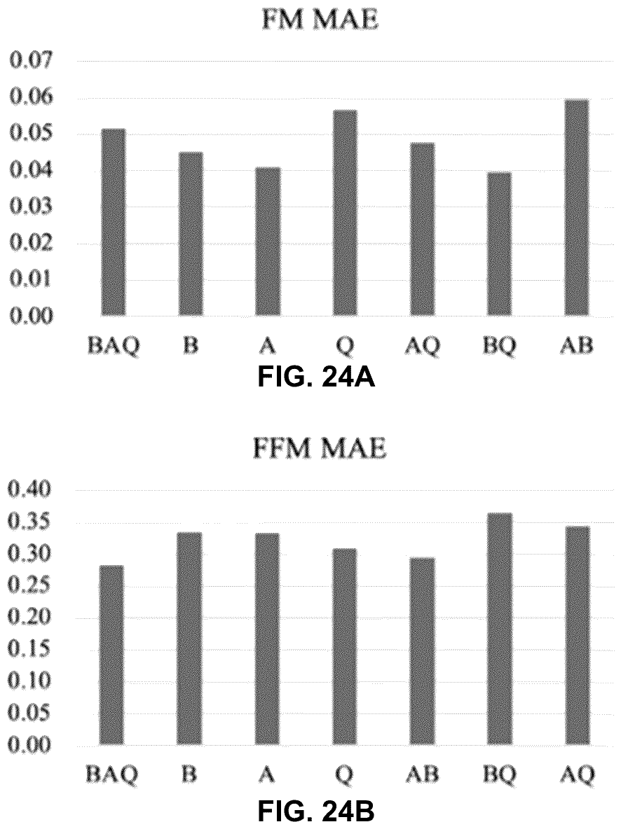

FIG. 21A, FIG. 21B, and FIG. 21C: Clinical ultrasound image measurement of abdomen, biceps, and quadriceps of the premature infant. Left: abdomen, Middle: biceps, and Right: quadriceps.

FIG. 21A (Comparative results—Training Regime A): In an example, this panel summarizes baseline training with standard preprocessing, moderate augmentation, and fixed learning-rate scheduling. Bars (or points) report mean absolute percentage error and RMSE for fat mass (FM) and fat-free mass (FFM) across single-site and multi-site inputs (biceps, abdomen, quadriceps, and fusions). Error bars show cross-validation variability; dashed lines mark prespecified clinical-acceptability thresholds. An inset calibration plot (predicted vs. reference) and a small table of bias/limits-of-agreement provide context. Regime A establishes the reference performance and highlights the gain from multi-region fusion compared with any single site.

FIG. 21B (Comparative results—Training Regime B): In some embodiments, this panel evaluates a variant emphasizing stronger harmonization and augmentation (e.g., wider intensity jitter, rotation/translation) with early stopping and cosine learning-rate decay. The same metrics and axes enable head-to-head comparison with FIG. 21A. FM and FFM errors typically contract for image-quality-limited subsets, with improved calibration slopes near unity. A box/violin overlay illustrates narrower dispersion, while symbol encodings flag anatomical-region combinations. A small ablation table contrasts Regime B vs. A on bias and limits-of-agreement, revealing robustness gains in noisier frames without sacrificing accuracy on clean acquisitions.

FIG. 21C (Comparative results—Training Regime C): According to some aspects, this panel presents a multi-task/ensemble configuration that jointly predicts FM and FFM and averages outputs across complementary backbones. Using identical axes to FIGS. 21A-21B, Regime C demonstrates further error reductions, particularly for multi-site inputs, and the tightest calibration among the three regimes. Confidence-interval whiskers shrink across folds; a star or highlight marks the configuration selected for deployment. An inset bar shows computational footprint (inference time/memory) to contextualize the accuracy gain. Overall, Regime C offers the best trade-off between performance and stability across device settings and acquisition conditions. In this study, we systematically evaluated the prediction performance with the following combinations of ultrasound images: biceps only (B), quadriceps only (Q), abdomen only (A), biceps+quadriceps (BQ), abdomen+biceps (AB), abdomen+quadriceps (AQ), and biceps+quadriceps+abdomen (BQA).

Qualitative Analysis Of Model Errors: To visualize the decision-making process of the EfficientNet-B1 model with fine-tuning, we applied Gradient-weighted Class Activation Mapping (Grad-CAM)to generate heatmaps that highlight spatial regions within the input images that contribute most significantly to the model's predictions. The Grad-CAM computes the gradients of the output with respect to the feature maps of a specified convolutional layer, producing a localization map that reflects the relative importance of different regions. In this study, Grad-CAM heatmaps were generated for all three anatomical regions using activations from the final convolutional layer of the EfficientNet-B1 architecture.

Statistical Analysis: Gaussian process (GP)was applied to predict PerFM and PerFFM for all six body parts. The data was split into 80% train, 10% test, and 10% validation. Since there were no clear outliers in the 12 plots of BM vs PerFM, BM vs PerFFM, BA vs PerFM, etc, root-mean-square error (RMSE) and mean squared error (MSE) were used rather than (mean absolute error) MAE.

Results: Data Pre-processing; To determine a suitable data preprocessing pipeline for the deep learning model, a series of ultrasound data preprocessing steps were conducted as follows:
1) Denoising: Among various denoising methods, such as stochastic denoising, we found that median filter was most effective for our dataset. We experimented with different pixel sizes for the median filter and determined that a pixel size of 5 produced the best results. Larger or smaller sizes either did not improve performance significantly or resulted in performance degradation.
2) Augmentation: We compared various approaches to image augmentation. Augmenting each image within the dataset (without adding new ground truth data) proved more effective than augmenting the entire dataset by adding new sets of augmented data with corresponding ground truth. Specifically, augmenting each image five times provides the best balance between computational efficiency and performance improvement.
3) Resizing: We tested multiple resizing configurations, including 512×512, 256×256, 128×128, and 64×64, to identify the most suitable balance between computational efficiency and model performance. Our experiments indicated that resizing images to 256×256 pixels provided the optimal trade-off. This resolution allowed us to maintain high prediction performance while reducing computational demands compared to higher resolutions. Although resizing to 512×512 resulted in marginal improvements in performance, it introduced a substantial computational burden, making it less practical for efficient model training. On the other hand, 128×128 and 64×64 led to a noticeable decline in performance. Consequently, we found 256×256 to be the most effective choice, offering a good balance between computational efficiency and predictive accuracy, and is consistent with common practices in ultrasound image analysis.
4) Normalization: We experimented with different normalization techniques such as min-max normalization and mean normalization. The standard normalization to a mean of 0.5 and a standard deviation of 0.5 proved to be the most effective approach.

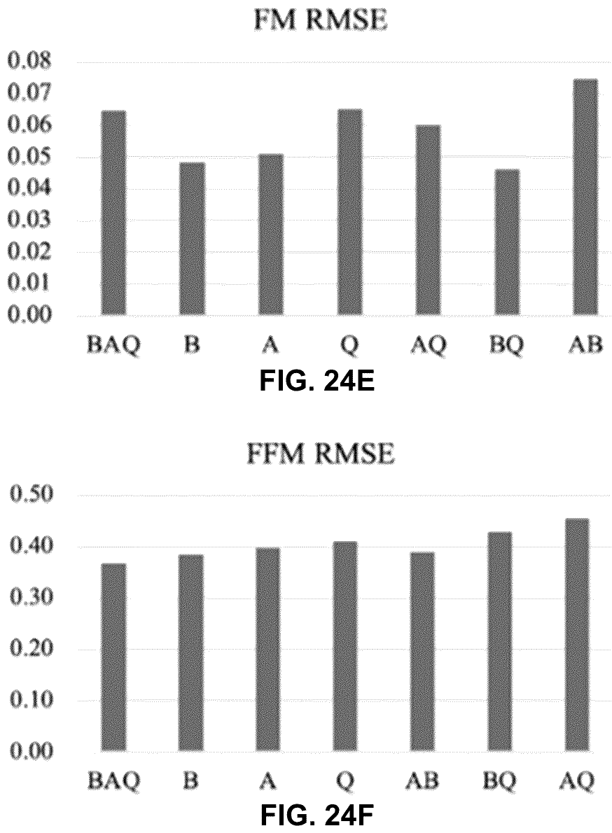

FIG. 23 shows Table V, p-values from one-sided t-test comparing mean performance metrics across different model configurations (a matrix of p-values indicates pairwise statistical comparisons between different deep learning models and training strategies, based on two evaluation metrics: MAE and MSE. The models evaluated are ResNet18 and EfficientNet, each trained using two approaches: Linear Probing (LP) and Fine-Tuning (FT). Each model-strategy-metric combination is labeled accordingly (e.g., ResNet18_LP_MAE, EfficientNet_FT_MSE)). This combination provides significant performance improvements over raw data. Additionally, we found that median filtering alone improved prediction accuracy, and applying image augmentation (augmenting each image five times) alone also improved performance. However, combining both median filtering and augmentation did not lead to further significant improvements, indicating that each technique independently contributes to performance enhancement.

Data Analysis: Model Design Choices For Deep Learning Pipelines; For FM prediction, the traditional model based on HOG features achieved an MAE of 0.1061 kg, MSE of 0.0155 kg², RMSE of 0.1247 kg, and MAPE of 116.23%. Similarly, the SIFT-based model utilizing BoVW has comparable results, with an MAE of 0.1101 kg, MSE of 0.0171 kg², RMSE of 0.1309 kg, and MAPE of 125.21%. Therefore, both models displayed limited ability to capture variability across infants, with predictions consistently hovering around a constant FM of approximately 0.2 kg.

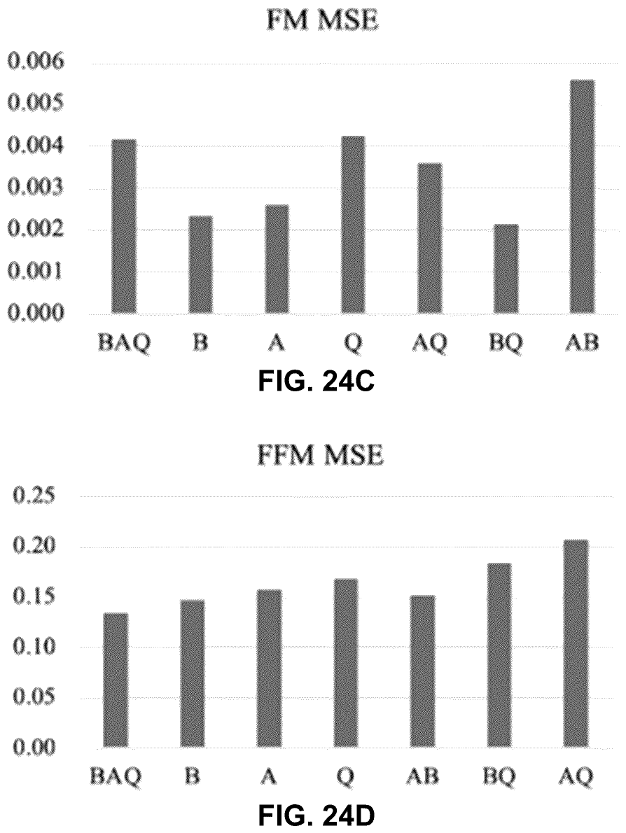

FIG. 20: presents the FM prediction results of various models using various optimizers and loss functions. In contrast, the deep learning models outperformed these traditional approaches across all error metrics. EfficientNet-B1 with fine-tuning and MAE loss function exhibited the best performance, achieving an MAE of 0.0455 kg and a MAPE of 25.32%. This marked a significant improvement over the classical methods, which had MAEs above 0.10 kg and MAPEs exceeding 100%. Therefore, EfficientNet-B1 with the MAE loss function was selected for further performance evaluation across different muscle combinations. FIG. 22 shows VMAPE Results for combinations of anatomical image locations

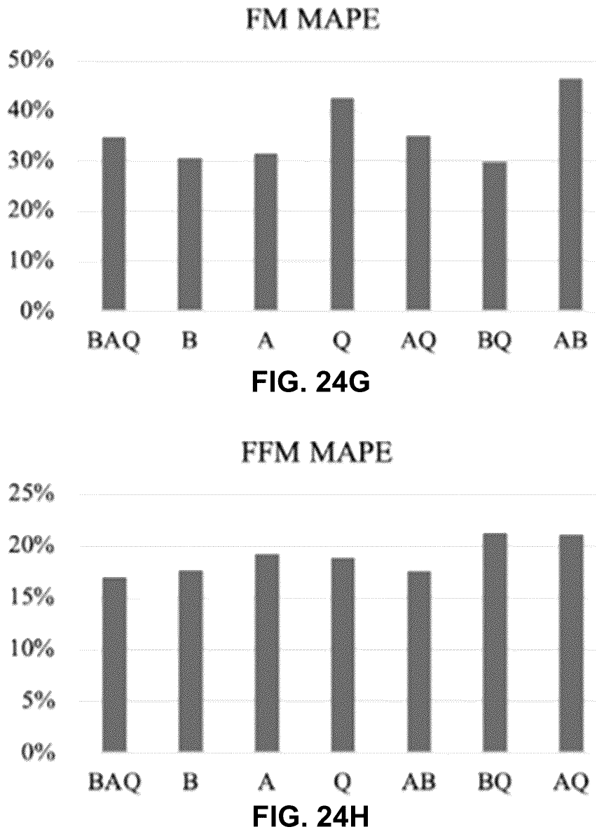

Ablation Studies: We conducted 50 independent runs of each model configuration on the same test dataset, recording the MAPE for each run. Subsequently, we performed one-sided paired t-tests to compare the distributions of MAPE values across model configurations. We calculated p-values to evaluate whether one configuration consistently yielded lower MAPE values compared to another. The Table in FIG. 23 presents these p-values, where a value close to 0 indicates that the MAPE values in the row are significantly lower than those in the columns, while a value close to 1 suggests the opposite. Based on this analysis, the best configuration is EfficientNet-B1 with fine-tuning. FIGS. 24A-24H show comparison of human body composition measurements (FM and FFM) across various combinations of body parts. The best configuration uses EfficientNet-B1 with fine-tuning and the mean absolute error (MAE) loss function, followed by ResNet18 with linear probing and the mean squared error (MSE) as the second-best configuration. The top two configurations are not significantly different from each other but are significantly different from the others.

In addition, we also analyzed the effect of the training strategy and loss function on model performance. For ResNet18, Linear Probing showed statistically significant improvements over Fine-Tuning, which suggests that linear probing may better capture the relevant features for this particular architecture. In contrast, for EfficientNet-B1, fine-tuning outperformed Linear Probing, demonstrating the importance of adjusting the weights in this model to achieve optimal performance. Interestingly, the choice of loss function, whether MAE or MSE, did not show consistent performance differences, indicating that both loss functions are equally effective in optimizing the models for this task.

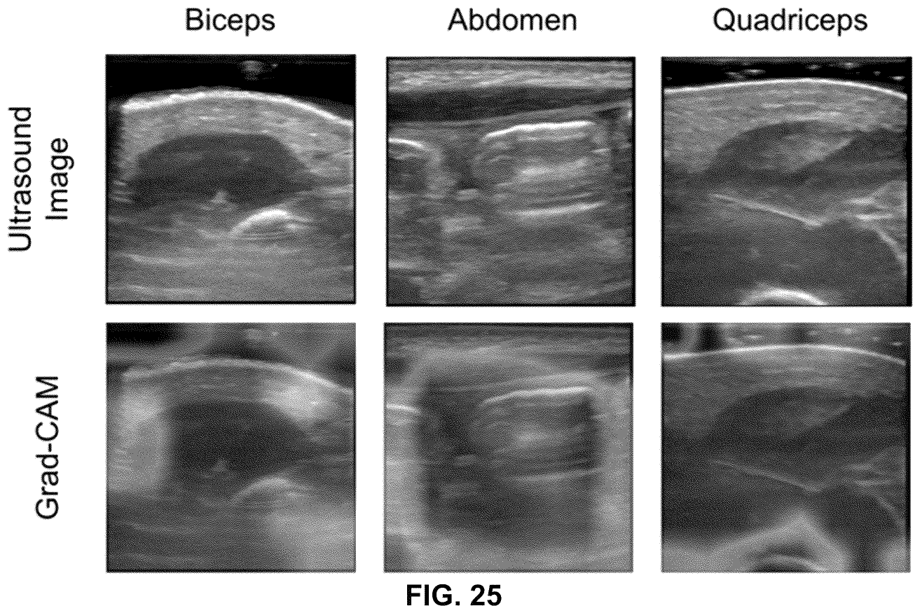

FIG. 25: The top row of images shows representative ultrasound images of the biceps, abdomen, and quadriceps. The bottom row shows Grad-CAM results of the contributory regions in the ultrasound images of abdomen, biceps and quadriceps. Warmer colors (reds) indicate higher importance in the model's prediction, while cooler colors (blue) indicate lower importance in the model's prediction. The results (with FIGS. 24G-24H and the Tables herein) further highlight the superiority of the EfficientNet-B1 model with fine-tuning and MAE loss function, as evidenced by significantly lower MAPE values. This configuration consistently outperformed all other models, suggesting that it is the most effective choice for predicting human body composition from ultrasound images. The findings also reveal that fine-tuning is a more effective strategy for certain models, while Linear Probing is a more appropriate strategy for others, which indicates that the effectiveness of training strategies is architecture-dependent.

FIGS. 24A-24H: in some examples, illustrate the systematic comparisons of all four evaluation metrics for both FM and FFM across seven combinations of human body parts. For FM prediction, the model trained with the combination of biceps and quadriceps outperforms those trained with other datasets. For FFM prediction, the model trained using all three body parts (biceps, abdomen, and quadriceps) achieves the best performance.

FIG. 24A—FM MAE: In an example, bar chart of fat mass (FM) mean absolute error across seven input configurations: BAQ (all three sites), single sites (B, A, Q), and pairwise fusions (AQ, BQ, AB). The y-axis spans small absolute-error units; lower bars indicate better accuracy. The panel shows a relatively tight spread across configurations, illustrating how site choice and fusion influence absolute error while remaining within a narrow operating band.

FIG. 24B—FFM MAE: Mean absolute error for fat-free mass (FFM) by the same seven configurations (BAQ, B, A, Q, AQ, BQ, AB). The y-axis covers a wider range than FM, reflecting larger absolute scales for FFM. Bars allow side-by-side comparison of single-site versus fused inputs, highlighting how combining anatomical regions can modulate error magnitude and stability across the cohort.

FIG. 24C—FM MSE: Mean squared error for FM, emphasizing outliers due to squaring. The x-axis lists the seven configurations; the y-axis shows small squared-error values. Differences between bars illustrate sensitivity of FM performance to site selection and fusion. Lower bars denote both fewer large deviations and better overall agreement with reference values.

FIG. 24D—FFM MSE: Mean squared error for FFM across BAQ, single-site, and pairwise inputs. Because FFM values can span a larger numeric range, the y-axis extends higher than FM. The panel highlights how squared error penalizes occasional large misses and underscores the impact of anatomical-site choice on robustness to outliers.

FIG. 24E—FM RMSE: Root-mean-squared error for FM, restoring squared error to original units for interpretability. Bars compare single-site and fused configurations. Lower RMSE bars indicate better overall accuracy by balancing bias and variance. The panel complements MAE/MSE by providing a scale-matched measure clinicians can relate to absolute FM units.

FIG. 24F—FFM RMSE: Root-mean-squared error for FFM under the seven configurations. The y-axis reflects FFM's larger absolute scale. Comparative bar heights reveal how pairwise or three-site fusion can stabilize performance relative to single-site inputs, reducing overall dispersion while remaining interpretable in native FFM units.

FIG. 24G—FM MAPE: Mean absolute percentage error for FM, enabling scale-free comparison. The y-axis reports percentages; lower bars denote better relative accuracy. By presenting error as a fraction of the reference value, the panel makes differences across configurations easier to compare when absolute FM varies across newborns.

FIG. 24H—FFM MAPE: Mean absolute percentage error for FFM across BAQ, single-site, and pairwise inputs. Percentage scaling facilitates cross-configuration comparison despite FFM's broader numeric range. Lower bars indicate more precise relative estimates, highlighting configurations that maintain consistent proportional accuracy across the cohort.

FIG. 25: displays Grad-CAM visualizations for a representative subject, highlighting the regions within the ultrasound images of the abdomen, biceps, and quadriceps that most influenced the model's predictions. Regions with warmer colors (e.g., red) denote higher relevance, while cooler colors (e.g., blue) indicate lower relevance in the prediction process. The feature maps reveal a consistent emphasis on muscular regions, with muscle tissue generally receiving greater attention than subcutaneous fat or underlying bone structures such as the femur and humerus. In particular, the abdominal images show that subcutaneous tissue is contributing more to the model output as compared to deeper tissues.

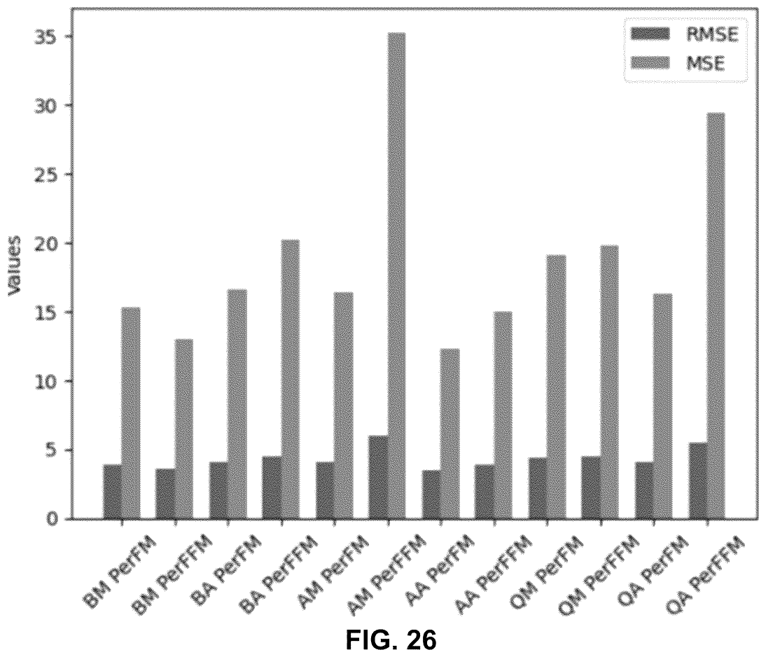

Sensitivity Studies: We conducted a sensitivity analysis to evaluate the human body composition prediction performance based on muscle and adipose tissue thickness measurements. The performance of PerFM and PerFFM prediction for each body part is shown in FIG. 26.

FIG. 26: This example histogram shows performance of utilizing adipose tissue/muscle thickness to predict PerFM/PerFFM (average measurement abbreviation—BM: biceps muscle, BA: biceps adipose, AM: abdominal muscle, AA: abdominal adipose; QM: quadriceps muscle, and QA: quadriceps adipose). The histogram shows example performance of utilizing adipose tissue/muscle thickness to predict PerFM/PerFFM (average measurement abbreviation—BM: biceps muscle, BA: biceps adipose, AM: abdominal muscle, AA: abdominal adipose; QM: quadriceps muscle, and QA: quadriceps adipose).

RMSE and MSE were employed instead of MAE due to the absence of clear outliers in the resulting plots. It can be observed that prediction performances for FM and FFM vary across different body parts. RMSE ranges from 3.51 to 5.94, while MSE ranges from 12.29 to 35.24 across all cases. Notably, BM PerFM/PerFFM and AA PerFM/PerFFM prediction exhibit the best performance. Additionally, our findings reveal that, adipose tissue thickness-based PerFM prediction has a lower RMSE than muscle thickness-based PerFM prediction for abdomen and quadriceps images, whereas muscle thickness-based PerFFM prediction has a lower RMSE than adipose tissue thickness-based PerFFM prediction for biceps and quadriceps images.

Discussion: Ultrasound has significant potential applications for nutritional evaluation and analysis. For instance, it can be used for assessing the nutritional status of older adults, conduct nutritional assessment of children with nephrotic syndrome, and perform morpho-functional assessment of disease related malnutrition. Unlike methods such as CT scans, ultrasound is radiation-free and more cost-effective. However, ultrasound has yet to be utilized for the automated estimation of human body composition, which is a critical metric for nutritional assessment. To our knowledge, this research is the first to apply deep learning-based image analysis for this purpose.

Ultrasound imaging is a promising tool for predicting body composition. However, there are no standard experimental protocols for conducting such measurements in the literature. In addition, no publicly available datasets exist for this application, which precludes external validation at this stage of the work. Our ultimate goal is to develop an automated ultrasound tool for body composition prediction that could ultimately be deployed for point-of-care nutritional assessment. In this paper, we pioneer the use of ultrasound imaging to develop a deep learning-based pipeline for automated human body composition prediction.

First, we conducted an analysis of ultrasound data using deep learning-based techniques to determine effective preprocessing methods, including median filtering, denoising, and image augmentation. These steps enhanced both the computational efficiency and the prediction performance of our deep learning models. This data preprocessing pipeline may serve as a foundation for further developing deep learning models for this and other musculoskeletal ultrasound applications.

Then, the comparison between traditional feature-based models and deep learning approaches highlights the clear advantages of modern neural networks in predicting FM. Both HOG and SIFT with BoVW models resulted in high error metrics, with MAPE values exceeding 100%, and struggled to capture the variability in FM across different infants, and consistently predicted values close to a constant. In contrast, the deep learning models showed significant improvements in prediction accuracy. EfficientNet-B1 with fine-tuning and the MAE loss function achieved an MAE of 0.0455 kg and a MAPE of 25.32%, which significantly outperform the traditional methods. Moreover, we also explored the use of GPR as part of the sensitivity studies to assess its potential for handling ultrasound image data for this task. GPR has shown promise in various ultrasound-based applications, such as human leg localization and gesture classification, due to its ability to provide robust predictive performance alongside uncertainty estimation. Future work may further investigate the integration of GPR with deep learning models to leverage its uncertainty estimation capabilities, particularly in clinical settings where model confidence is critically important.

In addition, we conducted a focused comparison of data acquisition protocols, specifically evaluating the contributions of images from different body parts to body composition prediction. By implementing EfficientNet-B1, we show that BQ and BAQ had the lowest MAPE values for prediction of FM compared to the other combinations of images. In contrast, all other combinations, including those for FFM predictions, were considerably higher. Therefore, it can be concluded that anatomical locations BQ and BAQ, along with their respective image regions are most predictive of FM and FFM. These findings are consistent with previous experimental studies in the literature, which indicate that specific body regions were commonly used for infants (0-1 years) to assess the whole-body composition. In those studies, biceps brachii have a strong relationship with body mass index and total body muscle mass. While these results merit further investigation, they suggest that particular combinations of images can lead to improved predictions, potentially streamlining clinical protocols.

Furthermore, the Grad-CAM visualizations provide valuable insight into the model's decision-making process by highlighting the anatomical regions that contribute most significantly to the predictions. The heatmaps display that muscle tissue such as biceps and quadriceps significantly contribute to the model's prediction. Conversely, subcutaneous fat and bone structures (e.g., femur and humerus) contribute less to the model's predictions. Notably, the abdominal region showed a distinct separation between muscle and fat, suggesting that the model emphasizes superficial tissue rather than deeper tissues for body composition prediction. In conclusion, these results reveal the model's reliance on key anatomical features and offer a more transparent understanding of how different human body parts in ultrasound images affect body composition predictions.

Our sensitivity analysis also examined the influence of different anatomical regions on prediction performance for FM and FFM. BM PerFM/PerFFM and AA PerFM/PerFFM achieve the best performance. The prediction performance metrics, RMSE and MSE, of PerFFM is higher than that of PerFM for most cases. Our findings indicate that adipose tissue thickness-based predictions for PerFM exhibit a lower RMSE compared to muscle thickness-based predictions for abdomen and quadriceps images. Conversely, muscle thickness-based predictions for PerFFM demonstrate a lower RMSE than those based on adipose tissue thickness for biceps and quadriceps images.

In this study, we successfully establish the feasibility of using deep learning for end-to-end prediction of human body composition from ultrasound images. In this proof-of-concept study, we focused exclusively on imaging data to develop and evaluate the effective data processing pipeline. Our findings provide a foundational benchmark and a methodological contribution by proposing an effective baseline model and an optimized data processing pipeline for this task. Overall, this study presents a novel deep learning approach for fully automated, ultrasound-based body composition prediction and then validates its feasibility, which lays the foundation for future research and broader clinical applications. Our preliminary results exhibit great potential for an end-to-end deep learning solution for automated ultrasound-based body composition prediction, potentially enhancing point-of-care assessments of malnutrition. While the study focuses on newborns, these techniques have broader applications, including the diagnosis of obesity, diabetes, and age-related musculoskeletal changes, as well as other nutritional evaluations.

However, in an example, we note several limitations. We acknowledge that the dataset used in this study is limited to 65 premature infants, with only 46 infants having complete data across all relevant modalities. This relatively small sample size is a key limitation, particularly for training deep learning models, which typically require larger and more diverse datasets to achieve robust generalization. Therefore, we recognize the preliminary nature of these findings, which demonstrate the feasibility of predicting body composition from ultrasound and provide a foundation for future research. Nevertheless, these results offer valuable insights for guiding subsequent studies and highlight the need for larger-scale data collection efforts to validate and refine the proposed approach. These insights are crucial for designing and optimizing experimental protocols, and for establishing a baseline for future research.

An additional limitation of this study is the absence of an external validation set, which restricts our ability to assess the generalizability of the model across different populations and clinical settings. The dataset used in this work was collected from a single institution, and access to external datasets was not available at this stage of the research. Considering the primary aim of this study was to establish the feasibility of using deep learning for ultrasound-based prediction of human body composition and to develop an effective data processing pipeline. Within this context, our findings serve as a proof-of-concept, and demonstrates the potential of the proposed approach. Future work will focus on expanding data collection to include multiple sites and more diverse populations, which will be essential for performing external validation and ensuring broader applicability of the model. On the other hand, when considering the successful deployment of such models in the future, several key challenges must be addressed as follows: 1). Optimizing real-time inference speed is essential for point-of-care applications, while maintaining prediction accuracy; 2). The model's interpretability, enhanced through techniques like Grad-CAM, will be crucial for clinician trust and adoption; 3). Obtaining regulatory approval and ensuring compliance with safety standards will be necessary steps for clinical use; 4). Ethical considerations, including the role of automated decision-making in supporting rather than replacing, clinician judgment, will also be integral to future development.

In upcoming studies, we will build on these results to develop novel deep learning architectures for the body composition prediction task, incorporate additional image analysis techniques (e.g., segmentation of various anatomical structures, such as fat and muscle layers), and utilize non-image clinical characteristic data (e.g., sex, birth weight, and age) as supplementary model inputs. Then, in order to improve our datasets, we will expand data collection to include multiple sites and more diverse populations, which will be essential for conducting external validation and ensuring broader applicability of the model. We are currently conducting clinical studies at two academic medical centers in East Africa and North America, where we are gathering additional ultrasound data and clinical metrics from diverse populations. We anticipate that aggregating these new datasets with our existing data will enhance our deep learning pipeline's robustness and generalizability. Although this study centers on preterm infants, we will also expand our research to include full-term infants to evaluate consistency across populations. Furthermore, future studies will investigate outliers in model predictions and extend our analysis to other high-risk infant groups, thereby broadening the impact of our findings. Finally, we will explore the deployment of the DL models in practical scenarios, with the potential to enhance clinical decision-making and patient care.

Conclusion: In this study, we curated a representative experimental dataset of ultrasound images alongside gold standard body composition values from ADP, and developed a deep learning-based pipeline for predicting human body composition. The key contributions of this paper are as follows: (1) The implementation of median filtering, denoising, and image augmentation achieved a balance between computational efficiency and prediction performance; (2) Among the models evaluated, EfficientNet-B1 with fine-tuning and trained using the MAE loss function demonstrated the most promising baseline performance; (3) The combinations of biceps and quadriceps images, as well as biceps, abdomen, and quadriceps, resulted in predictions with the lowest MAPE. Finally, sensitivity analysis indicates that the prediction performance of FM and FFM is influenced by various body parts, as well as muscle and adipose thicknesses. Our findings provide critical guidelines for optimizing a novel ultrasound scanning and interpretation protocol for predicting human body composition, with significant implications for the clinical assessment of infant malnutrition.

In a discussion, study or a reading of the details, features, embodiments, aspects, any figure or any part of any figure, and/or examples of the technology disclosed herein, any of the features, embodiments, aspects, and/or examples herein can be optionally inter-combined (or inter-discussed) with the example details listed below, and any portion (or aspect) of any detail below can be inter-combined with any portion of any feature or example disclosed herein:

Detail 1: A computer-implemented method for estimating body composition of a subject from ultrasound imagery, the method comprising: receiving one or more ultrasound images of a subject acquired at at least one of a biceps region, an abdomen region, and a quadriceps region; preprocessing the one or more ultrasound images to generate normalized inputs, the preprocessing comprising one or more of cropping, resizing, denoising, intensity normalization, or pixel spacing normalization; segmenting tissue structures in the normalized inputs by executing a trained neural network to produce pixel-wise delineations of anatomical boundaries; and predicting, using a trained regression model operating on features derived from the normalized inputs and the pixel-wise delineations, a body-composition output comprising at least one of fat mass (FM) and fat-free mass (FFM), and producing a report comprising the body-composition output.

Detail 2: The method of detail 1, wherein the trained neural network comprises an encoder-decoder architecture with skip connections.

Detail 3: The method of detail 1, wherein the one or more ultrasound images comprise images from two or more of the biceps region, the abdomen region, and the quadriceps region, and the predicting comprises combining region-specific predictions to produce the body-composition output.

Detail 4: The method of detail 1, wherein the preprocessing further comprises normalizing pixel spacing using image metadata or a scale indicator to standardize physical scale prior to segmentation.

Detail 5: The method of detail 1, wherein the preprocessing further comprises speckle reduction using at least one of median filtering or anisotropic diffusion.

Detail 6: The method of detail 1, further comprising selecting, from a sequence of frames of a given anatomical region, a subset of frames that satisfy a quality criterion for use in the predicting.

Detail 7: The method of detail 1, further comprising aggregating a plurality of frames of a given anatomical region into a region-level representation using at least one of averaging, median aggregation, or feature pooling prior to the predicting.

Detail 8: The method of detail 1, further comprising computing an image-quality score for a received ultrasound image and rejecting the ultrasound image responsive to the image-quality score failing a threshold comprising motion blur or insufficient anatomical coverage.

Detail 9: The method of detail 1, wherein the predicting further comprises adjusting the body-composition output based on one or more subject covariates selected from the group consisting of age, sex, and birthweight.

Detail 10: The method of detail 1, further comprising computing an uncertainty or confidence score for the body-composition output and including the uncertainty or confidence score in the report. In subjects with diabetes or pre-diabetes, the report optionally recommends confirmatory laboratory testing when the uncertainty exceeds a configurable threshold.

Detail 11: The method of detail 1, further comprising generating an explanation visualization comprising a saliency or attention heatmap overlaid on at least one of the ultrasound images and including the explanation visualization in the report.

Detail 12: The method of detail 1, further comprising triggering an alert when the body-composition output indicates under- or over-nutrition relative to a configurable threshold.

Detail 13: The method of detail 1, wherein the receiving comprises batched ingestion of images for multiple subjects and the predicting is performed as a batch operation with per-subject outputs.

Detail 14: The method of detail 1, wherein the receiving comprises streaming frames from an ultrasound probe and the predicting is performed incrementally as frames are received.

Detail 15: The method of detail 1, further comprising storing, in association with a subject identifier, at least the ultrasound images, intermediate segmentations, the body-composition output, and the uncertainty or confidence score.

Detail 16: The method of detail 1, wherein the predicting comprises multi-task inference to output both FM and FFM concurrently.

Detail 17: The method of detail 1, further comprising ensembling predictions from a plurality of trained models to generate the body-composition output.

Detail 18: The method of detail 1, wherein the preprocessing further comprises brightness and contrast normalization to reduce acquisition variability.

Detail 19: The method of detail 1, wherein the predicting further comprises calibration against a reference cohort to reduce systematic bias.

Detail 20: The method of detail 1, wherein the report comprises textual values for each of FM and FFM and, when applicable for pregnant subjects or subjects with diabetes, adiposity indices including preperitoneal fat thickness and a visceral-to-subcutaneous fat ratio, a gestational-weight-gain percentile for pregnant subjects, and at least one performance or agreement metric computed with respect to a reference measure.

Detail 21: The method of detail 1, wherein at least a portion of the segmenting executes on an edge device coupled to an ultrasound probe and at least a portion of the predicting executes on a remote server, and the report is returned to a display of the edge device.

Detail 22: The method of detail 1, further comprising requesting reacquisition of an image when the image-quality score fails the threshold or when the explanation visualization indicates insufficient coverage of a target tissue region.

Detail 23: The method of detail 1, wherein the trained neural network is configured to output both the pixel-wise delineations and derived geometric measurements for at least one tissue layer.

Detail 24: The method of detail 1, wherein the predicting further comprises regularizing the regression model to reduce overfitting using at least one of weight decay or dropout.

Detail 25: A system for estimating body composition of a subject from ultrasound imagery, comprising: an ultrasound acquisition interface configured to receive ultrasound images of a subject acquired at at least one of a biceps region, an abdomen region, and a quadriceps region; one or more processors; and non-transitory memory storing instructions that, when executed by the one or more processors, cause the system to perform operations comprising: preprocessing the ultrasound images to generate normalized inputs; segmenting tissue structures in the normalized inputs using a trained neural network to produce pixel-wise delineations; generating features from the normalized inputs and the pixel-wise delineations; predicting, using a trained regression model, a body-composition output comprising at least one of FM, FFM, preperitoneal fat thickness, a visceral-to-subcutaneous fat ratio, or an adiposity score; and producing a report comprising the body-composition output.

Detail 26: The system of detail 25, further comprising a display configured to present the report and an explanation visualization comprising a saliency heatmap overlaid on at least one ultrasound image.

Detail 27: The system of detail 25, wherein at least a portion of the preprocessing and segmenting executes on an edge device integrated with or coupled to an ultrasound probe.

Detail 28: The system of detail 25, further comprising a network interface configured to communicate normalized inputs or intermediate features to a remote server for inference and to receive the body-composition output in response.

Detail 29: The system of detail 25, wherein the non-transitory memory stores the trained neural network comprising an encoder-decoder architecture with skip connections for pixel-wise segmentation.

Detail 30: The system of detail 25, wherein the system is configured to accept multiple images per anatomical region and to combine the multiple images to produce a region-level prediction.

Detail 31: The system of detail 25, wherein the system is configured to compute and store at least one of: (i) an uncertainty or confidence score for the body-composition output, and (ii) an image-quality score for a received ultrasound image. In pregnant subjects, the system further stores a gestational age at visit and flags visits for trend analysis across prenatal care.

Detail 32: The system of detail 25, wherein the system is configured to provide operator feedback when the image-quality score is below a threshold and to request reacquisition for a specified anatomical region.

Detail 33: The system of detail 25, further comprising secure data storage to retain acquired images, segmentations, and outputs tied to a subject identifier with access control by user role.

Detail 34: The system of detail 25, wherein the system is configured to operate in an offline mode and to synchronize pending results when connectivity is restored.

Detail 35: The system of detail 25, wherein the system includes hardware acceleration for neural-network inference comprising at least one of a GPU, an NPU, or a DSP.

Detail 36: The system of detail 25, wherein the system exposes an application programming interface configured to export the body-composition output to an external clinical record system, together with associated laboratory values when available (including HbA1c, fasting glucose, or fasting insulin).

Detail 37: The system of detail 25, wherein the system is configured to present probe-placement guidance or anatomical targeting cues on the display during image acquisition.

Detail 38: The system of detail 25, wherein the system is configured to maintain audit trails linking inputs, intermediate results, and outputs to versioned models and configuration parameters.

Detail 39: The system of detail 25, wherein the system is configured to apply brightness and contrast normalization during preprocessing to reduce acquisition variability.

Detail 40: The system of detail 25, wherein the system is configured to aggregate predictions across two or more of the biceps region, abdomen region, and quadriceps region to produce the body-composition output.

Detail 41: The system of detail 25, wherein the system is configured to compute at least one agreement metric with respect to a reference measurement and to display the agreement metric in the report.

Detail 42: The system of detail 25, wherein the system is configured to receive streaming frames from the ultrasound acquisition interface and to update the body-composition output incrementally as frames are received.

Detail 43: The system of detail 25, wherein the non-transitory memory stores model parameters for an ensemble of trained models and the one or more processors are configured to ensemble outputs of the trained models.

Detail 44: A method of training models to estimate body composition of a subject from ultrasound imagery, the method comprising: accessing a training dataset comprising ultrasound images of subjects and corresponding reference body-composition measurements; preprocessing the ultrasound images to generate normalized training inputs; training a segmentation network using the normalized training inputs to produce pixel-wise delineations of anatomical boundaries; deriving features from the normalized training inputs and the pixel-wise delineations; and training a regression model using the features to predict at least one of FM and FFM.

Detail 45: The method of detail 44, wherein the segmentation network comprises an encoder-decoder architecture with skip connections and is trained using a loss comprising a Dice component.

Detail 46: The method of detail 44, wherein the training dataset comprises images from at least two of the biceps region, abdomen region, and quadriceps region for a given subject, and the regression model is trained to combine region-level representations.

Detail 47: The method of detail 44, further comprising augmenting the ultrasound images using at least one of geometric transformations or intensity perturbations.

Detail 48: The method of detail 44, further comprising selecting hyperparameters for the segmentation network or the regression model based on validation performance.

Detail 49: The method of detail 44, further comprising performing cross-validation to estimate generalization performance of the trained models.

Detail 50: The method of detail 44, further comprising computing agreement metrics selected from the group consisting of mean absolute percentage error and a Bland-Altman analysis on a held-out dataset.

Detail 51: The method of detail 44, further comprising calibrating outputs of the regression model to reduce systematic bias relative to the reference measurements.

Detail 52: The method of detail 44, further comprising ensembling predictions from a plurality of trained models to generate a final prediction on the held-out dataset.

Detail 53: The method of detail 44, wherein the training further comprises learning to output an uncertainty or confidence score associated with at least one of FM or FFM.

Detail 54: The method of detail 44, further comprising post-processing the pixel-wise delineations using morphological operations to refine tissue boundaries.

Detail 55: The method of detail 44, further comprising validating explanation visualizations for validation images to confirm that salient regions correspond to anatomically relevant structures.

Detail 56: The method of detail 44, further comprising early stopping of training responsive to stagnation of validation performance.

Detail 57: The method of detail 44, wherein the regression model is trained to predict both FM and FFM concurrently as a multi-task objective.

Detail 58: The method of detail 44, further comprising standardizing pixel spacing across the training dataset to a common physical scale.

Detail 59: The method of detail 44, further comprising selecting model checkpoints based on a criterion comprising lowest validation error or highest agreement metric.

Detail 60: The method of detail 44, further comprising storing trained model parameters and training metadata for subsequent deployment.

Detail 61: A method for acquisition planning for ultrasound body-composition estimation in a subject, the method comprising: receiving an indication of candidate anatomical regions comprising at least the biceps region, the abdomen region, and the quadriceps region; estimating, for each candidate anatomical region or combination of candidate anatomical regions, a prediction error for at least one of FM and FFM using a trained model; and selecting a subset of the candidate anatomical regions that satisfies an error threshold and generating acquisition guidance specifying the subset.

Detail 62: The method of detail 61, wherein the selecting favors subsets with fewer anatomical regions subject to satisfying the error threshold.

Detail 63: The method of detail 61, wherein the acquisition guidance comprises textual instructions presented on a display coupled to an ultrasound probe.

Detail 64: The method of detail 61, further comprising instructing reacquisition of an anatomical region when a received image fails a quality criterion comprising motion blur or insufficient anatomical coverage.

Detail 65: The method of detail 61, further comprising updating the subset over time based on newly acquired data and observed agreement metrics in clinical use.

Detail 66: The method of detail 61, wherein estimating the prediction error comprises using validation performance of the trained model on images from the corresponding anatomical regions.

Detail 67: The method of detail 61, wherein the selecting comprises optimizing a multi-objective criterion that balances expected error and acquisition time.

Detail 68: The method of detail 61, further comprising presenting probe-placement guidance or anatomical targeting cues during acquisition in accordance with the acquisition guidance.

Detail 69: The method of detail 61, further comprising computing an expected confidence score for the body-composition output corresponding to the selected subset and presenting the expected confidence score in the acquisition guidance. For subjects with diabetes, the confidence score is computed for the adiposity score and for preperitoneal fat thickness.

Detail 70: The method of detail 61, further comprising applying a clinic- or population-specific (including pregnancy or diabetes) error threshold or acquisition time constraint.

Detail 71: The method of detail 61, further comprising determining a fallback subset when at least one candidate anatomical region is unavailable due to occlusion, artifact, or clinical constraints.

Detail 72: The method of detail 61, further comprising recording operator performance metrics comprising the number of reacquisition requests, average acquisition time, or achieved error relative to the threshold.

Detail 73: The method of detail 61, further comprising storing the selected subset, acquisition guidance, and resulting predictions in association with a subject identifier for continual improvement analytics.

Detail 74: The method of detail 61, further comprising proposing a next-best anatomical region after each successfully acquired region until the error threshold is satisfied.

Detail 75: The method of detail 61, wherein the acquisition guidance is updated in real time based on the image-quality score of frames received during acquisition.

Detail 76: The method of detail 61, further comprising computing an expected reduction in prediction error for each additional anatomical region prior to selection of the subset.

Detail 77: The method of detail 61, wherein the selecting is constrained by a maximum number of anatomical regions or a maximum acquisition time specified by a user.

Detail 78: The method of detail 61, further comprising exporting the acquisition guidance and the selected subset to an external clinical record system.

Detail 79: The method of detail 61, wherein the estimating further comprises accounting for subject covariates selected from the group consisting of age, sex, and birthweight.

Detail 80: The method of detail 61, further comprising presenting graphical overlays that illustrate target tissue zones for the selected anatomical regions.

Detail 81: The method of detail 61, further comprising updating the error threshold over time responsive to observed agreement metrics across a patient population.

Detail 82: The method of detail 61, wherein the estimating further comprises computing expected uncertainty for the body-composition output corresponding to the selected subset.

Detail 83: The method of detail 61, further comprising handling images from multiple ultrasound probes or devices by normalizing device-specific acquisition parameters prior to estimating the prediction error.

Detail 84: The method of detail 61, further comprising prioritizing anatomical regions according to expected information gain estimated from validation data.

Detail 85: The method of detail 61, further comprising displaying a summary of the selected subset and expected error on the display prior to acquisition.

Detail 86: The method of detail 61, wherein the acquisition guidance comprises both textual instructions and graphical cues rendered on a live ultrasound feed.

Detail 87: The method of detail 61, further comprising storing outcomes of completed acquisition sessions to update the trained model that estimates the prediction error for future planning sessions.

Detail 88: The method of detail 61, further comprising issuing an alert when the expected error is above a maximum allowable value after all candidate anatomical regions have been acquired.

Detail 89: The method of detail 61, further comprising recommending a follow-up acquisition schedule based on the selected subset and the subject's covariates.

Detail 90: The method of detail 61, wherein the selecting further comprises ranking combinations of candidate anatomical regions by predicted error and acquisition time, and presenting the ranking to a user.

Detail 91: The method of detail 61, further comprising determining, based on the selected subset, whether to perform on-device inference, remote inference, or a combination thereof.

Detail 92: The method of detail 61, further comprising logging the anatomical regions attempted, accepted, and rejected during acquisition for audit and quality assurance.

Detail 93: The method of detail 61, further comprising determining that no additional anatomical regions are required once the error threshold is satisfied and instructing termination of acquisition.

Detail 94: The method of detail 61, wherein the acquisition guidance further includes confidence bounds for the expected FM or FFM outputs or, when applicable, an adiposity score given the selected subset.

Detail 95: The method of detail 61, further comprising storing de-identified acquisition metadata and prediction outcomes for performance monitoring across deployments.

Detail 96: The method of detail 61, further comprising generating a summary report that includes the selected subset, acquisition time, expected error, and final predicted FM or FFM values.

In general, any combination of disclosed features, components and methods described herein is possible. Steps of a method can be performed in any order that is physically possible.

All cited references are incorporated by reference herein. Although embodiments have been disclosed, it is not desired to be limited thereby. Rather, the scope should be determined only by the appended claims.

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

The methods and systems described herein may be implemented on any suitable computing architecture. In some embodiments, a computing environment includes one or more processors, memory, persistent storage, and network interfaces coupled via one or more buses. Processors may include general-purpose CPUs, multicore processors, graphics processors (GPUs), tensor or neural processing units (TPUs/NPUs), digital signal processors (DSPs), and/or custom accelerators such as FPGAs or ASICs. Any subset of these devices may be employed for training, fine-tuning, and/or inference of machine-learning models, including deep neural networks and other statistical or rules-based components. Program logic can be organized as applications, services, libraries, drivers, kernels, and/or microservices executing in user space or kernel space.

Memory may comprise volatile memory (e.g., registers, caches, SRAM, DRAM) and non-volatile memory (e.g., flash/SSD, NVMe drives, persistent memory, MRAM) storing instructions and data. A non-transitory computer-readable medium may store instructions that, when executed by one or more processors, cause the processors to perform any of the operations described herein. Storage may include block, file, and object stores, and may be deployed locally (on-premises), in public or private clouds, or across hybrid and multi-cloud configurations.

In some embodiments, applications are packaged into container images and orchestrated by a container orchestration platform to automate deployment, scaling, health management, and rollbacks. Orchestration may support declarative configuration, secrets management, workload autoscaling (e.g., horizontal/vertical), service discovery, and persistent volume attachment for stateful workloads. In other embodiments, portions of the system are delivered as “serverless” functions that execute in response to events (e.g., message arrivals, API calls, file uploads) with the cloud provider provisioning and managing underlying compute resources. Serverless components can be used for lightweight preprocessing, postprocessing, or background tasks, while long-running services and GPUs/TPUs run in containers or virtual machines as needed.

Networking may include local and wide-area networks, VPNs, and the public Internet using wired and/or wireless links. Edge devices (e.g., mobile phones, tablets, wearables, cameras, ultrasound probes, and other embedded devices) may execute on-device components with intermittent connectivity to upstream services. Communication may use secure channels (e.g., TLS) and authenticated requests (e.g., short-lived tokens). Message-oriented middleware (e.g., publish/subscribe topics and queues) can decouple producers and consumers, support back-pressure, and enable streaming or batch processing.

Data pipelines may ingest heterogeneous inputs (e.g., images, video frames, waveforms, text, tabular records, sensor measurements) into landing areas and durable stores. Schemas may be enforced or inferred; metadata catalogs can track provenance, lineage, and data quality. Feature stores can materialize precomputed or on-demand features. For unstructured content, embedding generators may map items to dense vectors stored in a vector index to support similarity search and retrieval-augmented workflows. Conventional relational, key-value, document, time-series, and object stores may also be used for transactional and analytical workloads.

Machine-learning components can include supervised, unsupervised, and reinforcement-learning models, classical and deep architectures (e.g., CNNs, RNNs, transformers, diffusion models), and hybrid or ensemble methods. Training may occur on clusters of accelerators with distributed data or model parallelism; inference can be performed online (request/response), offline (batch), or near-real-time (streaming). In some embodiments, a retrieval-augmented generation (RAG) pipeline couples a retriever with one or more generative models to ground outputs in a corpus of verified knowledge. The retriever can query a vector database and/or keyword index, optionally performing hybrid retrieval, reranking, and citation tracking. Embedding models may be domain-specific, multilingual, or multimodal, and can be periodically refreshed to reflect new data.

To improve latency and efficiency, models may be optimized via quantization (e.g., INT8 or FP8), pruning, knowledge distillation, operator/kernel fusion, graph compilation, caching (e.g., KV-cache), and mixed-precision execution. Workloads can be placed dynamically on heterogeneous accelerators; autoscaling may consider request rates, queue depth, GPU memory, and cost constraints. Observability may include tracing, metrics, and logs for request latency, throughput, error rates, and model-level telemetry (e.g., drift, calibration, and outlier detection). Canary and shadow deployments may be used to validate updates safely before promotion.

In some embodiments, privacy-preserving and security controls are incorporated by design. When training requires sensitive data, techniques such as federated learning can train models across distributed clients or sites while retaining raw data locally. Additional protections may include differential-privacy mechanisms to bound disclosure risk, secure enclaves or confidential-computing virtual machines to protect data and models “in use,” encryption of data at rest and in transit, strong identity and access management, and cryptographic attestation of trusted execution environments. Policy-driven governance may include dataset and model cards, risk registers, audit logs, and controls aligned with contemporary AI risk-management frameworks. Runtime guardrails may filter inputs/outputs, enforce rate limits, and block unsafe prompts or responses based on configurable policies.

Deployment patterns may include: (i) single-tenant and multi-tenant SaaS; (ii) on-premises or virtual private cloud for regulated customers; (iii) edge-to-cloud split inference where a lightweight model runs on-device and delegates complex tasks to a remote service; and/or (iv) offline-capable modes that buffer requests and synchronize results when connectivity is restored. High availability can be achieved via multi-zone or multi-region redundancy, graceful degradation, queue-backed retries, idempotent APIs, and circuit-breaker patterns. Disaster recovery can include regular, encrypted backups and tested restore runbooks.

The system may expose one or more APIs (e.g., REST, gRPC, GraphQL) and SDKs. Access tokens may be scoped and short-lived, with continuous key rotation. Administrative consoles can surface configuration, quotas, and audit trails. Tooling may include CI/CD pipelines for infrastructure-as-code, automated testing (unit, integration, load, and safety evaluations), and rollout orchestration. MLOps workflows can address the model lifecycle: data collection, labeling, evaluation (including fairness and robustness metrics), versioning, packaging, deployment, monitoring, and rollback. Human-in-the-loop review may be invoked for low-confidence or high-risk cases.

Any module described herein can run on a single device or be distributed across multiple machines and clouds. The components may be combined, split, reordered, or omitted in various embodiments. The techniques are not limited to a particular programming language, framework, cloud provider, or model family. Unless stated otherwise, the examples are non-limiting, and any enumerated alternatives are illustrative rather than exhaustive.

### Examples of Suitable Implementations (Non-Exhaustive)

Orchestrated containers for core services, with autoscaling and declarative rollouts.
Event-driven “serverless” functions for preprocessing, file ingestion, and scheduled jobs.
A retrieval layer using dense embeddings stored in a vector index for semantic search, optionally combined with keyword search and reranking for hybrid retrieval.
Accelerator-optimized inference using mixed precision and quantization to reduce latency and cost while meeting accuracy targets.
Privacy-enhancing features such as federated training, differential-privacy noise mechanisms for analytics, confidential-computing VMs for sensitive workloads, and encrypted transport and storage.
Centralized observability with metrics, traces, and logs, plus model-quality monitors (drift, bias checks, and safety filters).

The foregoing description is intended as a generalized, technology-agnostic base section that can be adapted to a variety of inventions. It may be combined with domain-specific embodiments (e.g., medical imaging, ultrasound processing, or other sensor-based systems) and with specific figures, claims, and examples as appropriate. Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. Moreover, due to biological functional equivalency considerations, some changes can be made in protein structure without affecting the biological or chemical action in kind or amount. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure. The methods, kits, formulations, and devices disclosed herein can be combined in any way into systems to address the current public health emergency.

The technology described herein is further illustrated by the following examples which in no way should be construed as being further limiting. The Examples are provided to demonstrate examples of future planned work, which in some experiments is emergency work. Although methods and materials similar or equivalent to those described herein can be used in the practice or testing of this disclosure, suitable methods and materials are described below.

### EXAMPLES

The invention now being generally described, it will be more readily understood by reference to the following Examples which are included merely for purposes of illustration of certain aspects and embodiments of the present invention and are not intended to limit the invention.

### Example 1. Testing of Implementation Options in Methods

Prophetic methods are tested for all descriptions above and further as discussed below. We demonstrate a method for predicting body composition using ultrasound imaging and deep learning techniques. In an example, this could comprise of: acquiring ultrasound images from a subject's body using an ultrasound imaging device; pre-processing the acquired images to enhance image quality and prepare for effective analysis; utilizing deep learning models trained on a dataset of labeled ultrasound images correlated with known body composition metrics, where the deep learning models employ convolutional neural networks (CNNs) to extract relevant features from the images. This includes inputting the preprocessed images into the model.

Next would be generating predictions of the subject's body composition metrics, including but not limited to fat mass and fat free mass, fat percentage, lean mass, and muscle distribution; then outputting results and interpretation in a user-friendly format for further analysis or clinical interpretation. This includes visualization methods, like Grad-CAM and other approaches for explainable AI

The deep learning model above can be further optimized through techniques such as transfer learning, data augmentation, and/or regularization.

The deep learning model above can be where pre-processing includes but is not limited to noise reduction, normalization and/or segmentation.

In some aspects, the deep learning model above is where ultrasound images are acquired in real-time and predictions could be generated within a specified time frame to facilitate realistic clinical decision making.

Ultrasound system: configured to capture real-time images of the subject, processing unit with trained deep learning models for analyzing the images, user interface for guiding a user to collect high quality data and predicting body composition metrics to a user.

In an example figure (FIG. 1) an example of a possible implementation of the invention is shown. Based on our work, (Ranger, et al., 2024), there is a need for expanding work in utilizing ultrasound for assessing pediatric nutritional assessment. Most of our studies thus far have been on newborns. Ultrasound equipped with deep learning interpretation methods, offers significant potential as a research tool to study growth and nutritional assessment, as well as a practical tool that could one day be used for routine scanning. Our proposed methods could be expanded to other populations. Of particular interest are: pregnant women, adolescents, athletes, elderly. This could be realized as personalized nutrition monitoring, dietary feedback, and clinical nutritional interventions.

This could potentially expand to complement other clinical assessments or biomedical research such as: nutrient absorption evaluation, hydration, and assessment of muscle quality.

### Example 2. Example Embodiments

The following example embodiments are tested and are further refined:

Example Embodiment 1: A computer-implemented method for estimating body composition of a subject from ultrasound imagery, the method comprising: receiving, by one or more processors, one or more ultrasound images of a subject acquired at at least one of a biceps region, an abdomen region, and a quadriceps region; preprocessing the one or more ultrasound images to generate normalized inputs, the preprocessing comprising one or more of cropping, resizing, denoising, or intensity normalization; segmenting tissue structures in the normalized inputs by executing a trained neural network to produce pixel-wise delineations of anatomical boundaries; generating, from the normalized inputs and the pixel-wise delineations, a learned feature representation; and predicting, using a trained regression model, a body-composition output comprising at least one of fat mass (FM) and fat-free mass (FFM), and producing a report comprising the body-composition output.

Example Embodiment 2: The method of example embodiment 1, wherein the trained neural network comprises a U-Net or U-Net-like encoder-decoder architecture.

Example Embodiment 3: The method of example embodiment 1, wherein the ultrasound images comprise a plurality of images from two or more anatomical regions and the predicting comprises combining region-specific predictions to produce the body-composition output.

Example Embodiment 4: The method of example embodiment 1, wherein the preprocessing further comprises standardizing physical scale using metadata or scale bars to normalize pixel spacing prior to segmentation.

Example Embodiment 5: The method of example embodiment 1, further comprising computing an uncertainty or confidence score for the body-composition output and including the confidence score in the report.

Example Embodiment 6: The method of example embodiment 1, further comprising generating an explanation visualization comprising a saliency or attention heatmap overlaid on at least one of the ultrasound images and providing the explanation visualization in the report.

Example Embodiment 7: The method of example embodiment 1, wherein the predicting further comprises adjusting the body-composition output based on subject covariates selected from the group consisting of age, sex, weight, and, in neonatal embodiments, birthweight.

Example Embodiment 8: The method of example embodiment 1, further comprising aggregating multiple frames of a given anatomical region into a region-level representation prior to predicting the body-composition output.

Example Embodiment 9: The method of example embodiment 1, wherein the report comprises a textual value for each of FM and FFM and at least one performance or agreement metric computed with respect to a reference measure.

Example Embodiment 10: The method of example embodiment 1, wherein at least a portion of the segmenting executes on an edge device coupled to an ultrasound probe and the predicting executes on a remote server, and the report is returned to a display of the edge device.

Example Embodiment 11: The method of example embodiment 1, wherein receiving comprises rejecting images that fail a quality criterion comprising motion blur or insufficient anatomical coverage.

Example Embodiment 12: A system for estimating body composition of a subject from ultrasound imagery, comprising: an ultrasound acquisition interface configured to receive ultrasound images of a subject acquired at at least one of a biceps region, an abdomen region, and a quadriceps region; one or more processors; and non-transitory memory storing instructions that, when executed by the one or more processors, cause the system to perform operations comprising the operations of any of example embodiments 1-11.

Example Embodiment 13: The system of example embodiment 12, further comprising a display configured to present the report comprising the body-composition output and the explanation visualization.

Example Embodiment 14: The system of example embodiment 12, wherein the non-transitory memory stores a trained neural network comprising an encoder-decoder with skip connections for pixel-wise segmentation.

Example Embodiment 15: The system of example embodiment 12, wherein the system is configured to accept multiple images per anatomical region and to combine the multiple images to produce a region-level prediction.

Example Embodiment 16: The system of example embodiment 12, wherein the system includes a network interface to communicate normalized inputs or intermediate features to a remote server for inference.

Example Embodiment 17: The system of example embodiment 12, wherein the system is configured to compute and store the uncertainty or confidence score along with the body-composition output.

Example Embodiment 18: The system of example embodiment 12, wherein the system is configured to perform preprocessing comprising physical scale normalization using image metadata.

Example Embodiment 19: The system of example embodiment 12, wherein the system is configured to store acquired images, intermediate segmentations, and outputs in association with a unique subject identifier.

Example Embodiment 20: The system of example embodiment 12, wherein the system is configured to provide operator feedback when image quality is below a threshold and to request reacquisition for a specified anatomical region.

Example Embodiment 21: A non-transitory computer-readable medium storing instructions that, when executed by one or more processors, cause the one or more processors to perform the method of any of example embodiments 1-11.

Example Embodiment 22: The non-transitory computer-readable medium of example embodiment 21, wherein the instructions comprise code to compute an explanation visualization comprising a saliency heatmap and to embed the explanation visualization in the report.

Example Embodiment 23: The non-transitory computer-readable medium of example embodiment 21, wherein the instructions comprise code to aggregate predictions across the biceps region, abdomen region, and quadriceps region.

Example Embodiment 24: The non-transitory computer-readable medium of example embodiment 21, wherein the instructions comprise code to standardize pixel spacing of received ultrasound images prior to segmentation.

Example Embodiment 25: The non-transitory computer-readable medium of example embodiment 21, wherein the instructions comprise code to reject images failing a quality criterion comprising motion blur or insufficient anatomical coverage.

Example Embodiment 26: The non-transitory computer-readable medium of example embodiment 21, wherein the instructions comprise code to compute the body-composition output comprising FM and FFM and to format the report with textual values for FM and FFM.

Example Embodiment 27: The non-transitory computer-readable medium of example embodiment 21, wherein the instructions comprise code to execute at least the segmenting on an edge device and to execute at least the predicting on a remote server.

Example Embodiment 28: The non-transitory computer-readable medium of example embodiment 21, wherein the instructions comprise code to compute an uncertainty score and include the uncertainty score in the report.

Example Embodiment 29: A method of training a model to estimate body composition of a subject from ultrasound imagery, the method comprising: accessing a training dataset comprising ultrasound images of subjects and corresponding reference body-composition measurements; preprocessing the ultrasound images to generate normalized training inputs; training a segmentation network using the normalized training inputs to produce pixel-wise delineations of anatomical boundaries; training a regression model using features derived from the normalized training inputs and the pixel-wise delineations to predict at least one of fat mass (FM) and fat-free mass (FFM); and validating the trained segmentation network and the trained regression model on a held-out dataset.

Example Embodiment 30: The method of example embodiment 29, wherein the segmentation network comprises a U-Net or U-Net-like encoder-decoder architecture with skip connections.

Example Embodiment 31: The method of example embodiment 29, further comprising generating explanation visualizations for validation images and confirming that salient regions correspond to anatomically relevant structures.

Example Embodiment 32: The method of example embodiment 29, wherein the training dataset comprises images from at least two of the biceps region, abdomen region, and quadriceps region for a given subject.

Example Embodiment 33: The method of example embodiment 29, further comprising computing agreement metrics selected from the group consisting of mean absolute percentage error and Bland-Altman analysis on the held-out dataset.

Example Embodiment 34: The method of example embodiment 29, further comprising selecting hyperparameters of the segmentation network or the regression model based on validation performance.

Example Embodiment 35: The method of example embodiment 29, wherein the regression model is trained to output both a predicted value and an uncertainty or confidence score for at least one of FM and FFM.

Example Embodiment 36: The method of example embodiment 29, further comprising ensembling predictions from a plurality of trained models to generate a final prediction on the held-out dataset.

Example Embodiment 37: A method for acquisition planning for ultrasound body-composition estimation in a subject, the method comprising: receiving an indication of one or more candidate anatomical regions comprising at least the biceps region, the abdomen region, and the quadriceps region; estimating, for each candidate anatomical region or combination of anatomical regions, a prediction error for at least one of FM and FFM using a trained model; and selecting a subset of the candidate anatomical regions that satisfies an error threshold and generating acquisition guidance specifying the selected subset.

Example Embodiment 38: The method of example embodiment 37, wherein the estimation of prediction error is based on validation performance for the trained model on images from the corresponding anatomical regions.

Example Embodiment 39: The method of example embodiment 37, wherein the acquisition guidance comprises textual instructions presented on a display coupled to an ultrasound probe.

Example Embodiment 40: The method of example embodiment 37, wherein the selecting favors subsets with fewer anatomical regions subject to satisfying the error threshold.

Example Embodiment 41: The method of example embodiment 37, further comprising updating the selected subset over time based on newly acquired data and observed agreement metrics in clinical use.

Example Embodiment 42: The method of example embodiment 37, wherein the acquisition guidance instructs reacquisition when a received image fails a quality criterion comprising motion blur or insufficient anatomical coverage.

Example Embodiment 43: In any of embodiments 1-42, the subject is a pregnant subject and the method estimates one or more body-composition metrics of the pregnant subject to inform nutritional assessment during prenatal care.

Example Embodiment 44: In any of embodiments 1-42, ultrasound images are acquired at sites comprising a biceps region, an abdominal wall region lateral to the umbilicus, and a quadriceps region in the pregnant subject, and the predicting comprises fusing region-level representations to produce fat mass (FM) and fat-free mass (FFM) of the subject.

Example Embodiment 45: In any of embodiments 1-42, the body-composition output for a pregnant subject further comprises at least one of: gestational-weight-gain percentile for current gestational age, change in FM or FFM from a baseline visit, or a nutritional risk flag relative to configurable clinical thresholds.

Example Embodiment 46: In any of embodiments 1-42, the method calibrates outputs for a pregnant subject against a reference technique comprising air-displacement plethysmography (ADP) using a BodPod device when available and otherwise records the body-composition output with an associated uncertainty score.

Example Embodiment 47: In any of embodiments 1-42, the acquisition interface provides probe-placement cues and motion guidance using built-in inertial measurement units (IMUs), and the quality gate requests reacquisition when compression or motion artifacts exceed a threshold in the pregnant subject.

Example Embodiment 48: In any of embodiments 1-42, the report for a pregnant subject includes numerical FM and FFM values and a trend plot over prenatal visits, together with an explanation visualization highlighting the abdominal subcutaneous fat boundary used in the prediction.

Example Embodiment 49: In any of embodiments 1-42, the subject is a subject with diabetes, pre-diabetes, or metabolic syndrome, and the method estimates one or more adiposity metrics including a visceral-adiposity proxy derived from abdominal ultrasound images.

Example Embodiment 50: In any of embodiments 1-42, the predicting for a subject with diabetes further comprises computing at least one of: preperitoneal fat thickness, the ratio of visceral to subcutaneous adipose tissue (V/S ratio), or a composite adiposity score that fuses ultrasound-derived features with waist circumference and body-mass index obtained from medical records.

Example Embodiment 51: In any of embodiments 1-42, the report for a subject with diabetes includes the adiposity score, an uncertainty or confidence interval, and a recommendation to repeat acquisition or obtain confirmatory laboratory testing when the uncertainty exceeds a threshold or when quality criteria are not met.

Example Embodiment 52: In any of embodiments 1-42, the method associates the body-composition output with clinical laboratory data comprising at least one of: hemoglobin A1c (HbA1c), fasting glucose, fasting insulin, lipid panel, or liver enzymes, and stores the association in secure storage linked to a unique subject identifier for longitudinal analysis.

Example Embodiment 53: In any of embodiments 1-42, the acquisition-planning method selects a minimal subset of anatomical regions for a subject with diabetes to satisfy an error threshold for the adiposity score, favoring abdominal wall views while optionally adding biceps or quadriceps views when predicted error remains above the threshold.

Example Embodiment 54: In any of embodiments 1-42, the method monitors response to therapy in a subject with diabetes receiving a dietary intervention or pharmacologic therapy including a GLP-1 receptor agonist, by comparing current FM/FFM or adiposity score with prior visits and flagging changes that exceed a configurable minimal clinically important difference.

Example Embodiment 55: In any of embodiments 1-42, the training dataset further comprises images from adult subjects, pregnant subjects, and subjects with diabetes, with augmentation and intensity/scale harmonization applied to reduce domain shift between neonatal and non-neonatal cohorts.

Example Embodiment 56: In any of embodiments 1-42, the explanation visualization for a subject with diabetes comprises a saliency or attention map highlighting preperitoneal and subcutaneous interfaces and is stored with the report to support clinical audit.

Example Embodiment 57: In any of embodiments 1-42, the system exports, via an application programming interface, the body-composition output for a pregnant subject or a subject with diabetes to an electronic health record together with metadata identifying model version, anatomical sites used, and quality scores.

Example Embodiment 58: In any of embodiments 1-42, the method operates in community or low-resource clinical settings using an edge device for preprocessing and segmentation and a remote service for inference, and synchronizes results when connectivity is available, for pregnant subjects and subjects with diabetes.

Example Embodiment 59: In any of embodiments 1-42 and 43-58, the method monitors response to therapy in a subject receiving a dietary or behavioral intervention and/or a pharmacologic therapy including a glucagon-like peptide-1 (GLP-1) receptor agonist. In some embodiments, the therapy further includes, without limitation, a GLP-1/GIP co-agonist, an insulin-sensitizing agent, or another anti-obesity or anti-diabetic medication. The system compares a current body-composition output (e.g., fat mass (FM), fat-free mass (FFM), preperitoneal fat thickness, visceral-to-subcutaneous fat ratio, or an adiposity score) against prior visits, computes a trend and an uncertainty, and flags changes that exceed a configurable minimal clinically important difference, irrespective of whether the subject has diabetes.

Example Embodiment 60: In any of the embodiments, the method is configured for pregnancy care. Ultrasound images acquired at standardized maternal regions (e.g., abdominal wall, arm, or thigh) are processed to estimate FM/FFM and to compute a gestational-weight-gain percentile for the current gestational age. Longitudinal trends across prenatal visits are displayed together with explanation overlays and quality indicators. In some embodiments, outputs are fused with obstetric record fields (e.g., gestational age at visit) and are formatted to support nutrition counseling and shared decision-making in prenatal care.

Example Embodiment 61: In any of the embodiments, the method supports postpartum follow-up. Serial FM/FFM and adiposity indices are compared across the late-pregnancy, delivery, and postpartum time points to characterize tissue-compartment recovery and to guide targeted nutrition or activity plans.

Example Embodiment 62: In any of the embodiments, the method supports subjects with diabetes or pre-diabetes. The system optionally ingests laboratory values (e.g., HbA1c, fasting glucose, fasting insulin, or lipid panel) and anthropometrics (e.g., waist circumference, BMI) and presents a report that fuses ultrasound-derived features with such clinical data. Thresholds for alerts can be tailored to therapeutic goals (e.g., preferential FFM preservation during weight loss).

Example Embodiment 63: In any of the embodiments, the method evaluates response to weight-management pharmacotherapy and/or structured lifestyle programs in subjects without diabetes. Outputs include time-aligned trends of FM, FFM, and adiposity indices, adherence-adjusted forecasts, and an audit trail linking predictions to acquisition quality and model version.

Example Embodiment 64: In any of the embodiments, the system is used to monitor physiological readiness in military populations. In some implementations, scans are performed in austere or field settings using a handheld probe; preprocessing and segmentation execute on an edge device, with encrypted synchronization when connectivity is available. Readouts (e.g., FM/FFM trend and adiposity score with uncertainty) inform training status, recovery, and duty readiness.

Example Embodiment 65: In any of the embodiments, the method is deployed in sports, occupational health, community screening, or telehealth programs. The acquisition planner selects a minimal subset of regions predicted to meet an accuracy target; real-time quality gates prompt reacquisition if motion, compression, or coverage criteria are not met. Results are exported via an API to an electronic record or program dashboard.

Example Embodiment 66: In any of the embodiments, reports include an explanation visualization (e.g., saliency/attention heatmap) and a calibrated confidence or uncertainty interval. When uncertainty exceeds a configurable threshold, the system recommends confirmatory testing and/or follow-up imaging.

Example Embodiment 67: In any of the embodiments, cohort-level calibration reduces systematic bias relative to a local reference method (e.g., air-displacement plethysmography when available), while preserving subject-level trends when the reference is absent.

Examples' Breadth Across Therapies and Populations—The foregoing embodiments, features, details and aspects make explicit that the technology applies beyond newborns to subjects across the lifespan and across clinical and non-clinical programs. Without limitation, use cases include: pregnancy and postpartum nutrition monitoring; pre-diabetes and type 1 or type 2 diabetes management; supervised weight-loss or weight-maintenance programs (dietary, behavioral, or pharmacologic, including GLP-1-based agents and other anti-obesity medications); cardiometabolic risk management in primary care; sarcopenia or frailty assessment in older adults; oncology or chronic-disease cachexia monitoring; rehabilitation and recovery after illness or surgery; sports medicine and occupational-health surveillance; and physiological-readiness assessments in military populations. In each case, the same acquisition protocol (standardized biceps, abdominal wall, and/or quadriceps views with quality gating), learning pipeline (preprocessing, segmentation, feature generation, and regression), and reporting elements (FM, FFM, adiposity indices, uncertainty, explanation overlay, and longitudinal trends) are employed, optionally fusing ultrasound-derived features with available clinical variables. The system is device- and deployment-agnostic: it functions on a handheld tablet or probe with optional cloud inference, operates offline with later synchronization, and exports structured results to electronic records and analytics. By framing the outputs as generalized body-composition biomarkers rather than population-specific surrogates, the disclosure supports monitoring response to any dietary, behavioral, or pharmacologic therapy and supports decision-making in diverse settings from tertiary centers to field operations.

After testing the above-described example embodiments, methods, other embodiments and other experiments; next, major work will be undertaken to implement greater scale up and automated procedures in the form of AI, and software with devices.

### Example 3A. Pregnancy/Maternal Nutrition

The following example embodiments discuss portable ultrasound at standardized sites; ADP (BodPod) as ground truth; IMU-assisted probe guidance; outcomes including FM/FFM, growth/nutrition metrics; deployment in low-resource settings; and are tested and are further refined.

MOTIVATION & OBJECTIVES: Malnutrition is a global threat that affects all ages, genders, races, social statuses, and countries. Survivors of malnutrition are at high risk for reduced physical and cognitive development, capacity to resist disease, carry out physical work, and study and progress in school. Updated global projections indicate that 670 million people will be undernourished in 2030, 78 million more than the predicted scenario without the occurrence of the COVID-19 pandemic, stressing malnutrition as a current global public health threat and in the following years to come. In particular, studies have shown that burden and determinants of undernutrition among young pregnant women in Ethiopia are disproportionately high. Nutritional screening tools have not demonstrated reproducibility, agreement with one another, or validity in identifying malnutrition. To monitor a patient's nutritional health, healthcare workers often use anthropometric indicators such as weight, height, and body mass index (BMI). Such metrics, though straightforward to acquire with scales and tape measures, do not adequately provide a comprehensive assessment of nutritional health. More advanced methods, such as air-displacement plethysmography (ADP) and doubly labeled water (DLW), are expensive and only available in specialized facilities.

Our objective is to develop, following a human-AI co-design approach, a cost-effective, portable and automated ultrasound tool that will measure critical nutritional metrics. Our proposed innovation will include novel AI models that will guide a user to collect high quality data and predict metrics for nutritional status and are integrated as part of a mobile ultrasound system for use by frontline healthcare workers without extensive ultrasound training. This work directly addresses the grand challenges opportunity area to advance women's health innovation to increase research on prenatal, intrapartum, and postpartum conditions and risk factors associated with adverse maternal health outcomes to enable the development of diagnostics, treatments, and prevention, including artificial intelligence/machine learning tools.

PROPOSED WORK: Hypothesis; machine learning-based ultrasound image analysis algorithms can predict conventional nutritional metrics, growth, and body composition for women in Ethiopia.

This pilot study will be achieved through the following aims: 1. Collect clinical data, anthropometric measures, ultrasound, ADP, and developmental indicators: Study location; the study will be conducted at Jimma Medical Center (JMC). JMC is a referral hospital located in the southwest part of Ethiopia around 350 km from Addis Ababa, the capital of the country. The medical center provides multiple diagnostic and therapeutic services including radiologic services to the over 20 million population in the sub-region. The medical center is equipped with clinicians trained at different levels of care, including pediatricians and radiologists. Moreover, there are different research centers equipped with facilities and expertise located within the medical center conducting experimental and observational studies. One of such centers is Jimma University Clinical and Nutrition Research Partnership (JUCAN), which is a state-of-the-art nutrition research center that has many recognized standards for measuring body composition, including bioimpedance, ADP (adult and pediatric), as well as ultrasound, MRI and CT imaging. Currently, JUCAN has studies examining metabolic syndrome among pregnant women, and measuring maternal-newborn dyad body composition using ADP. The existing clinical infrastructure at JMC is the ideal setting for collecting relevant gold standard clinical nutritional data, developing our proposed ultrasound methods, and evaluating the technology.

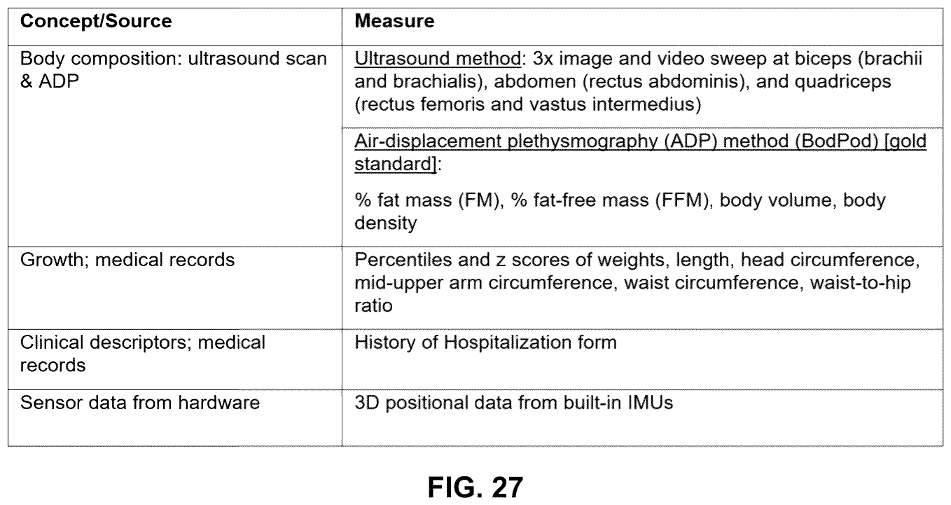

Study design and measures: Using a prospective cohort study design, we will generate a database of ultrasound scans, anthropometry, gold standard body composition, and associated clinical data from a target group of 50 young pregnant women, along with 50 community controls, at JUCAN. Participants will be recruited from the population of women receiving routine care at JMC. The inclusion criteria will specify participants to be at least 18 years of age. Pregnant participants will include those at various gestational stages, ranging from 6 to 40 weeks of pregnancy. Eligible participants should be generally healthy, without significant chronic illnesses, and must provide informed consent to participate. For this pilot study, the inclusion criteria will be intentionally broad to capture a wide range of ages, demographics, and BMI values, thereby ensuring a diverse range of body compositions. Moreover, we will adopt flexible inclusion criteria to capture variations in pregnancy stages and health backgrounds. Collecting and analyzing demographic and clinical data will allow for ongoing monitoring of representation so that we can make any needed adjustments. Exclusion criteria will include women with pregnancy complications, and individuals with severe chronic illnesses. Furthermore, women with disabilities or medical conditions that might hinder participation in ultrasound or body composition measurement protocols will be excluded. Specific measures that will be collected are summarized in the table shown in FIG. 27.

The portable ultrasound system we will use in this study has an embedded inertial measurement unit (IMU), which will allow us to collect gyroscope, accelerometer, and magnetometer data with the precise time stamp so that we can correlate user positional data to the ultrasound video and image data. Specifically, we will utilize a Clarius L15 portable ultrasound probe that is currently deployed at the research site for other studies. The clinical research staff at Jimma Medical Center are trained in its general operation. The Clarius L15 is a handheld ultrasound system designed for point-of-care imaging and offers high-definition imaging for various applications including musculoskeletal, abdominal and obstetrics. The device features wireless connectivity for straightforward image sharing and provides access to cloud data storage, which enables secure and protected data sharing. Our team will use 3D positional data from the IMU sensors to develop feedback algorithms for guiding users in collecting high-quality data. The Clarius system(s) provide(s) access to high-frequency raw sensor data for calculating orientation angles essential for optimal probe positioning. Ultimately, we aim to develop preliminary guidance algorithms that will provide real-time feedback to users on conducting scans effectively.
2. Develop AI/ML algorithms that predict critical nutritional and growth metrics and provide user guidance: one major challenge in designing the ultrasound imaging protocol is the limited prior knowledge in the field on what and where to measure to facilitate the body composition prediction task. To address this, we will build a novel human-in-the-loop visual measurement interpretation method to ensure that the AI model learns sensible signals instead of artifacts while exploring the design space of the imaging protocol using the following experimental design: 1) Baseline experiment: We will first prototype a deep learning system to measure the body composition from a single ultrasound image. To build the training data, we will sample 100 image frames per subject and pair them with the ground truth label from the ADP method (BodPod). Following the common practice in the field with limited labeled data, we will first train a 2D residual neural network model on a large-scale ultrasound image prediction dataset8, and then fine tune the model on our data for body composition prediction. 2) Human-in-the-loop interpretable visual measurements identification: Despite recent progress in interpretable image prediction, there are many confounding factors from video artifacts that may influence a prediction that is hard to rule out. To tackle this interpretability challenge, we will extend the popular GradCAM method for multi-site images to compute the importance of each input dimension to distill interpretable factors for prediction10. 3) Imaging protocol design space exploration: Equipped with the interpretability method above, we will explore the following imaging protocol design choices: (A) Image vs. video input: we will change the model architecture to SlowFast to process ultrasound videos to evaluate the effectiveness of the additional temporal information, (B) Image location encoding: for the input image, we will add an additional latent variable to indicate its location of measurement to evaluate its usefulness for the prediction, and (C) Single-location vs. multiple-location image input: for each individual, we will apply the late-fusion approach to integrate 2D ResNet model features for images at multiple locations for the prediction. With this, we can use different combinations of locations to discover the most informative locations.
3. Conduct initial user assessment using human-centered design methodologies: Though the use of portable ultrasound systems has increased significantly in recent years due to the commercialization of several mobile-based devices, the deployment of such systems for body composition measurements and nutritional status has not been pursued. Therefore, it will be critical to gather clinical user insights early in the research process, including as part of this pilot work, so that the ultimate tool we develop will address these important challenges in global nutrition. To this end, we will follow a human-centered and participatory design process to formally define and document the challenges faced by our target users: frontline and community healthcare workers. To achieve this, we will develop a survey to acquire qualitative feedback from the clinical users, which will consist of questions related to the following themes: (1) clinical workflow and decision making, (2) useability of the portable ultrasound device, and (3) human-computer interaction (HCI).

PATH TO IMPACT: Impact; If successful, this innovative, low-cost, and portable ultrasound tool will have the capability to assess growth and body composition, which has the potential to identify those who are at risk for poor nutrition, growth, and/or neurodevelopmental outcomes and could benefit from targeted interventions. This tool could also be incorporated into routine clinical assessment for more accurate assessment of infant growth and nutrition and will be designed so that it can work in a variety of clinical settings, and be used by users with minimal training. Though this study will focus on young pregnant women, results can reasonably translate to numerous other clinical nutrition applications in newborn care, elderly populations, and patients in intensive care.

Next phase of work: The expected outcomes of this pilot work are intentionally designed to position our team to apply for additional funding and subsequently transition from a cross-sectional observational study to launch a full-scale longitudinal cohort study at JUCAN to collect a more expansive database of ultrasound and clinical data. In terms of timeline, upon successful completion of this 2-year pilot phase, we would be well-positioned to launch a larger study shortly thereafter. We anticipate a future study with an expanded sample size of over 100 pregnant women, who will be scanned at multiple time points throughout their pregnancies, along with an equal number of community controls. Analysis of the data from this pilot study will allow us to complete a power analysis to finalize the sample size for a future study. The strategy for this future study aims to recruit a diverse cohort of pregnant women, thereby enhancing the statistical power and generalizability of the findings. We plan to implement a longitudinal study design to assess changes in body composition throughout pregnancy, providing valuable insights into trends, possible nutritional interventions, and health outcomes. To track enough data over time and conduct analysis, we expect a future expanded study to last approximately 3 years. Additionally, we will conduct a comprehensive clinical data collection and records review to gain a holistic understanding of the factors influencing body composition, including dietary information and any other nutritional interventions.

Follow-up assessments postpartum will also be included to evaluate changes over time. Furthermore, we will broaden the inclusion criteria to encompass additional populations, allowing for an examination of variations in body composition. For a future study of this size, we anticipate that a higher percentage effort will be required by the investigators involved in the project. This will include budgeting for recruitment, additional ultrasound systems, data collection tools, and research support for data analysis. Over a 3-year period, we estimate the total budget to be approximately $1M. Equipped with this expanded dataset, we will refine and validate our machine learning models to predict body composition and nutritional status over time. These algorithms will be integrated into a low-cost mobile phone-based ultrasound system that has a software development kit (SDK) available (e.g., Clarius, Philips, or Butterfly). The algorithm-integrated device will then be deployed at JUCAN to evaluate clinical accuracy, assess performance, collect usability data, and eventually perform a clinical trial as basis for regulatory approval. Importantly, our proposed research will contribute to the growing body of knowledge of how clinicians interact with portable AI-enabled medical technologies.

### Example 3B. Diabetes/Visceral Adiposity

The following example embodiments discuss abdominal scans in Asian American adults; community settings; aims include protocol, pilot data, and ML prediction of adiposity (with waist circumference, A1C, etc.).

Introduction: One in two Asian Americans (AAs) develop diabetes or pre-diabetes in their lifetime, with a significant majority having Type 2 Diabetes (T2DM). Additionally, AAs are at a 1.6 times higher risk of having T2DM compared to White Americans, and the prevalence of T2DM and pre-diabetes is increasing rapidly within this population. These trends are attributed to a combination of physiological factors, such as greater visceral adiposity despite lower body weights, and environmental influences, including unhealthy lifestyles and environments. Furthermore, a lack of interventions that are culturally, linguistically, and socially responsive further exacerbates the problem. A research area that is underexplored is the assessment of visceral adiposity in the AA population, and how this may change over time and in diverse populations. To fill this knowledge gap, we propose the incorporation of portable ultrasound devices for assessing visceral adiposity, a critical component of diabetes monitoring, as part of PI Nguyen's ongoing funded diabetes prevention program studies. The proposal outlines three specific aims:

Develop and refine clinical protocol for data collection. We will conduct a systematic literature search of the use of ultrasound for adiposity measurements and develop a clinical data collection protocol to collect ultrasound data as part of the ongoing studies. We will refine the protocol based on expert input and submit for institutional review board (IRB) approval at Boston College and our partner institutions.

Collect pilot data. Upon ethical approval of the clinical data collection protocol, we will deploy portable ultrasound probes with Dr. Nguyen's clinical partners to perform abdominal scans of participants to collect adiposity measures.

Conduct preliminary analysis of pilot data. We will analyze the pilot data and develop novel artificial intelligence (AI) algorithms to predict adiposity and other clinical metrics related to T2DM from the image data. Preliminary results will form the basis of future grant applications.

In pursuing these aims, we will not only collect critical adiposity data that is currently not being gathered as part of these ongoing studies but also lay the groundwork for developing novel ultrasound methods that may serve as a clinically deployable tool for assessing adiposity metrics over time in AA populations.

For this project to be successful, we will need to draw upon clinical expertise in diabetes, and ultrasound image analysis. The project team's interdisciplinary background and expertise in these areas will position them well to implement, research and develop each of these areas of work. Dr. Tam Nguyen's expertise in diabetes studies in the Asian American population will be critical for finalizing the clinical protocol with our partners and establishing a robust means of acquiring qualitative user feedback. Dr. Bryan Ranger's expertise in ultrasound image analysis, as well as experience in the global health sector will contribute to protocol development, image analysis, and assessing user feedback. Sunand Bhattacharya's expertise in human-centered design methodologies will be critical for understanding end-user needs from a human-computer interaction (HCI) perspective. We will also consult closely with Dr. Jinjin Cao, an abdominal radiologist at MGH, who will provide clinical expertise and assist with image annotation.

The project aligns closely with the mission of the Schiller Institute by integrating many different disciplines together to solve a challenge in healthcare. If successful, this innovative, low-cost, and portable ultrasound method will have the capability to assess adiposity in diabetic populations, which has the potential to identify those who are at risk of poor health outcomes.

Project Plan: Motivation & Potential for Impact on Societal Problems Related to Health; Background; One in two Asian Americans (AAs) develop diabetes or pre-diabetes in their lifetime (Centers for Disease Control and Prevention, 2014); with 90-95% of the cases involving Type 2 Diabetes (T2DM). Additionally, AAs are 1.6 times more likely than Whites to have T2DM, and the prevalence of T2DM and pre-diabetes are increasing faster among AAs than Whites, Blacks, and Hispanic Americans (National Diabetes Information Clearinghouse, 2011). The prevalence of T2DM and pre-diabetes in this population results from a combination of physiological and environmental influences (Hsu et al., 2012); notably greater visceral adiposity than the general population, despite having lower body weights, as well as increased exposure to unhealthy lifestyles and environments; with a paucity of interventions that are linguistically, culturally, and socially responsive. The Diabetes Prevention Program (DPP) is an evidenced based self-management/lifestyle intervention that focuses on losing 5-7% of body weight through dietary changes and increased physical activity. The DPP has been shown to reduce the development of T2DM by 58% (Knowler et al., 2002; Diabetes Prevention Program Research Group, 2015). However, the generalizability of these findings to Southeast AAs, such as Vietnamese Americans (VAs), who are anthropometrically and culturally different from the general population, is not well established. Currently, PI Nguyen is conducting studies (funded by the Betty Irene Moore Fellowship for Nurse Leaders and Innovators and the Centers for Disease Control) that builds on an adapted and translated version of the DPP for VAs, and aims to address key gaps in the process and products needed to inform a re-imagined diabetes prevention program that capitalizes on advances in implementation science and technology.

Significance: T2DM is a rapidly growing problem for all people, and a “silent” killer among Asian Americans: In 2021 over 37 million Americans were identified with T2DM as compared to 1.6 million in 1958; and it is estimated that 94 million Americans currently have pre-diabetes, defined as a HgA1C level between 5.7-6.4% (American Diabetes Association, 2021). While T2DM is a problem for all people, the perception that Asian Americans have low to moderate risk for T2DM has limited the development of resources to address this problem. However, there is evidence that the prevalence of T2DM is increasing faster among Asian Americans than Whites, Blacks, and Hispanic Americans (Diamant et al., 2007; Lee et al., 2011; McBean et al., 2004). Additionally, the proportion of people identified as pre-diabetic is higher among Asian Americans (32%) than Whites (21%), Blacks (21%), and Hispanic Americans (25%) (Thorpe et al., 2009). Further, compelling data suggest that the relationship between T2DM and Body Mass Index (BMI) is different among Asians Americans compared to other race/ethnic groups, with Asian Americans reporting T2DM at significantly lower BMI levels and higher visceral adiposity compared to the general population (Lee et al., 2011; Karter et al., 2013; Rajpathak et al., 2010; Wang et al., 2011). This paradox challenges the traditional practice of using overweight cut-off points to identify risk and masks the problem of T2DM in Asian Americans. It also challenges the focus on weight-loss as a necessary intervention component to prevent diabetes.

Current T2DM prevention interventions have not been effectively adapted or translated for Asian Americans: The strongest evidence available to guide the prevention of T2DM in the U.S. comes from a large, randomized trial (n=3,234) called the Diabetes Prevention Program (DPP) (Knowler et al., 2002). While the evidence supporting the effectiveness of this program is robust, there are stubborn patterns of inequity that exists in the prevention of T2DM in underserved ethnic/social minority groups like Asian Americans. Over the past two decades, our team as well as other nurse researchers have tailored interventions to support culturally sensitive and relevant care for these populations (McEwen et al., 2017; Kim et al., 2015; Lynch et al., 2019). However, we recognize that the progress has been slow and incremental, with the focus mainly directed at linguistic translations and cultural adaptations using a “one size fits all for an ethnic group” approach. Providing next generation “targeted and tailored” interventions that attend to the “within group variation” that result from intersections among various identities, social determinants of health, psychosocial, and physiologic factors is urgently needed. Another gap in the field is represented by a largely missed opportunity to adopt technology-assisted intervention in ethnic/social minority groups (Im et al., 2018). Rapidly developing new technologies, along with an explosion of technology-assisted interventions, are now fundamental to comprehensive chronic disease programs in 21^{st} century (Starkweather et al., 2019). Addressing these gaps has the potential to reduce the stubborn inequities in T2DM among Asian Americans.

Measuring Visceral Fat in Diabetic Patients and Existing Methods: The measurement of visceral adiposity in diabetic patients has high significance given its central role in the pathophysiology of diabetes (Tchernof & Despés, 2013). Visceral fat, which accumulates around internal organs in the abdominal cavity, is metabolically active and is strongly associated with insulin resistance, a hallmark of T2DM (Gastaldelli et al., 2007). It is not merely a passive energy storage depot but rather an active endocrine organ that releases bioactive molecules, known as adipokines, which can disrupt glucose metabolism and promote inflammation (Amato et al., 2014). Additionally, visceral adiposity is a known risk factor for a range of cardiovascular and metabolic complications, including hypertension and dyslipidemia, further exacerbating the health risks for diabetic patients (Haberka et al., 2018). Collecting data on visceral adiposity is vital as it allows for the early identification of high-risk individuals, facilitates personalized care, and provides a means to assess the effectiveness of interventions. Therefore, it can assist both healthcare providers and patients to tailor management strategies, ultimately reducing the risk of diabetes-related complications and improving the overall health outcomes for individuals living with diabetes.

There are various techniques available for measuring adiposity in diabetic patients, each with its own advantages and limitations. One commonly used method is waist circumference measurement, a simple and cost-effective approach that provides an estimate of abdominal adiposity (Ross et al., 2020). Dual-energy X-ray absorptiometry (DXA) is another technique that offers precise quantification of fat mass and distribution, enabling the differentiation of visceral and subcutaneous fat (Kaul et al., 2012). Bioelectrical impedance analysis (BIA) measures body composition by assessing the electrical resistance of different tissues, making it a non-invasive and easily accessible method (Ryo et al., 2005). CT and MRI are advanced techniques that provide high-resolution images of fat distribution within the abdominal cavity, allowing for accurate assessment of visceral adiposity (Jensen et al., 1995; Gray et al., 1991). Additionally, skinfold thickness measurements are a simple anthropometric method that estimates subcutaneous fat content (Orphanidou et al., 1994). The choice of technique depends on factors such as accessibility, cost, and the level of detail required, making it important to select the most appropriate method for a given clinical or research context when assessing adiposity in diabetic patients.

Ultrasound is a low-cost and safe imaging modality that has been increasingly used to estimate adiposity, particularly visceral fat, in various populations, including diabetic patients (Benevides et al., 2022). Although ultrasound may not provide the same precision as computed tomography (CT) or magnetic resonance imaging (MRI), it has been validated as a means to accurately measure thickness of preperitoneal or omental fat layers, which are key components of visceral adiposity. One of the significant advantages of ultrasound over CT and MRI is its non-invasive nature and ability to provide real-time assessments, making it a useful tool for monitoring changes in visceral fat over time. Studies have shown that ultrasound is a reliable method for directly visualizing abdominal visceral and subcutaneous fat (Suzuki et al., 1993; Stolk et al., 2001; Ribeiro-Filho et al., 2003; Hirooka et al., 2005; Merino-Ibarra et al., 2005; Vlachos et al., 2007), with Suzuki et al. (1993) reporting strong correlations between ultrasound measurements of preperitoneal fat thickness and abdominal visceral fat area determined by CT (r=0.70, p<0.001). Additionally, handheld ultrasound has demonstrated strong agreement with dual-energy X-ray absorptiometry (DXA) in estimating total and trunk fat mass for both sexes (Gomez-Perez, 2021). While CT generally shows higher intra-observer and interobserver reliability compared to ultrasound, both modalities have demonstrated high accuracy and reproducibility in assessing abdominal fat (Mauad et al., 2017). Ultrasound is also a valid method for measuring various abdominal fat depots (Cuatrecasas et al., 2020), and it has been highlighted for its accuracy, reproducibility, and rapid assessment of abdominal adiposity, providing an easy and accessible tool for regional fat analysis (Bazzocchi et al., 2011). Furthermore, ultrasound has proven effective in epidemiological studies of older adults when MRI and CT are not feasible (De Lucia Rolfe et al., 2010). Despite these promising results, ultrasound has yet to be extensively applied to measure visceral fat specifically in Asian American populations, representing a gap in the existing literature that could provide valuable insights.

We hypothesize that portable ultrasound devices hold great potential for measuring adiposity in diabetic patients at the community level, since they can offer a cost-effective and accessible means of assessment. Numerous portable ultrasound devices have come to market recently, operate using mobile or tablets, and are relatively low-cost. This makes these devices particularly well suited for use by community health workers and allow healthcare professionals to conduct adiposity assessments in a variety of settings and reach underserved populations. The real-time nature of ultrasound imaging can provide immediate feedback to patients, which holds the potential to advance their understanding of adiposity and foster greater engagement in their diabetes management. Furthermore, due to the limited data in the literature regarding the use of ultrasound for adiposity assessment in Asian American populations, this study aims to provide valuable new insights for this application.

B. Aims and Methodology: Aim 1: Develop and refine clinical protocol for data collection; We will initiate a comprehensive literature search focused on the utilization of ultrasound for adiposity measurements. Our review will encompass a wide spectrum of sources including scientific articles, clinical studies, and best practice guidelines. By analyzing the methodologies reported in the literature, we will identify key parameters, protocols, and approaches that have demonstrated efficacy in the context of ultrasound-based adiposity measurements. This knowledge will form the basis for the development of a clinical data collection protocol tailored to our specific research needs. In addition, to ensure the protocol's accuracy, validity, and ethical considerations, we will seek expert input from medical professionals and researchers with expertise in the field of ultrasound imaging and adiposity assessment. Their insights and recommendations will be invaluable in refining the protocol, optimizing data collection methods, and ensuring that it aligns with the highest standards of scientific rigor and patient safety. Once the protocol is drafted, we will proceed to submit it for review and approval by the Institutional Review Board (IRB) at our collaborating partner institutions. This will safeguard the rights and well-being of participants in the ongoing studies, and it will ensure compliance with all ethical and regulatory standards for clinical research.

The protocol will be used to create a standard of operating procedures (SOP) that will include step-by-step instructions for a community health worker to conduct an ultrasound scan. To complete the SOP, we will conduct a human-centered and iterative design approach by engaging directly with community health workers. The SOP will be written so that it is easily understandable and has example images for reference.

Aim 2: Collect pilot data: Upon ethical approval of our clinical data collection protocol, we will first conduct training sessions with the community health workers who currently collect data as part of PI Nguyen's ongoing studies. The training session will include: (1) presenting on the goals of our pilot study and how this data collection will be added to the existing data collection that they are performing, (2) overview of the final SOP document developed in Aim 1, and (3) interactive and guided practice sessions of how to use key features of the ultrasound device. Training will be conducted by the PI's and nursing research assistants.

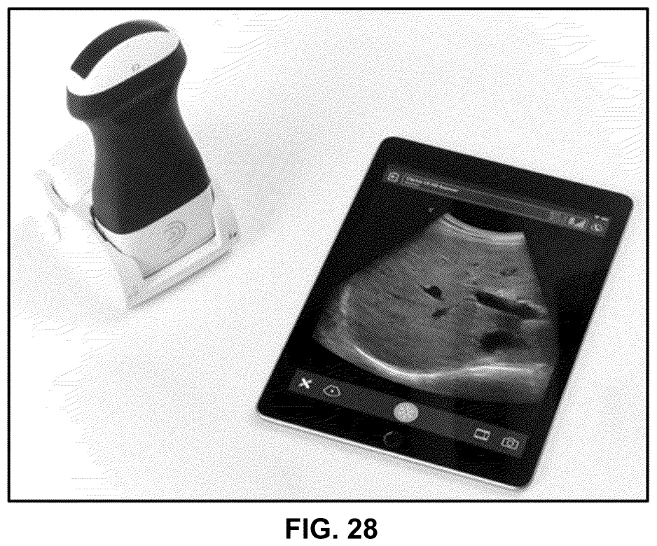

For this work, we propose using the Clarius C3 HD3 Convex Portable Scanner (Clarius® Mobile Health, Vancouver, Canada), shown in FIG. 28. PI Ranger currently utilizes linear ultrasound probes from this company (L15 and L20) for separate ongoing musculoskeletal studies. As compared to the linear versions, the Clarius C3 is a convex probe that is designed for wide field-of-view and higher imaging depth, making it appropriate for abdominal scanning. All Clarius probes are FDA-cleared ultrasound scanning systems that allow for full body imaging using iOS or Android devices. The Clarius systems include private cloud access for storing images, as well as a research package that allows for access to raw data. The Clarius C3 probes have already been purchased and are not included in our budget estimates.

Following the training sessions, we will deploy the portable ultrasound probes with PI Nguyen's clinical partners to perform abdominal scans from (approximately n=45) participants to collect adiposity measures. Images will be collected, documented, and saved using the Clarius Cloud, a secure storage space that only the study PI's and approved personnel will have access to. Dr. Cao, an abdominal radiologist, will review and annotate the images, and ensure that any potential incidental findings are addressed appropriately.

The Diabetes Prevention Program is a one-year structured lifestyle intervention. The main goals of the intervention include a 5-7% reduction in weight and engagement in ≥150 minutes of moderate physical activity per week. To achieve these goals, a 16-session lifestyle curriculum covering diet, exercise, and behavior change is taught in weekly group meetings facilitated by a Health Coach trained in motivational interviewing (MI) techniques. The 16-session lifestyle curriculum is covered during the first 6-months. Additionally, monthly group follow-up sessions are provided to reinforce behavior changes over the last 6-months. Will plan to conduct abdominal ultrasound at 3, 6, 9, and 12 months. Each scan should take approximately 10-15 minutes.

In parallel to image data collection, our team will follow a human-centered and iterative design process to rigorously study the needs of the end-user, particularly from a human-computer interaction (HCI) perspective. After the data collection, PI Nguyen will maintain the study database including the key linking identifiable data to subject identification numbers. Only de-identified data will be transferred to a HIPAA compliant, secured, encrypted network storage folder (e.g., Box) supported by Boston College and to a REDCap database hosted by Boston College for data analysis, which will only be accessible by the investigator team.

Key to this process will be our partnership and contractual agreements with the Quincy Asian Resource Initiative (QARI) and Communicate Health, Inc. QARI is a not-for-profit 501(c) social service agency in the greater Boston (Quincy) area whose mission is to foster and improve the social, cultural, economic, and civic lives of immigrants and their families. Quincy has the highest density of VAs in Massachusetts, and our project coordinator will oversee activities needed to carry out this project, as well as to facilitate alignments between the project, community, and social services that may be needed to ensure the project's success.

Aim 3: Conduct preliminary analysis of pilot data: Clinical data will be extracted from each site's Diabetes Prevention Program database by the site community health worker, which includes basic demographics, A1C, height, weight, waist circumference, and minutes of physical activity per week. Only the PI and site community health workers will have access to personally identifiable information (PHI). The site community health worker will de-identify the data and this de-identified data will then be entered into a secure web-based database (REDCap) supported by Boston College. Study subjects will be assigned a study ID number, and all data collected from the subjects will be named and identifiable only by the ID number.

During each measurement, ultrasound data will be directly uploaded to a password protected data collection mobile device; after data collection, a member of the research team will transfer the data to the secured and encrypted network storage folder (e.g., Box) supported by Boston College, which will only be accessible by the research team. Ultrasound data may also be stored in the HIPAA-compliant cloud archive (Clarius cloud) provided by the manufacturer of the FDA-approved ultrasound device. To ensure patient privacy, all images will be stored using the subject ID number only, without any personally identifiable information linked to the images.

Statistical analysis will be performed solely with the de-identified data. The main outcome variables are (1) anthropometric measurements (waist circumference, weight, height), and (2) the adipose tissue composition derived from the ultrasound images after post-processing the ultrasound images using a custom-built AI-model. In addition, other secondary variables from the clinical data, such as the participants' age, health condition, sex, race, dietary nutrition, etc. will be included to evaluate their potential influence on adipose composition.

In addition, we will develop machine learning models to evaluate various model design choices for adiposity measurement prediction from input ultrasound data. This will include the following:

Baseline Experiment: We will first prototype a working deep learning system for the proposed task of predicting adiposity from ultrasound in AA patients. Ultrasound data will be stripped of patient identifiers, tagged with “ground truth” measures of adiposity, and pre-processed. The labeled data will then be randomized into training (60%), validation/tuning (20%), and test sets (20%). We will develop our models using PyTorch and make use of the pretrained image prediction models for Ultrasound images (Ma et al., 2017). The validation/tuning set will be used to determine the best network structure and other classifier variations based on the training runs. Subsequently, the independent test set will be used to evaluate performance until the classifier has been completed. To evaluate the model, mean absolute error (MAE), mean square error (MSE), and the 95% confidence interval will be calculated and reported.

Model Improvement: To improve the model from baseline experiments, we will examine the following modifications of the baseline model to evaluate their usefulness for the prediction. (1) Image vs. video input: we will change the model architecture to SlowFast (Feichtenhofer et al., 2019) to process ultrasound videos to evaluate the effectiveness of the additional temporal information. (2) Image location encoding: for the input image, we will add an additional latent variable to indicate its location of measurement to evaluate its usefulness for the prediction. (3) Single-location vs. multiple-location image input: for each individual, we will apply the late-fusion approach to integrate 2D ResNet model features for images at multiple locations for the prediction. With this, we can use different combinations of locations to discover the most informative locations. (4) Additional image features: beyond 2D measurements of ultrasound-derived tissue thickness, echogenicity, elastography, and other image features will be examined as part of training the models. (5) Data augmentation: given the small size of the pilot data, we will explore data augmentation techniques to synthesize more images to train the deep learning models.

Summary of Anticipated Results and Deliverables; The anticipated results and products of this work consist of the following:

Aim 1: An IRB-approved clinical protocol for collecting ultrasound images to assess adiposity, and SOP document to be used for data collector training. Aim 2: Pilot dataset of abdominal ultrasound image data from a cohort of AA diabetic patients. Aim 3: Preliminary AI models to predict adiposity measures from ultrasound data, and longitudinal plots of adiposity in AA populations. The anticipated outputs of this study lay the groundwork for future funding applications (e.g. NIH) that require preliminary data.

The preliminary results from our proposed research, which integrates portable ultrasound technology for assessing adiposity in Asian American populations, will serve as a foundational steppingstone for pursuing large external funding from the National Institutes of Health (NIH). We will specifically focus on highlighting the effectiveness of portable ultrasound as a cost-effective and non-invasive tool for monitoring adiposity in this at-risk population. As part of future work, we will highlight the effectiveness of portable ultrasound as a cost-effective and non-invasive tool for monitoring adiposity in this at-risk population. In addition, we will also emphasize the refinement of the clinical data collection protocol for successful deployment of portable ultrasound devices in a community setting, and how AI algorithms for predictive analytics of ultrasound data for adiposity measures. In doing so, we will present a clear and compelling case for the continuation and expansion of our research efforts. A particular grant opportunity that we are exploring is the “Comprehensive Care for Adults with Type 2 Diabetes Mellitus from Populations with Health Disparities”—an R01 Opportunity that is supported by the National Institute on Minority Health and Health Disparities (NIMHD), National Eye Institute (NEI), National Institute of Diabetes and Digestive and Kidney Diseases (NIDDK), and Office of Research on Women's Health (ORWH). Furthermore, this work also aligns closely with the National Institute on Nursing Research (NINR)'s new strategic plan which has a key focus area in “Prevention and Health Promotion.” Our proposed future work aims to promote efforts that facilitate healthy behaviors by developing new tools that could facilitate interventions and also prevent inequities in disease burden by focusing on AAs, a disproportionately affected population. Additional disciplines that we will engage with should this work be successful include computer/data scientists.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and do not constitute any admission as to the correctness of the dates or contents of these documents.

The foregoing written specification is considered to be sufficient to enable one skilled in the art to practice the present aspects and embodiments. The present aspects and embodiments are not to be limited in scope by examples provided, since the examples are intended as a single illustration of one aspect and other functionally equivalent embodiments are within the scope of the disclosure. Various modifications in addition to those shown and described herein will become apparent to those skilled in the art from the foregoing description and fall within the scope of the appended claims. The advantages and objects described herein are not necessarily encompassed by each embodiment. Those skilled in the art will recognize or be able to ascertain using no more than routine experimentation, many equivalents to the specific embodiments described herein. Such equivalents are intended to be encompassed by the following exemplary claims.

We claim:

1. A computer-implemented method for estimating body-composition metrics of a subject from ultrasound imagery, the method comprising: receiving one or more ultrasound images of the subject acquired at at least one of a biceps region, an abdominal wall region lateral to the umbilicus, and a quadriceps region; preprocessing the one or more ultrasound images to generate normalized inputs comprising at least scale normalization, cropping, resizing, denoising, and intensity normalization with quality-control gating; segmenting tissue structures in the normalized inputs with a trained neural network to produce pixel-wise anatomical delineations; generating, from the normalized inputs and the pixel-wise delineations, a learned feature representation; predicting, using a trained model, a body-composition output comprising at least one of fat mass (FM), fat-free mass (FFM), preperitoneal fat thickness, a visceral-to-subcutaneous fat ratio, or an adiposity score; and producing a report comprising the body-composition output.

2. The method of claim 1, wherein the subject is a pregnant subject, and the report further comprises at least one of: FM, FFM, a gestational-weight-gain percentile for current gestational age, or a trend of the body-composition output across prenatal visits to inform nutritional assessment in prenatal care; and/or wherein the method of claim 1 is used to monitor a physiological readiness in military populations.

3. The method of claim 2, further comprising calibrating the body-composition output against a reference comprising air-displacement plethysmography (ADP) using a BodPod device when available, and otherwise recording the body-composition output with an associated uncertainty score.

4. The method of claim 2, wherein acquiring the one or more ultrasound images comprises providing probe-placement cues and motion guidance using inertial measurement unit (IMU) signals from a handheld ultrasound probe, and rejecting frames that fail a quality criterion comprising compression or motion artifacts.

5. The method of claim 1, wherein the subject has diabetes or pre-diabetes, and the predicting further comprises computing at least one of: preperitoneal fat thickness, the visceral-to-subcutaneous fat ratio, or a composite adiposity score that fuses ultrasound-derived features with waist circumference and body-mass index obtained from clinical records; and/or wherein the method is configured to monitor response to therapy in a subject receiving a dietary intervention or pharmacologic therapy including a GLP-1 receptor agonist.

6. The method of claim 5, further comprising associating the body-composition output for the subject with diabetes with laboratory data comprising at least one of hemoglobin A1c (HbA1c), fasting glucose, fasting insulin, lipid panel, or liver enzymes, and including an uncertainty or confidence interval in the report.

7. The method of claim 5, further comprising selecting, by an acquisition-planning module, a minimal subset of anatomical regions to satisfy an error threshold for the adiposity score, favoring abdominal wall views and optionally adding biceps or quadriceps views when predicted error remains above the threshold.

8. The method of claim 1, wherein the one or more ultrasound images comprise images from two or more of the biceps, abdominal wall, and quadriceps regions, and the predicting comprises combining region-level predictions by fusion to produce the body-composition output.

9. The method of claim 1, wherein the preprocessing further comprises normalizing pixel spacing using image metadata or a scale bar to standardize physical scale prior to segmentation and prediction.

10. The method of claim 1, further comprising computing an uncertainty or confidence score for the body-composition output, generating an explanation visualization comprising a saliency or attention heatmap overlaid on at least one of the ultrasound images, and producing a longitudinal trend of the body-composition output across visits in the report.

11. A system for estimating body-composition metrics of a subject from ultrasound imagery, comprising: an ultrasound acquisition interface configured to receive ultrasound images of a subject acquired at at least one of a biceps region, an abdominal wall region lateral to the umbilicus, and a quadriceps region; one or more processors; and non-transitory memory storing instructions that, when executed by the one or more processors, cause the system to perform operations comprising: preprocessing the ultrasound images to generate normalized inputs with quality-control gating; segmenting tissue structures using a trained neural network to produce pixel-wise delineations; generating a learned feature representation from the normalized inputs and the pixel-wise delineations; predicting, using a trained model, a body-composition output comprising at least one of FM, FFM, preperitoneal fat thickness, a visceral-to-subcutaneous fat ratio, or an adiposity score; and producing a report comprising the body-composition output.

12. The system of claim 11, wherein at least a portion of the segmenting executes on an edge device coupled to a handheld ultrasound probe and at least a portion of the predicting executes on a remote server, and wherein the system is further configured to export the report and associated metadata to an electronic health record via an application programming interface.

13. The system of claim 11, wherein the system is configured, in pregnant subjects, to compute FM and FFM and to present a gestational-weight-gain percentile and a trend across prenatal visits, together with an explanation visualization highlighting an abdominal subcutaneous fat boundary used in the prediction; and/or wherein the system of claim 11 is used to monitor a physiological readiness in military populations.

14. The system of claim 11, wherein the system is configured, in subjects with diabetes or pre-diabetes, to compute at least one of preperitoneal fat thickness, the visceral-to-subcutaneous fat ratio, or an adiposity score that fuses ultrasound-derived features with anthropometric inputs including waist circumference and body-mass index, and to flag results that exceed a configurable clinical threshold; and/or wherein the system is configured to monitor response to therapy in a subject receiving a dietary intervention or pharmacologic therapy including a GLP-1 receptor agonist.

15. The system of claim 11, further comprising an IMU-assisted guidance module configured to provide probe-placement cues and motion guidance and to reject frames that fail a quality criterion comprising compression or motion artifacts.

16. A non-transitory computer-readable medium storing instructions that, when executed by one or more processors, cause the one or more processors to perform a method comprising: receiving one or more ultrasound images of a subject acquired at at least one of a biceps region, an abdominal wall region lateral to the umbilicus, and a quadriceps region; preprocessing the one or more ultrasound images to generate normalized inputs with scale harmonization and denoising; segmenting tissue structures in the normalized inputs by executing a trained neural network to produce pixel-wise delineations; generating a learned feature representation from the normalized inputs and the pixel-wise delineations; predicting, using a trained model, a body-composition output comprising at least one of FM, FFM, preperitoneal fat thickness, a visceral-to-subcutaneous fat ratio, or an adiposity score; and producing a report comprising the body-composition output.

17. The non-transitory computer-readable medium of claim 16, wherein the instructions comprise code to normalize pixel spacing using image metadata or a scale bar prior to segmentation and to reject an image that fails a quality criterion comprising motion blur or insufficient anatomical coverage.

18. The non-transitory computer-readable medium of claim 16, wherein the instructions comprise code to aggregate predictions across two or more of the biceps region, abdominal wall region, and quadriceps region to produce the body-composition output by late-fusion of region-level predictions.

19. The non-transitory computer-readable medium of claim 16, wherein the instructions comprise code to format the report to include at least one of: FM, FFM, preperitoneal fat thickness, the visceral-to-subcutaneous fat ratio, or an adiposity score; an uncertainty or confidence interval; an explanation visualization; and, when available, associated laboratory values comprising HbA1c or fasting glucose.

20. The non-transitory computer-readable medium of claim 16, wherein the instructions comprise code to select, by an acquisition-planning module, a minimal subset of anatomical regions to satisfy an error threshold for an adiposity score or FM/FFM, favoring an abdominal wall view and optionally adding biceps or quadriceps views when predicted error remains above the threshold.
